(19) United States
(12) Patent Application Publication
(10) Pub. No.: US 2026/0084826 A1
(43) Pub. Date: Mar. 26, 2026

(54) AIRCRAFT WITH AN UNDUCTED FAN PROPULSOR

(71) Applicant: General Electric Company, Evendale, OH (US)

(72) Inventors: Sara Elizabeth Carle, Columbus, OH (US); Daniel L. Tweedt, West Chester, OH (US); Syed Arif Khalid, West Chester, OH (US); Andrew Breeze-Stringfellow, Montgomery, OH (US); William Bowden, Cleves, OH (US); Trevor Howard Wood, Clifton Park, NY (US); Kishore Ramakrishnan, Rexford, NY (US)

(21) Appl. No.: 19/404,889

(22) Filed: Dec. 1, 2025

Related U.S. Application Data
(63) Continuation-in-part of application No. PCT/US2024/040754, filed on Aug. 2, 2024.
Application No. PCT/US2024/040754 is a continuation-in-part of application No. 18/652,052, filed on May 1, 2024, now Pat. No. 12,384,522.
Application No. 18/652,052 is a continuation-in-part of application No. 18/230,609, filed on Aug. 4, 2023, now Pat. No. 12,365,471.

(51) Int. Cl. B64D 27/12; B64C 11/18; B64C 11/48

(52) U.S. Cl. CPC B64D 27/12; B64C 11/18; B64C 11/48

(57) ABSTRACT

The present disclosure is generally related to aircraft having one or more unducted fan propulsors at locations within specific regions relative to an airfoil, such as a wing or horizontal stabilizer. More specifically, the specific regions are located where there is a relatively higher pressure air flow beneath the wings or above a horizontal stabilizer. That higher pressure air flow can be utilized to provide increased thrust from the unducted fan propulsor.

### CROSS-REFERENCE TO RELATED APPLICATIONS

This application is a continuation-in-part of International Appl. No. PCT/US2024/040754, filed Aug. 2, 2024, which claims priority to U.S. patent application Ser. No. 18/230,609, filed on Aug. 4, 2023, and Ser. No. 18/652,052, filed May 1, 2024, the latter of which is a continuation-in-part of the former, the disclosures of which are hereby incorporated by reference in their entireties.

### FIELD

The present disclosure relates generally to an aircraft with a fan propulsor.

### BACKGROUND

Winged aircraft have undermounted propulsors in the form of a turboprop engine. The addition of a propulsor to a wing can lead to installation penalties, including increased drag. As the size of the undermounted propulsor increases, installation penalties can also increase, such as increased weight.

### BRIEF DESCRIPTION OF THE DRAWINGS

A full and enabling disclosure of the aspects of the present description, including the best mode thereof, directed to one of ordinary skill in the art, is set forth in the specification, which refers to the appended figures, in which:

FIG. 1 comprises a top plan view of an aircraft as configured in accordance with various embodiments of these teachings, with undermounted, unducted fan propulsors mounted on forward wings of the aircraft;

FIG. 2 comprises a top plan view of an aircraft as configured in accordance with various embodiments of these teachings, with unducted fan propulsors mounted on top of horizontal stabilizers of the aircraft;

FIG. 3 comprises an elevational cross-sectional view of an exemplary unducted fan propulsor having a plurality of blades arranged in a forward array and a rearward array;

FIG. 4 comprises a schematic side elevation view showing the location of the unducted fan propulsor of FIG. 3 relative to an airfoil section;

FIG. 5A is a schematic side elevation view similar to FIG. 4 and showing the unducted fan propulsor pitched downward relative to the airfoil section;

FIG. 5B defines a pitch angle Φ for the unducted fan propulsor relative to a chord line of the airfoil section in FIG. 4;

FIG. 6A comprises a top plan view of the propulsor of FIG. 4 and inboard and outboard locations of the wing relative to an unducted fan propulsor centerline, with the inboard and outboard locations in FIG. 6A used to determine a chord length (C) of the airfoil section in FIG. 4;

FIG. 6B comprises a schematic side elevation view of a first section and a second section of the aircraft wing, which sections are used to determine an effective quarter chord point (QC) of the airfoil section in FIG. 4;

FIG. 6C comprises a schematic top plan view of a portion of an aircraft having a pair of wings extending from the fuselage with the propulsor of FIG. 3 mounted relative to each of the wings;

FIG. 6D comprises a schematic front elevation view of the aircraft portion of FIG. 6C;

FIG. 6E comprises a schematic top plan view of a portion of an aircraft having a pair of wings extending from the fuselage with the propulsor of FIG. 3 mounted relative to each of the wings, similar to FIG. 6C but showing the propulsors toed inwardly toward the fuselage;

FIG. 7 comprises a schematic side elevation view similar to that of FIG. 4, but showing a first ellipse, a second ellipse, a third ellipse, and a fourth ellipse to illustrate various embodiments of mounting locations of one of the unducted fan propulsors relative to one of the wings;

FIG. 8 comprises a schematic side elevation view similar to that of FIG. 7, but showing a first ellipse, a second ellipse, a third ellipse, and a fourth ellipse to illustrate various embodiments of mounting locations of one of the unducted fan propulsors relative to one of the horizontal stabilizers;

FIG. 9 comprises a schematic side elevation view similar to that of FIG. 7, showing the first ellipse, the second ellipse, the third ellipse, and the fourth ellipse to illustrate various embodiments of mounting locations of one of the unducted fan propulsors relative to one of the wings;

FIG. 10 comprises a schematic side elevation view similar to that of FIG. 8, showing the first ellipse, the second ellipse, the third ellipse, and the fourth ellipse to illustrate various embodiments of mounting locations of one of the unducted fan propulsors relative to one of the horizontal stabilizers; and

FIG. 11 comprises a schematic representation showing exemplary locations of a point P of one of the unducted fan propulsors, as defined herein, within the first ellipse, the second ellipse, the third ellipse, and the fourth ellipse.

FIG. 12 is an illustration of an alternative embodiment of an exemplary vane assembly for an unducted fan propulsor;

FIG. 13 depicts vector diagrams illustrating Cu through both rows for two exemplary embodiments;

FIG. 14 depicts graphically the aerodynamic rotor load distribution of two exemplary embodiments of an unducted fan propulsor in comparison with a conventional configuration;

FIG. 15 depicts graphically the exit swirl velocity and axial velocity for two exemplary embodiments of an unducted fan propulsor in comparison with two conventional configurations;

FIG. 16 depicts graphically how various parameters such as camber and stagger angle are defined with respect to a blade or vane;

FIG. 17 depicts graphically representative parameters associated with an exemplary embodiment of an airfoil blade in comparison with a conventional airfoil blade;

FIG. 18 is an elevational view of an exemplary airfoil blade for an unducted fan propulsor with section line locations 1 through 11 identified; and

FIGS. 19, 20, 21, 22, 23, 24, 25, 26, 27, 28, and 29 are cross-sectional illustrations of the exemplary airfoil blade of FIG. 18 at section line locations 1 through 11 in comparison with analogous sections through the conventional airfoil blade referenced previously.

FIG. 30 is an illustration of an aircraft including an exemplary open rotor in accordance with some embodiments.

FIG. 31 is a side view of the exemplary open rotor shown in FIG. 30.

FIG. 32 is a schematic front elevation view of the open rotor shown in FIG. 30.

FIG. 33 is a schematic side elevation view of the open rotor shown in FIG. 30.

FIG. 34 is a schematic sectional view taken along cross section plane 5-5 of FIG. 32.

FIG. 35 is a plot of a meanline shape of an exemplary midspan airfoil section of a blade in accordance with some embodiments.

FIG. 36 is a plot of meanline angle as a function of a fraction of chord length of an exemplary midspan airfoil section of a blade in accordance with some embodiments.

FIG. 37 is a plot of aerodynamic loading versus chord for a representative prior art airfoil section.

FIG. 38 is a plot of aerodynamic loading versus chord for an airfoil section in accordance with some embodiments.

FIG. 39 shows an elevational cross-sectional view of an exemplary unducted propulsion system having an axis of rotation, forward and aft blade assemblies, forward and aft housings, engine inlet and engine exit, in accordance with some embodiments.

FIG. 40 is a schematic, perspective view of an exemplary gas turbine engine attached to a wing of an aircraft in accordance with some embodiments.

FIG. 41 is a schematic side elevation view of a blade in accordance with some embodiments.

FIG. 42 is a plot of meanline angle as a function of a fraction of chord length of an exemplary midspan airfoil section of a blade in accordance with some embodiments;

FIG. 43 is a plot of meanline angle as a function of a fraction of chord length of an exemplary midspan airfoil section of a blade with a sub-region of increasing meanline angle in accordance with some embodiments; and

FIG. 44 is an illustration of a blade having trailing edge wave feature in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present teachings. Also, common but well-understood elements that are useful or necessary in a commercially feasible embodiment are often not depicted in order to facilitate a less obstructed view of these various embodiments of the present teachings. Certain actions and/or steps may be described or depicted in a particular order of occurrence while those skilled in the art will understand that such specificity with respect to sequence is not actually required.

### DETAILED DESCRIPTION

Aspects and advantages of the present disclosure will be set forth in part in the following description or may be learned through practice of the present disclosure.

The word “or” when used herein shall be interpreted as having a disjunctive construction rather than a conjunctive construction unless otherwise specifically indicated.

The terms “coupled,” “fixed,” “attached to,” and the like refer to both direct coupling, fixing, or attaching, as well as indirect coupling, fixing, or attaching through one or more intermediate components or features, unless otherwise specified herein.

The singular forms “a”, “an”, and “the” include plural references unless the context clearly dictates otherwise.

The term “at least one of” in the context of, e.g., “at least one of A, B, and C” refers to only A, only B, only C, or any combination of A, B, and C.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to fluid flow in a fluid pathway. For example, “upstream” refers to the direction from which the fluid flows, and “downstream” refers to the direction to which the fluid flows.

The term “leading edge” refers to components and/or surfaces which are oriented predominately upstream relative to the fluid flow of the system, and the term “trailing edge” refers to components and/or surfaces which are oriented predominately downstream relative to the fluid flow of the system.

“Airfoil section” and “effective quarter chord point (QC)” are defined as follows.

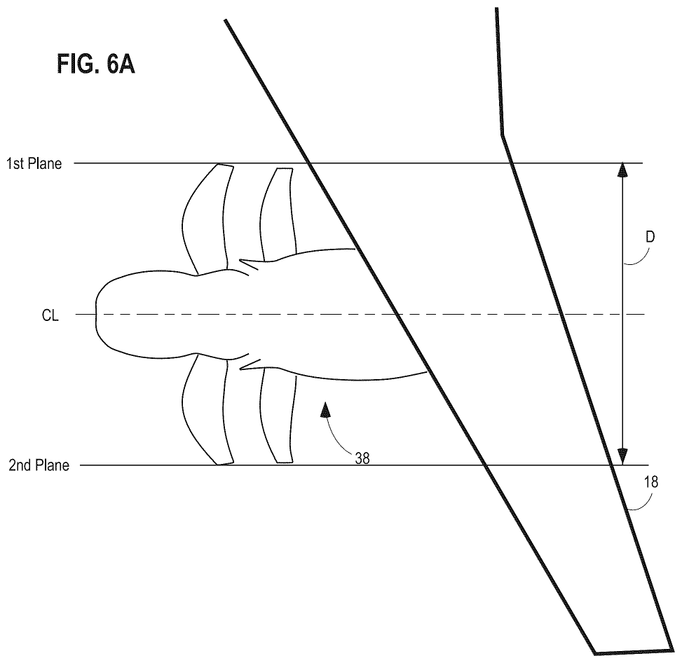

“Airfoil section” is defined as the average of a first offset plane section and a second offset plane section of an airfoil (e.g., an airfoil associated with a horizontal stabilizer or wing of an aircraft), where the first offset plane section is the section of the airfoil taken at a first plane and the second offset plane section is the section of the airfoil taken at a second plane, the first and second planes each being offset in a direction perpendicular to, and equidistant from a central plane by a distance of ½ of a fan diameter (D) of rotating blades of a propulsor mounted to the portion of the aircraft body associated with the airfoil section (wing or horizontal stabilizer). The first plane is inboard of the central plane (towards the fuselage) and the second plane is outboard of the central plane. When the aircraft is on the ground, both the gravity vector and axis of rotation of the rotating blades lie in the central plane. The intersection of the first offset plane with the airfoil defines a first section having a first section leading edge (LE1) and a first section trailing edge (TE1), with the LE1 at the forward-most point of the first section and the TE1 at the aft-most point of the first section. The intersection of the second offset plane with the airfoil defines a second section having a second section leading edge (LE2) and a second section trailing edge (TE2), with the LE2 at the forward-most point of the section and the TE2 at the aft-most point of the second section. Averaging the coordinates of LE1 and LE2 yields a representative LE location for the airfoil section. Averaging the coordinates of TE1 and TE2 yields a representative TE location for the airfoil section. The LE and TE points obtained this way are indicated in FIGS. 6 and 6B. An “Airfoil Section” defined herein has its leading and trailing edges TE, LE determined in this manner. “Effective Quarter-chord point” (“QC”) is defined as ¼ of the distance from the leading edge LE of the airfoil section determined in the foregoing manner, measured along the chord of this airfoil section. QC is dependent on the fan diameter (D) because the airfoil section LE and TE values change if D for the unducted fan propulsor changes.

“Cruise Speed” refers to aircraft speed and applies to a vehicle with a cruising altitude up to approximately 65,000 ft. In certain embodiments, cruise altitude is between approximately 28,000 ft. and approximately 45,000 ft. In still certain embodiments, cruise altitude is expressed in flight levels based on a standard air pressure at sea level, in which a cruise flight condition is between FL280 and FL650. In another embodiment, cruise flight condition is between FL280 and FL450. In still certain embodiments, cruise altitude is defined based at least on a barometric pressure, in which cruise altitude is between approximately 4.85 psia and approximately 0.82 psia based on a sea level pressure of approximately 14.70 psia and sea level temperature at approximately 59 degrees Fahrenheit. In another embodiment, cruise altitude is between approximately 4.85 psia and approximately 2.14 psia. It should be appreciated that in certain embodiments, the ranges of cruise altitude defined by pressure may be adjusted based on a different reference sea level pressure and/or sea level temperature.

It is understood that the plurality blades, whether forward or rearward, may have a variation of root forward-most points and root rearward-most points. This can be due to both installed position as well as orientation in the case of variable pitch blades. For purposes of defining the distances TRL, RTL, and VTL it is understood that a rotating blade or rotating array of blades are orientated such that the respective leading edges of the blades are in their most forward position, e.g., a feathered position. The respective trailing edge position is also obtained when the leading edge is in the most forward position. For purposes of defining the distances TRL, RTL, and VTL it is understood that the forward or leading edge or rearward or trailing edge of a stationary blade (or vane) or array of stationary blades (or vanes) is the most forward or leading edge position across the array of vanes or the most rearward or trailing edge position across the array of vanes.

“Blade” can refer to a stationary or rotating blade. “Stationary blade(s)” has the same meaning as “vane(s)”.

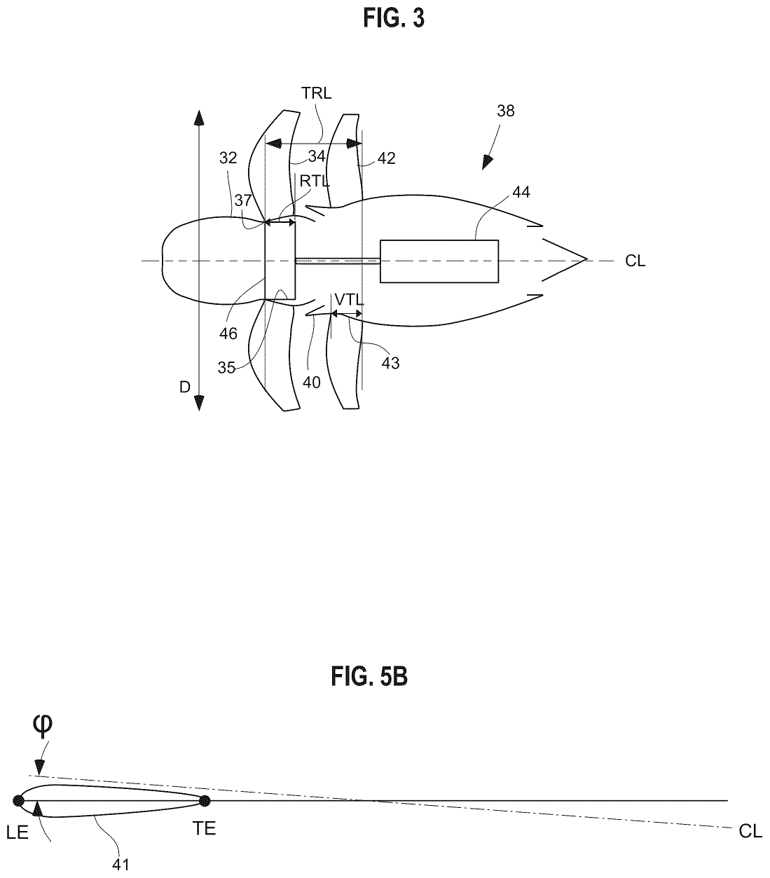

“Unducted fan propulsor” as used herein means an aircraft engine characterized by an array of rotating fan blades and static (or non-rotating), outlet guide vanes (OGV) aft of the array of rotating fan blades, or an array of rotating fan blades and static, unducted inlet guide vanes (IGV) forward of the rotating fan blades. In either case, neither the fan blades nor the IGV or OGV is surrounded by a duct or fan nacelle. FIG. 3 depicts an unducted fan propulsor. Additionally, the term unducted fan propulsor means an unducted, fan driven aircraft engine capable of providing thrust to an aircraft to enable cruise flight speeds between 0.7 Mach and 0.90 Mach, or 0.75 to 0.85 Mach.

“Aircraft” means a vehicle having a wing (and/or horizontal stabilizer), an airfoil defined by the wing (and/or horizontal stabilizer), and one or two unducted fan propulsors mounted to the wing, and the aircraft is operable at cruise flight speeds between 0.7 Mach and 0.90 Mach, or 0.75 to 0.85 Mach.

“Fuselage centerplane” (“FCP”) is defined as a plane that is located equidistant from the wingtips, intersecting the fuselage, and containing the gravity vector when the aircraft is on the ground.

Approximating language, as used herein throughout the specification and claims, is applied to modify any quantitative representation that could permissibly vary without resulting in a change in the basic function to which it is related. Accordingly, a value modified by a term or terms such as “about”, “approximately”, and “substantially”, are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

As used herein, the term “proximate” refers to being closer to one side or end than an opposite side or end.

The inventors were faced with a problem of how to improve thrust delivered to an aircraft by an unducted fan propulsor without increasing the required engine power delivered to the unducted fan of the unducted fan propulsor.

It was surprisingly found that the solution to this problem is heavily dependent on the location of the unducted fan propulsor relative to the aircraft wing.

The inventors found that installing an unducted fan propulsor presents the challenge of addressing penalties that can result due to the interaction with the rest of the aircraft. The manner in which these penalties are addressed according to the claimed subject matter is unique for this type of engine.

An unducted fan propulsor is particularly challenged due to the scrubbing and interference drags relative to a ducted turbofan. That additional drag then results in a higher thrust needed from the propulsor. Generally, higher thrust for a ducted turbofan comes with a larger power requirement and thus more fuel flow. For the unducted fan propulsor it was surprisingly found by placing the engine so that it can take advantage of the high pressure flow induced by the wing (and/or a horizontal stabilizer), engine thrust may increase without increasing the power requirement on the engine. This placement of the engine relative to the wing then acts to offset the scrubbing and interference drag, thus not increasing the required fuel (or reducing the increased fuel flow required for a non-optimum engine placement). The inventors found that increased drag effects associated with an unducted fan propulsor, rather than addressed directly, may instead be offset by placing the engine at a more optimal location relative to the wing.

Additionally, the inventors found that the installed engine's improved position also positively influences the noise produced by the wing-engine interaction during flight at cruise conditions.

It was surprisingly found that by adapting a particular location on an unducted fan propulsor relative to an aircraft wing's effective quarter chord point (QC), the desired result of offsetting interference and scrubbing drag without increasing the power delivered to the fan could be achieved for an unducted fan propulsor.

It was also found that the improved position is dependent on the fan blade size of the unducted fan propulsor.

As explained below, after recognizing the novel flow characteristics associated with an unducted fan propulsor installed on an aircraft, taking into account the limitations on where to place this propulsor, the inventors were surprisingly able to establish criteria for positioning the propulsor relative to an aircraft wing to offset interference and scrubbing effects by defining a midpoint (P) location between external output guide vanes (OGV) or input guide vanes (IGV) and a forward or aft rotating array of fan blades, respectively, and additionally defining the distance from the effective quarter chord point (QC) to P. The position of P relative to QC and QC itself were found dependent on the rotating fan diameter. The correlation of these parameters to offset interference and scrubbing effects was not used before and was the surprising finding of the inventors for an unducted fan propulsor. Thus, mounting unducted fan propulsors relative to the effective quarter-chord point (QC) and fan blade size as described in embodiments provided herein offsets interference and scrubbing effects associated with an unducted fan propulsor and is an improvement over other mounting locations, including conventional mounting locations that are more forward of, and more in line with, a wing chord line.

Various aspects of the present disclosure describe aspects of an aircraft characterized in part by a specific relation between an effective quarter chord point (QC) of an airfoil section associated with a wing (or horizontal stabilizer) and the unducted fan propulsor, which is believed to result in improved aircraft performance and/or fuel efficiency. According to the disclosure, an aircraft includes a fuselage and an unducted fan propulsor installed relative to a section of the wing or the horizontal stabilizer.

Reference will now be made in detail to present embodiments of the disclosure, one or more examples of which are illustrated in the accompanying drawings. The detailed description uses numerical and letter designations to refer to features in the drawings. Like or similar designations in the drawings and description have been used to refer to like or similar parts of the disclosure.

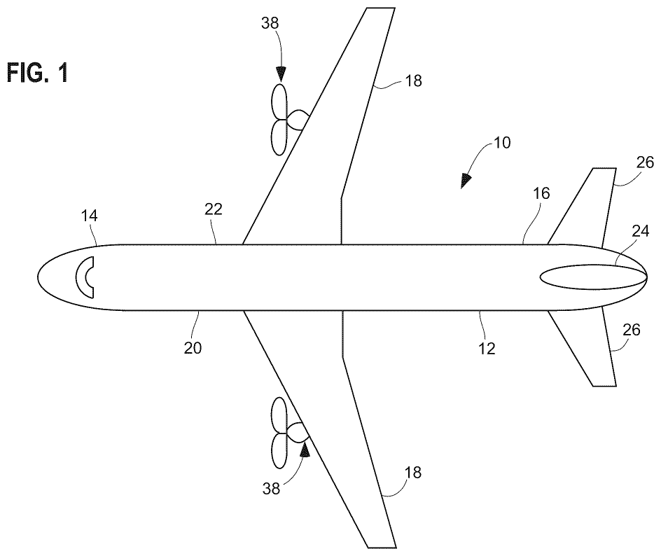

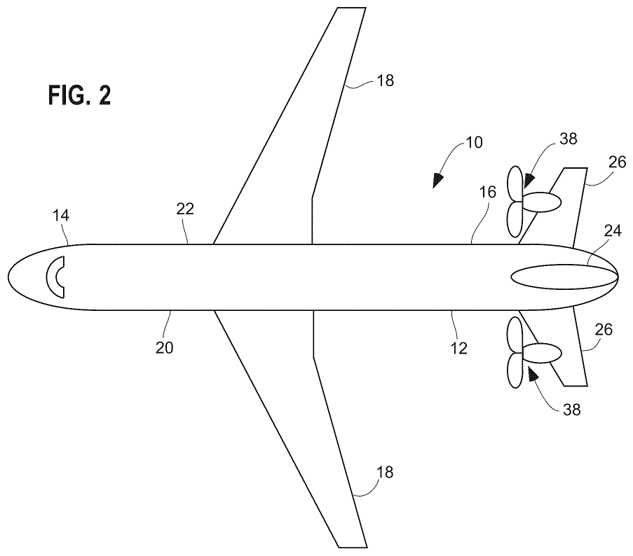

As shown in FIGS. 1 and 2, the aircraft 10 includes a fuselage 12 that extends longitudinally from a forward or nose section 14 and an aft or tail section 16 of the aircraft 10. The aircraft 10 further includes airfoils including a first wing 18 that extends laterally outwardly from a port side 20 and a second wing 18 that extends laterally outwardly from a starboard side 22 of the fuselage 12. The tail section 16 of the aircraft 10 includes a vertical stabilizer 24, a first airfoil of the horizontal stabilizer 26 that extends laterally outwardly from the port side 20, and a second airfoil of the horizontal stabilizer 26 that extends laterally outward from the starboard side 22 of the fuselage 12. An unducted fan propulsor 38 is undermounted relative to each of the wings 18, as shown in the embodiment of FIG. 1. Alternatively, the unducted fan propulsor 38 is mounted relative to the top of each of the horizontal stabilizers 26, as shown in FIG. 2. In some embodiments, more than one of the unducted fan propulsors 30 or 38 may be mounted to each of the wings 18 or each of the horizontal stabilizers 26.

FIG. 3 shows an elevational cross-sectional view of an embodiment of one of the unducted fan propulsors 38. As is seen from FIG. 3, the unducted fan propulsor 38 takes the form of an open fan propulsion system and has a rotating element in the form of rotatable propeller assembly 32 on which is mounted a first array of blades 34 around a centerline (CL) of the unducted fan propulsor 38. The first array of blades 34 defines a diameter D representing the tip-to-tip diameter of the blades and a maximum radial extent from CL. This diameter D is measured along a radial direction perpendicular to CL. The unducted fan propulsor 38 of FIG. 3 includes a second array of blades or vanes, which are non-rotating or static. In some embodiments, a non-rotating stationary element in the form of vane assembly 40 includes an array of vanes 42 disposed around CL.

Each of the blades 34 has a root 35 where the blade 34 is attached to the rotatable propeller assembly 32, and each blade 34 defines a root length (RTL). The root length (RTL) is defined as the axial extent (in a direction parallel to CL) from the radially innermost leading edge (LE) of the blade 34 airfoil, e.g., closest to CL, to the axial location of the radially innermost trailing edge (TE) of the blade 34 airfoil.

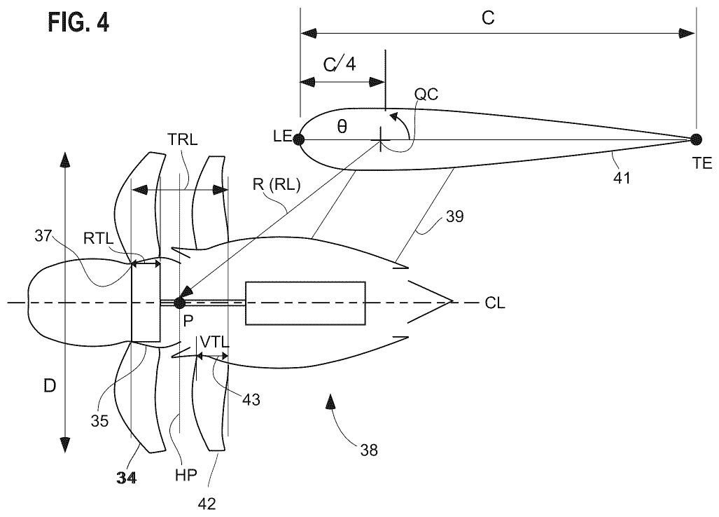

Each of the vanes 42 also has a root 43 with a vane root distance VTL where the vane 42 is attached to the non-rotating vane assembly 40. The total root length (TRL) is the distance between the leading edge (LE) of the blade 34 airfoil (radially nearest to CL) of the blades 34 and the trailing edge (LE) of the root 43 of the vanes 42, as shown in FIGS. 3 and 4. TRL is a measured axial distance from the radial innermost LE of the foremost row of blades/vanes and the trailing edge (TE) of the vanes 42. In some embodiments, the second array may instead be a second rotating elements and the TRL is the measured axial distance from the radially innermost LE of the blades 34 of the first rotating element and the TE of the root of the blades of the second rotating elements. In some embodiments, the vanes 42 may be forward of the rotating blades, and the TRL is the distance between the LE edge of the root of the vanes and the TE of the root of the rotating blades. In some embodiments, an unducted fan propulsor having rotating elements (e.g., rotating blades) and stationary elements (e.g. vanes) may be mounted according to the relationship described in the present disclosure. In unducted fan propulsors having multiple rows of blade and/or vanes, the TRL of an unducted fan propulsor is defined as the distance between the LE of the root of the foremost row of blades/vanes and the rearward edge of the root of the aftmost row of blades/vanes of the unducted fan propulsor.

Referring to FIG. 4, for purposes explained more later, the unducted fan propulsor 38 has a point P. For the unducted fan propulsor 38 with a first array of blades or vanes 34 and a second array of blades or vanes 42, as shown in FIGS. 3 and 4, the point P is located at the intersection of CL and a line HP perpendicular to CL and that passes through an axial midpoint of the total root length TRL between a forward end at the root of one of the blades 34 of the forward array and a rearward end at the root of one of the blades 42 of the rearward array when aligned with the one of the blades 34 of the forward array, as shown in FIG. 6. Either the forward or rearward array can be vanes or blades. In other words, the line HP is located equidistant from a forward end of the root of one of the forward vanes or blades 34 and a rearward end of the root of one of the rearward blades or vanes 42. The TRL of an unducted fan propulsor is defined as the distance between the LE of the root of the forward row of blades/vanes and the rearward edge of the root of the aftmost blade/vane.

Referring again to FIG. 3, the exemplary unducted fan propulsor 38 includes a drive mechanism 44 that provides torque and power to the propeller assembly 32 through a transmission 46. The drive mechanism 44 may be a gas turbine engine and associated transmission 46. Transmission 46 delivers torque from the drive mechanism 44 to the propeller assembly 32. The transmission system can be configured as a direct drive engine, transferring power from a power turbine or low pressure turbine (LPT) to the propeller assembly, or an indirect drive system where torque from the LPT is transferred to the propeller assembly 32 through a gearbox. The gearbox reduces a rotation speed of the drive shaft to match a desired rotational speed for the propeller assembly 32. The gas turbine engine includes in serial order a compressor, combustor, high pressure turbine and the LPT. In other embodiments the drive mechanism may generate power partially or fully by an electric motor. In the former case the drive mechanism is a hybrid electric drive mechanism including a gas turbine engine where a drive shaft includes an electric motor-generator for generating torque. In the latter case the drive mechanism is an electric motor.

The unducted fan propulsor 38 is attached relative to the wings 18 or horizontal stabilizer 26 through one or more intermediate components or features, e.g., a pylon 39, as shown in FIG. 4.

Each of the wings 18 shown in FIG. 1, and horizontal stabilizers 26 shown in FIG. 2, has an airfoil section 41 associated with it, where the airfoil section 41 is defined above.

As depicted in FIG. 4, a chord line C of the airfoil section, length C as shown, is a straight line extending from LE to TE of the airfoil section (it will be understood that the airfoil section as shown and defined herein is not meant to indicate any particular camber associated with an aircraft wing). The effective quarter-chord point (QC) of the airfoil section is located on the chord line. QC is located at a distance of C/4 from the LE of the airfoil section 41.

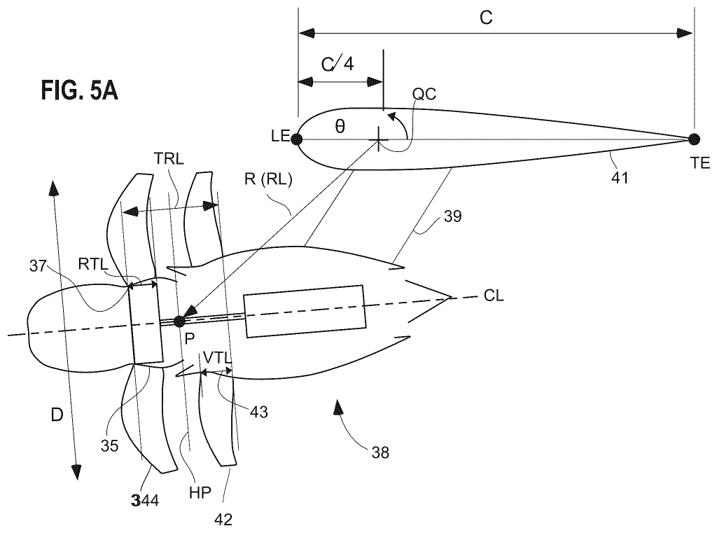

As shown in FIG. 4, the CL of the propulsor 38 and the chord line C are parallel to each other, corresponding to a zero pitch of the propulsor relative to the chord line C. The propulsor 38 can be pitched at different angles relative to the chord line, such as pitched downward as shown in FIG. 5A. FIG. 5B defines a pitch angle Φ for the propulsor 38, which is the angle spanned between the propulsor centerline CL and chord line C. Positive pitch corresponds to a clockwise rotation of CL relative to C. The pitch angle Φ can be fixed or variable during flight. For underwing installations, the pitch angle Φ can vary between −5 and +2 degrees, or it can vary between −3 and 0 degrees. During cruise conditions, propulsor pitch and toe angle (FIG. 6E, defined below) provide for an improved installed aerodynamic performance for the unducted fan propulsor in terms of reduced cabin noise and reduced off-axis loading of the unducted fan propulsor's drive shaft. For aft horizontal stabilizer or aft fuselage installations, the angle Φ can vary between −2 and +5 degrees to more align with downwash created by the wing.

The position of the open fan propulsor 38 is defined relative to QC. The airfoil section, as defined above, is the average of a first offset plane section and a second offset plane section of the airfoil (of the wing), where the first offset plane section is the section of the airfoil taken at a first plane and the second offset plane section is the section of the airfoil taken at a second plane, the first and second planes being offset in a direction perpendicular to, and equidistant from a central plane by a distance of ½ the maximum fan diameter (D) for the rotating blades, as shown in FIG. 6A. Both the gravity vector and axis of rotation of the rotating blades of the propulsor lie in this central plane when the aircraft is on the ground.

Referring to FIG. 6C, the propulsor 38—specifically, point P of the propulsor 38—has a spanwise location laterally offset from the fuselage centerplane (FCP) relative to the aircraft's wingspan B. P has a laterally offset position (LOP) between 10% and 80%, 20% and 40%, or between 25% and 35% of B/2 measured from the fuselage centerplane (FCP), as defined above. The location of P is also chosen to avoid interference with the fuselage or an adjacent propulsor if more than one propulsor is mounted relative to the wing. For an aft fuselage installation, the LOP of the propulsor will be closer to the fuselage, but far enough away from the fuselage's boundary layer to reduce or avoid undue interaction with the fuselage boundary layer.

As shown in FIG. 6C, the propulsor centerline CL and the fuselage centerplane (FCP) can be orientated parallel to each other. Referring to FIG. 6D, other angles between propulsor centerline CL and the fuselage centerplane (FCP) are contemplated. For an underwing mounted propulsor, the toe angle can provide added benefit when positive (i.e., the rotor toed-in towards the fuselage with the forward end of the propulsor 38 being more inboard than the aft end). The propulsor can have an inward toe angle of between 0 and 5 degrees, or between 1 and 3 degrees.

There are specific locations that the inventors have found to be advantageous to position the unducted fan propulsor 38 to generate increased thrust using higher pressure air flow, in order to offset the scrubbing and interference drag. The higher pressure air flow can be beneath the wings 18. In the case of a horizontal stabilizer 26, the higher pressure air flow is above the horizontal stabilizer 26. Accordingly, the high-pressure side of an airfoil may refer to the underside of a wing 18 or the top side of a horizontal stabilizer 26.

The aircraft described herein has a fuselage, wings and/or stabilizers, and two or more unducted fan propulsor systems (or propulsors). The unducted fan propulsor system, which is mounted on the pressure side of a wing or horizontal stabilizer, provides thrust to the aircraft. To improve upon what the propulsor system can deliver, there often is a need to make compromises to other parts of aircraft design (trade-offs). Stated another way, the benefits of an unducted fan propulsor cannot be viewed without consideration of the effect of placement of the propulsor on the aircraft. For example, placement can affect loads on and size of the pylon, wing loads, landing gear length and associated forces, weight, and cost.

The teachings described below enable improved balancing of the tradeoffs required in the aircraft design while positioning the unducted fan propulsor relative to the airfoil section's effective quarter chord point QC to offset scrubbing and interference drag loses.

Referring to FIG. 4, the location of an unducted fan propulsor relative to an airfoil section 41 is defined herein using a polar coordinate system having an angular (θ) coordinate and a radial (R) component, with origin located at the effective quarter chord point (QC) of the airfoil section having a chord length (C) as shown. The radial component is referred to herein as a “positioning line (R)”. The location of the point P of the unducted fan propulsor 38 relative to the origin (QC) of the polar coordinate system (the origin of the coordinate system is the same as the effective quarter chord point for airfoil section 41) is expressed in terms of a vector having radial component R with magnitude RL and angular component θ. The vector magnitude RL is called a “positioning line length (RL)”.

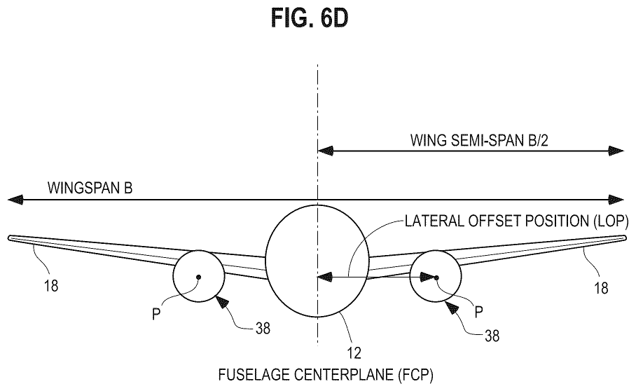

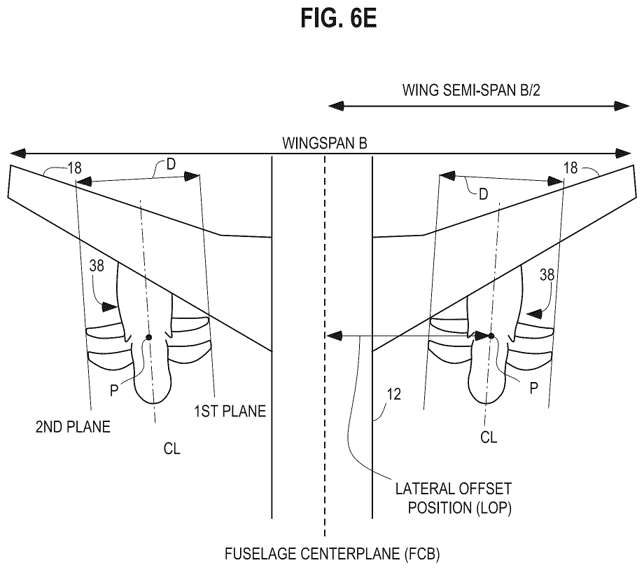

The angle θ is measured relative to a datum that is the airfoil section chord line (e.g., in FIG. 6 the vector R is located by an angle that is between 180 and 270 degrees measured counterclockwise about origin QC relative to the chord line). When viewed looking from an outboard position towards an inboard position (e.g., the fuselage), θ is positive in a counter-clockwise direction when the propulsor is below the airfoil section 41 (wing, FIG. 9), and θ is positive in a clockwise direction when the propulsor is above the airfoil section (horizontal stabilizer, FIG. 10) as indicated in the drawings, respectively, by the direction of the arrow from the origin.

The inventors found that for an unducted fan propulsor system the ratio of RL over D (i.e., RL/D) is desirably less than or equal to 2, less than or equal to 2 and greater than or equal to 0.15, or less than or equal to 2 and greater than or equal to 0.35. Additionally, for the undermounted unducted fan propulsor systems (pressure side of the airfoil section) of FIGS. 5 and 6 the angular component θ associated with these ranges for RL/D and locating the unducted fan propulsor system (i.e., the location of P relative to the airfoil section) are desirably between 187° and 342°, between 198° and 310°, or between 205° and 285°. These regions of RL and θ locating the unducted fan propulsor system relative to the airfoil section tend to offset scrubbing and interference drag for an unducted fan propulsor.

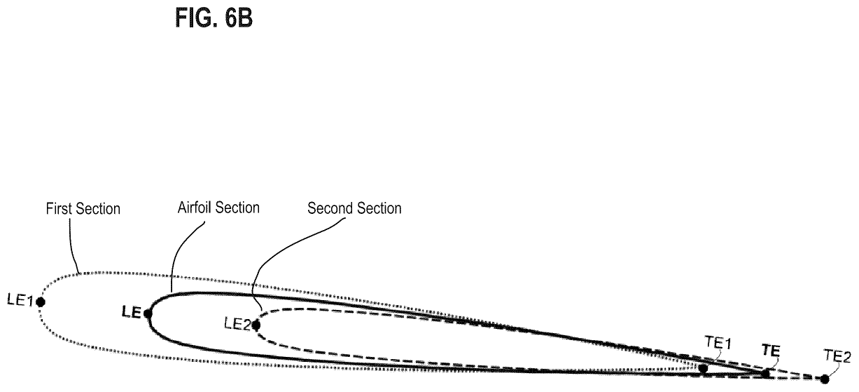

Alternatively, the point P for the unducted fan propulsor can be located within a defined ellipse defining a region relative to QC where scrubbing and interference drag tends to offset. FIGS. 7-10 each illustrate such ellipses according to several embodiments. Each of the ellipses has an origin OR, a major axis length (MajAL), and a minor axis length (MinAL), as shown in FIGS. 9 and 10 with respect to one of several ellipses and as will be explained further below. The location of OR is expressed relative to QC using the polar coordinate system frame of reference defined earlier. The propulsor system is mounted such that the point P of the unducted fan propulsors 38 is located within an ellipse as defined herein.

Referring to FIG. 9, the radial ellipse origin positioning line (EOR) extends from the ellipse origin OR, e.g., ellipse E1, to QC. The ellipse origin position line EOR has a length EORL. The origin of each of the ellipses is defined in the adopted polar coordinates with a radial coordinate defined as the ratio of EORL to the array of blades diameter (D), i.e., the quantity EORL/D. The angle θ is measured relative to the chord line (as defined earlier) and positive in a clockwise direction when the propulsor is above the airfoil section (horizontal stabilizer, FIG. 10) as indicated in the drawings, respectively, by the direction of the arrow from the origin.

An angle θ for the ellipse origin positioning line EOR is measured from a datum that is the chord line to an ellipse positioning line EOR (e.g., in FIG. 9 the vector EOR is located by an angle that is between 180 and 270 degrees measured counterclockwise about origin QC). A positive θ (1) increases in a counter-clockwise direction when the high pressure side of the airfoil section is below the airfoil section, and (2) increases in a clockwise direction when the high pressure side of the airfoil section is above the airfoil section.

In a first embodiment, the point P of the unducted fan propulsor 38 is located in a first ellipse E1 with a first ellipse origin defined by EORL/D of 0.938 and θ of 253.6°. The first ellipse E1 also has a first major axis length (1MajAL) and a first minor axis length (1MinAL), where 1MajAL/D is 2.8 and 1MinAL/D is 1.7. An unducted fan propulsor located within E1 tends to offset scrubbing and interference drag.

In a second embodiment, the point P of the unducted fan propulsor 38 is located in a second ellipse E2 having a second ellipse origin defined by EORL/D of 1.051 and θ of 248.8°. The second ellipse E2 has a second major axis length (2MajAL) and a second minor axis length (2MinAL), where 2MajAL/D is 1.86 and 2MinAL/D is 1.56. An unducted fan propulsor located within E2 tends to offset scrubbing and interference drag.

In a third embodiment, the point P of the unducted fan propulsor 38 is located in a third ellipse E3 having a third ellipse origin defined by EORL/D of 0.870 and θ of 239.6°. The third ellipse E3 has a third major axis length (3MajAL) and a third minor axis length (3MinAL), where 3MajAL/D is 1.4 and 3MinAL/D is 0.9. An unducted fan propulsor located within E3 tends to offset scrubbing and interference drag.

In a fourth embodiment, the point P of the unducted fan propulsor 38 is located in a fourth ellipse E4 having a fourth ellipse origin defined by EORL/D of 0.763 and θ of 235.7°. The fourth ellipse E4 has a fourth major axis length (4MajAL) and a fourth minor axis length (4MinAL), where 4MajAL/D is 0.94 and 4MinAL/D is 0.44. An unducted fan propulsor located within E4 tends to offset scrubbing and interference drag.

The location of the unducted fan propulsor system (i.e., point P) relative to the airfoil section may also be expressed in terms of the following expressions:

$$\frac{R L}{D} + \frac{\begin{matrix}( \sqrt{a * [ b * {sin}^{2} ( θ ) - c * {cos}^{2} ( θ ) + d * sin ( θ ) * cos ( θ ) ]} + \\ e * sin ( θ ) + f * cos ( θ )\end{matrix}}{g * {sin}^{2} ( θ ) + h * {cos}^{2} ( θ )} > 0$$

$$and$$

$$\frac{R L}{D} + \frac{\begin{matrix}( - \sqrt{a * [ b * {sin}^{2} ( θ ) - c * {cos}^{2} ( θ ) + d * sin ( θ ) * cos ( θ ) ]} + \\ e * sin ( θ ) + f * cos ( θ ) )\end{matrix}}{g * {sin}^{2} ( θ ) + h * {cos}^{2} ( θ )} < 0$$

where 0.07<RL/D<1.98 and θ is between 187° and 340°, and where a, b, c, d, e, f, g and h have the values set forth in the following table under the heading “Fifth Emb.”:

| | Fifth | Sixth | Seventh | Eighth |
|---|---|---|---|---|
| Variable | Emb. | Emb. | Emb. | Emb. |
| a | 1.4161 | 0.52621 | 0.09923 | 0.01069156 |
| b | 1.88978 | 0.7205 | 0.2964 | 0.036 |
| c | 0.0875 | 0.352 | 0.36 | 0.3485 |
| d | 0.477 | 0.7448 | 0.66 | 0.5418 |
| e | 1.764 | 0.8476 | 0.3675 | 0.139167 |
| f | 0.19146 | 0.23119 | 0.0891 | 0.020812 |
| g | 1.96 | 0.8649 | 0.49 | 0.2209 |
| h | 0.7225 | 0.6084 | 0.2025 | 0.0484 |

In a sixth embodiment, the point P of the unducted fan propulsor 38 can be defined by the above expression, but where 0.254<RL/D<1.86 and θ is between 199° and 306°, and where a, b, c, d, e, f, g and h have the values set forth in the above table under the heading “Sixth Emb.”

In a seventh embodiment, the point P of the unducted fan propulsor 38 can be defined by the above expression, but where 0.369<RL/D<1.43 and θ is between 204° and 291°, and where a, b, c, d, e, f, g and h have the values set forth in the above table under the heading “Seventh Emb.”.

In an eighth embodiment, the point P of the unducted fan propulsor 38 can be defined by the above expression, but where 0.477<RL/D<0.9455 and θ is between 211° and 274°, And where a, b, c, d, e, f, g and h have the values set forth in the above table under the heading “Eighth Emb.”

The unducted fan propulsor locations illustrated in FIG. 7 are made relative to an airfoil section of an aircraft wing and refer to an undermounted unducted fan propulsor system.

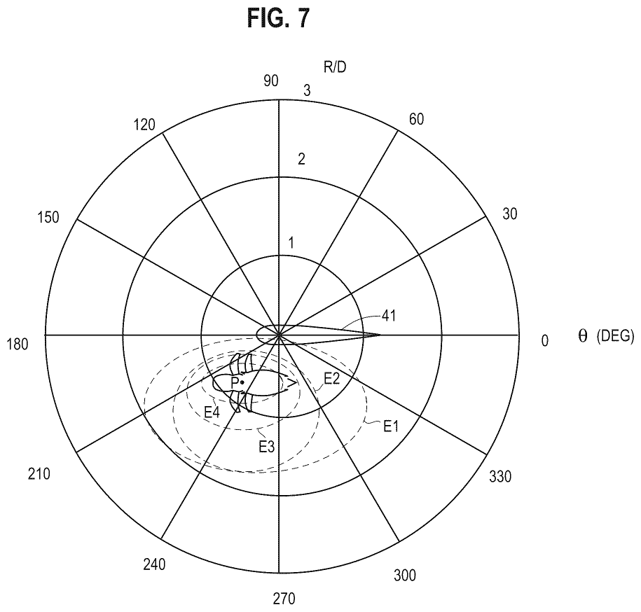

TABLES 1 and 3-6 set forth examples of embodiments of invention. TABLE 1 shows each maximum outer diameter (D) and the location of point P of the unducted fan propulsor relative to the effective quarter chord point, QC, contemplated, where the point P is defined by RL and θ. The term “Ref.” refers to the row in Table 1 for reference. The exemplary types of aircraft indicated with reference letters A through I in TABLE 1 are identified in TABLE 2. The point P of the unducted fan propulsor locations from TABLE 1 are shown in FIG. 11 for an under-wing mounted propulsor (for a propulsor mounted above a horizontal stabilizer the maximum outer diameter (D) and the point P of the unducted fan propulsor locations would be mirrored about the chord line of the airfoil section, which, for purposes of explanation, may be thought of as an axis passing through θ=0 deg and θ=180 deg in FIG. 11) relative to the first ellipse (E1), second ellipse (E2), third ellipse (E3), and the fourth ellipse (E4). The size of the points in FIG. 11 represent the relative size of D for the range provided in TABLE 1 (not to scale). The rotating blades diameter (D) may be between 2-50, 8-16, 10-15, 12-14, or 14-16 feet.

TABLE 1
P-location relative to the effective quarter chord point (QC)

| | Type of | RL | D | θ | |
|---|---|---|---|---|---|
| Ref. | aircraft | (ft) | (ft) | (deg) | RL/D |
| 1 | C I | 2.60 | 2.0 | 220.00 | 1.30 |
| 2 | F I | 1.07 | 2.0 | 189.00 | 0.54 |
| 3 | I | 3.13 | 2.0 | 199.73 | 1.57 |
| 4 | C F I | 2.18 | 3.0 | 319.20 | 0.73 |
| 5 | F I | 2.82 | 3.0 | 242.40 | 0.94 |
| 6 | C I | 1.47 | 4.0 | 293.60 | 0.37 |
| 7 | C I | 2.43 | 4.0 | 217.87 | 0.61 |
| 8 | I | 6.64 | 4.0 | 259.47 | 1.66 |
| 9 | C F I | 4.23 | 5.0 | 265.87 | 0.85 |
| 10 | C H I | 6.57 | 5.0 | 194.40 | 1.31 |
| 11 | F I | 2.03 | 5.0 | 250.93 | 0.41 |
| 12 | C F H I | 8.03 | 5.0 | 275.47 | 1.61 |
| 13 | C | 2.52 | 6.0 | 337.33 | 0.42 |
| 14 | H | 4.44 | 6.0 | 228.53 | 0.74 |
| 15 | C I | 1.88 | 6.0 | 208.27 | 0.31 |
| 16 | C F | 7.14 | 7.0 | 244.53 | 1.02 |
| 17 | B F H | 4.15 | 7.0 | 332.00 | 0.59 |
| 18 | B C I | 6.49 | 7.0 | 292.53 | 0.93 |
| 19 | C G | 8.05 | 8.0 | 216.80 | 1.01 |
| 20 | B F I | 11.89 | 8.0 | 256.27 | 1.49 |
| 21 | C G H | 10.08 | 8.0 | 277.60 | 1.26 |
| 22 | B C G I | 7.31 | 8.0 | 330.93 | 0.91 |
| 23 | C H | 9.97 | 8.0 | 294.67 | 1.25 |
| 24 | G I | 11.57 | 8.0 | 312.80 | 1.45 |
| 25 | B F I | 11.58 | 9.0 | 260.53 | 1.29 |
| 26 | C H | 6.06 | 9.0 | 224.27 | 0.67 |
| 27 | F G H | 3.06 | 9.0 | 233.87 | 0.34 |
| 28 | C I | 12.78 | 9.0 | 204.00 | 1.42 |
| 29 | B H | 10.47 | 10.0 | 210.40 | 1.05 |
| 30 | B I | 5.53 | 10.0 | 221.07 | 0.55 |
| 31 | A B C F G H | 7.00 | 10.0 | 253.07 | 0.70 |
| 32 | I | 2.47 | 10.0 | 306.40 | 0.25 |
| 33 | A C | 15.27 | 10.0 | 222.13 | 1.53 |
| 34 | G | 11.67 | 10.0 | 241.33 | 1.17 |
| 35 | A C F H | 17.13 | 10.0 | 243.47 | 1.71 |
| 36 | A B G I | 18.70 | 11.0 | 210.00 | 1.70 |
| 37 | G | 10.93 | 11.0 | 249.87 | 0.99 |
| 38 | A H | 4.33 | 11.0 | 285.07 | 0.39 |
| 39 | F I | 6.82 | 11.0 | 206.13 | 0.62 |
| 40 | A F H | 11.60 | 12.0 | 272.27 | 0.97 |
| 41 | A B F I | 10.64 | 12.0 | 227.47 | 0.89 |
| 42 | A H | 21.84 | 12.0 | 232.80 | 1.82 |
| 43 | A G | 8.56 | 12.0 | 236.00 | 0.71 |
| 44 | B F H | 0.78 | 12.0 | 263.50 | 0.07 |
| 45 | A F | 10.00 | 12.5 | 200.00 | 0.80 |
| 46 | A B G H I | 15.25 | 12.5 | 268.00 | 1.22 |
| 47 | B | 19.92 | 12.5 | 279.73 | 1.59 |
| 48 | A B F | 15.92 | 12.5 | 316.00 | 1.27 |
| 49 | A B | 6.25 | 12.5 | 270.13 | 0.50 |
| 50 | A F H | 18.42 | 12.5 | 211.47 | 1.47 |
| 51 | F G | 24.25 | 12.5 | 215.73 | 1.94 |
| 52 | A B H | 19.50 | 13.0 | 287.20 | 1.50 |
| 53 | H | 10.66 | 13.0 | 234.93 | 0.82 |
| 54 | B | 14.99 | 13.0 | 326.67 | 1.15 |
| 55 | I | 18.11 | 13.0 | 239.20 | 1.39 |
| 56 | A B F H | 23.49 | 13.0 | 225.33 | 1.81 |
| 57 | A F G H | 10.49 | 13.0 | 302.13 | 0.81 |
| 58 | B I | 3.38 | 13.0 | 231.73 | 0.26 |
| 59 | A B G | 13.95 | 13.0 | 212.53 | 1.07 |
| 60 | A B H | 10.14 | 13.0 | 255.20 | 0.78 |
| 61 | F | 10.80 | 13.5 | 215.00 | 0.80 |
| 62 | A H I | 19.35 | 13.5 | 198.67 | 1.43 |
| 63 | B F | 15.39 | 13.5 | 220.00 | 1.14 |
| 64 | A G H I | 7.83 | 13.5 | 207.20 | 0.58 |
| 65 | B H | 10.30 | 13.5 | 235.70 | 0.76 |
| 66 | A B | 23.49 | 13.5 | 237.07 | 1.74 |
| 67 | A H | 22.05 | 13.5 | 238.13 | 1.63 |
| 68 | F G | 13.08 | 13.5 | 192.00 | 0.97 |
| 69 | A B F | 6.03 | 13.5 | 195.47 | 0.45 |
| 70 | A F | 13.23 | 13.5 | 200.80 | 0.98 |
| 71 | B H | 16.89 | 14.0 | 201.87 | 1.21 |
| 72 | B I | 22.68 | 14.0 | 254.13 | 1.62 |
| 73 | A B F H | 24.17 | 14.0 | 269.07 | 1.73 |
| 74 | B E G | 19.69 | 14.0 | 301.07 | 1.41 |
| 75 | A | 12.60 | 14.0 | 223.20 | 0.90 |
| 76 | H I | 23.30 | 15.0 | 214.67 | 1.55 |
| 77 | A B E G H | 10.30 | 15.0 | 248.80 | 0.69 |
| 78 | A B E H | 17.90 | 15.0 | 288.27 | 1.19 |
| 79 | F G | 21.23 | 16.0 | 246.67 | 1.33 |
| 80 | A E | 8.64 | 16.0 | 290.40 | 0.54 |
| 81 | E G | 17.60 | 16.0 | 207.00 | 1.10 |
| 82 | A E | 25.20 | 18.0 | 230.00 | 1.40 |
| 83 | F | 19.80 | 18.0 | 225.00 | 1.10 |
| 84 | A G | 6.84 | 18.0 | 263.73 | 0.38 |
| 85 | A E | 35.64 | 18.0 | 221.00 | 1.98 |
| 86 | A E | 6.17 | 20.0 | 297.03 | 0.31 |
| 87 | F | 30.55 | 21.0 | 259.78 | 1.45 |
| 88 | A D | 10.99 | 22.0 | 252.33 | 0.50 |
| 89 | A E | 21.50 | 22.0 | 237.43 | 0.98 |
| 90 | D | 14.29 | 24.0 | 222.53 | 0.60 |
| 91 | D E | 25.75 | 24.0 | 319.38 | 1.07 |
| 92 | D E | 3.41 | 29.0 | 267.23 | 0.12 |
| 93 | D | 39.42 | 29.0 | 304.48 | 1.36 |
| 94 | E | 38.55 | 33.0 | 282.13 | 1.17 |
| 95 | D | 51.16 | 33.0 | 229.98 | 1.55 |
| 96 | D E | 44.23 | 35.0 | 215.08 | 1.26 |
| 97 | E | 24.18 | 35.0 | 311.93 | 0.69 |
| 98 | D | 8.53 | 40.0 | 207.63 | 0.21 |
| 99 | D | 31.45 | 40.0 | 274.68 | 0.79 |
| 100 | D | 18.19 | 45.0 | 334.28 | 0.40 |
| 101 | D | 42.32 | 48.0 | 192.73 | 0.88 |
| 102 | D | 90.00 | 50.0 | 244.88 | 1.80 |

TABLE 2

| Designator | |
|---|---|
| for | |
| TABLE 1 | Aircraft Type |
| A | Narrow Body, twin engine |
| B | Narrow Body, 4 engines |
| C | Narrow Body, distributed propulsors (>4 engines) |
| D | Wide Body, twin engine |
| E | Wide Body, 4 engines |
| F | Wide Body, distributed propulsors (>4 engines) |
| G | Regional Jet |
| H | Business Jet |
| I | UAV |

For Aircraft Type A, B, C and G having a Mach flight speed at cruise conditions of between 0.70 and 0.85 the fan diameter (D) is between 8 and 16 feet, or more preferably between 12 feet and 16 feet.

TABLES 3-6 provide exemplary embodiments for EORL and D for each of the first ellipse E1, second ellipse E2, third ellipse E3 and fourth ellipse E4, respectively, relative to the quarter chord point (QC).

TABLE 3
First Ellipse E1 Embodiments

| | | EORL | 1MajAL | 1MinAL | | | |
|---|---|---|---|---|---|---|---|
| D (ft) | θ (deg) | (ft) | (ft) | (ft) | EORL/D | 1MajAL/D | 1MinAL/D |
| 2 | 253.6 | 1.876 | 5.6 | 3.4 | 0.938 | 2.8 | 1.7 |
| 3 | 253.6 | 2.814 | 8.4 | 5.1 | 0.938 | 2.8 | 1.7 |
| 4 | 253.6 | 3.752 | 11.2 | 6.8 | 0.938 | 2.8 | 1.7 |
| 5 | 253.6 | 4.69 | 14 | 8.5 | 0.938 | 2.8 | 1.7 |
| 6 | 253.6 | 5.628 | 16.8 | 10.2 | 0.938 | 2.8 | 1.7 |
| 7 | 253.6 | 6.566 | 19.6 | 11.9 | 0.938 | 2.8 | 1.7 |
| 8 | 253.6 | 7.504 | 22.4 | 13.6 | 0.938 | 2.8 | 1.7 |
| 9 | 253.6 | 8.442 | 25.2 | 15.3 | 0.938 | 2.8 | 1.7 |
| 10 | 253.6 | 9.38 | 28 | 17 | 0.938 | 2.8 | 1.7 |
| 11 | 253.6 | 10.318 | 30.8 | 18.7 | 0.938 | 2.8 | 1.7 |
| 12 | 253.6 | 11.256 | 33.6 | 20.4 | 0.938 | 2.8 | 1.7 |
| 12.5 | 253.6 | 11.725 | 35 | 21.25 | 0.938 | 2.8 | 1.7 |
| 13 | 253.6 | 12.194 | 36.4 | 22.1 | 0.938 | 2.8 | 1.7 |
| 13.5 | 253.6 | 12.663 | 37.8 | 22.95 | 0.938 | 2.8 | 1.7 |
| 14 | 253.6 | 13.132 | 39.2 | 23.8 | 0.938 | 2.8 | 1.7 |
| 15 | 253.6 | 14.07 | 42 | 25.5 | 0.938 | 2.8 | 1.7 |
| 16 | 253.6 | 15.008 | 44.8 | 27.2 | 0.938 | 2.8 | 1.7 |
| 18 | 253.6 | 16.884 | 50.4 | 30.6 | 0.938 | 2.8 | 1.7 |
| 20 | 253.6 | 18.76 | 56 | 34 | 0.938 | 2.8 | 1.7 |
| 21 | 253.6 | 19.698 | 58.8 | 35.7 | 0.938 | 2.8 | 1.7 |
| 22 | 253.6 | 20.636 | 61.6 | 37.4 | 0.938 | 2.8 | 1.7 |
| 24 | 253.6 | 22.512 | 67.2 | 40.8 | 0.938 | 2.8 | 1.7 |
| 29 | 253.6 | 27.202 | 81.2 | 49.3 | 0.938 | 2.8 | 1.7 |
| 33 | 253.6 | 30.954 | 92.4 | 56.1 | 0.938 | 2.8 | 1.7 |
| 35 | 253.6 | 32.83 | 98 | 59.5 | 0.938 | 2.8 | 1.7 |
| 40 | 253.6 | 37.52 | 112 | 68 | 0.938 | 2.8 | 1.7 |
| 45 | 253.6 | 42.21 | 126 | 76.5 | 0.938 | 2.8 | 1.7 |
| 48 | 253.6 | 45.024 | 134.4 | 81.6 | 0.938 | 2.8 | 1.7 |
| 50 | 253.6 | 46.9 | 140 | 85 | 0.938 | 2.8 | 1.7 |

TABLE 4
Second Ellipse E2 Embodiments

| | | EORL | 2MajAL | 2MinA | | | |
|---|---|---|---|---|---|---|---|
| D (ft) | θ (deg) | (ft) | (ft) | L (ft) | EORL/D | 2MajAL/D | 2MinAL/D |
| 2 | 248.8 | 2.102 | 3.72 | 3.12 | 1.051 | 1.86 | 1.56 |
| 3 | 248.8 | 3.153 | 5.58 | 4.68 | 1.051 | 1.86 | 1.56 |
| 4 | 248.8 | 4.204 | 7.44 | 6.24 | 1.051 | 1.86 | 1.56 |
| 5 | 248.8 | 5.255 | 9.3 | 7.8 | 1.051 | 1.86 | 1.56 |
| 6 | 248.8 | 6.306 | 11.16 | 9.36 | 1.051 | 1.86 | 1.56 |
| 7 | 248.8 | 7.357 | 13.02 | 10.92 | 1.051 | 1.86 | 1.56 |
| 8 | 248.8 | 8.408 | 14.88 | 12.48 | 1.051 | 1.86 | 1.56 |
| 9 | 248.8 | 9.459 | 16.74 | 14.04 | 1.051 | 1.86 | 1.56 |
| 10 | 248.8 | 10.51 | 18.6 | 15.6 | 1.051 | 1.86 | 1.56 |
| 11 | 248.8 | 11.561 | 20.46 | 17.16 | 1.051 | 1.86 | 1.56 |
| 12 | 248.8 | 12.612 | 22.32 | 18.72 | 1.051 | 1.86 | 1.56 |
| 12.5 | 248.8 | 13.1375 | 23.25 | 19.5 | 1.051 | 1.86 | 1.56 |
| 13 | 248.8 | 13.663 | 24.18 | 20.28 | 1.051 | 1.86 | 1.56 |
| 13.5 | 248.8 | 14.1885 | 25.11 | 21.06 | 1.051 | 1.86 | 1.56 |
| 14 | 248.8 | 14.714 | 26.04 | 21.84 | 1.051 | 1.86 | 1.56 |
| 15 | 248.8 | 15.765 | 27.9 | 23.4 | 1.051 | 1.86 | 1.56 |
| 16 | 248.8 | 16.816 | 29.76 | 24.96 | 1.051 | 1.86 | 1.56 |
| 18 | 248.8 | 18.918 | 33.48 | 28.08 | 1.051 | 1.86 | 1.56 |
| 20 | 248.8 | 21.02 | 37.2 | 31.2 | 1.051 | 1.86 | 1.56 |
| 21 | 248.8 | 22.071 | 39.06 | 32.76 | 1.051 | 1.86 | 1.56 |
| 22 | 248.8 | 23.122 | 40.92 | 34.32 | 1.051 | 1.86 | 1.56 |
| 24 | 248.8 | 25.224 | 44.64 | 37.44 | 1.051 | 1.86 | 1.56 |
| 29 | 248.8 | 30.479 | 53.94 | 45.24 | 1.051 | 1.86 | 1.56 |
| 33 | 248.8 | 34.683 | 61.38 | 51.48 | 1.051 | 1.86 | 1.56 |
| 35 | 248.8 | 36.785 | 65.1 | 54.6 | 1.051 | 1.86 | 1.56 |
| 40 | 248.8 | 42.04 | 74.4 | 62.4 | 1.051 | 1.86 | 1.56 |
| 45 | 248.8 | 47.295 | 83.7 | 70.2 | 1.051 | 1.86 | 1.56 |
| 48 | 248.8 | 50.448 | 89.28 | 74.88 | 1.051 | 1.86 | 1.56 |
| 50 | 248.8 | 52.55 | 93 | 78 | 1.051 | 1.86 | 1.56 |

TABLE 5
Third Ellipse E3 Embodiments

| | | | 3MajAL | 3MinAL | | | |
|---|---|---|---|---|---|---|---|
| D (ft) | θ (deg) | EORL (ft) | (ft) | (ft) | EORL/D | 3MajAL/D | 3MinAL/D |
| 2 | 239.6 | 1.74 | 2.8 | 1.8 | 0.87 | 1.4 | 0.9 |
| 3 | 239.6 | 2.61 | 4.2 | 2.7 | 0.87 | 1.4 | 0.9 |
| 4 | 239.6 | 3.48 | 5.6 | 3.6 | 0.87 | 1.4 | 0.9 |
| 5 | 239.6 | 4.35 | 7 | 4.5 | 0.87 | 1.4 | 0.9 |
| 6 | 239.6 | 5.22 | 8.4 | 5.4 | 0.87 | 1.4 | 0.9 |
| 7 | 239.6 | 6.09 | 9.8 | 6.3 | 0.87 | 1.4 | 0.9 |
| 8 | 239.6 | 6.96 | 11.2 | 7.2 | 0.87 | 1.4 | 0.9 |
| 9 | 239.6 | 7.83 | 12.6 | 8.1 | 0.87 | 1.4 | 0.9 |
| 10 | 239.6 | 8.7 | 14 | 9 | 0.87 | 1.4 | 0.9 |
| 11 | 239.6 | 9.57 | 15.4 | 9.9 | 0.87 | 1.4 | 0.9 |
| 12 | 239.6 | 10.44 | 16.8 | 10.8 | 0.87 | 1.4 | 0.9 |
| 12.5 | 239.6 | 10.875 | 17.5 | 11.25 | 0.87 | 1.4 | 0.9 |
| 13 | 239.6 | 11.31 | 18.2 | 11.7 | 0.87 | 1.4 | 0.9 |
| 13.5 | 239.6 | 11.745 | 18.9 | 12.15 | 0.87 | 1.4 | 0.9 |
| 14 | 239.6 | 12.18 | 19.6 | 12.6 | 0.87 | 1.4 | 0.9 |
| 15 | 239.6 | 13.05 | 21 | 13.5 | 0.87 | 1.4 | 0.9 |
| 16 | 239.6 | 13.92 | 22.4 | 14.4 | 0.87 | 1.4 | 0.9 |
| 18 | 239.6 | 15.66 | 25.2 | 16.2 | 0.87 | 1.4 | 0.9 |
| 20 | 239.6 | 17.4 | 28 | 18 | 0.87 | 1.4 | 0.9 |
| 21 | 239.6 | 18.27 | 29.4 | 18.9 | 0.87 | 1.4 | 0.9 |
| 22 | 239.6 | 19.14 | 30.8 | 19.8 | 0.87 | 1.4 | 0.9 |
| 24 | 239.6 | 20.88 | 33.6 | 21.6 | 0.87 | 1.4 | 0.9 |
| 29 | 239.6 | 25.23 | 40.6 | 26.1 | 0.87 | 1.4 | 0.9 |
| 33 | 239.6 | 28.71 | 46.2 | 29.7 | 0.87 | 1.4 | 0.9 |
| 35 | 239.6 | 30.45 | 49 | 31.5 | 0.87 | 1.4 | 0.9 |
| 40 | 239.6 | 34.8 | 56 | 36 | 0.87 | 1.4 | 0.9 |
| 45 | 239.6 | 39.15 | 63 | 40.5 | 0.87 | 1.4 | 0.9 |
| 48 | 239.6 | 41.76 | 67.2 | 43.2 | 0.87 | 1.4 | 0.9 |
| 50 | 239.6 | 43.5 | 70 | 45 | 0.87 | 1.4 | 0.9 |

TABLE 6
Fourth Ellipse E4 Embodiments

| | | EORL | 4MajAL | 4MinAL | | | |
|---|---|---|---|---|---|---|---|
| D (ft) | θ (deg) | (ft) | (ft) | (ft) | EORL/D | 4MajAL/D | 4MinAL/D |
| 2 | 235.7 | 1.526 | 1.88 | 0.88 | 0.763 | 0.94 | 0.44 |
| 3 | 235.7 | 2.289 | 2.82 | 1.32 | 0.763 | 0.94 | 0.44 |
| 4 | 235.7 | 3.052 | 3.76 | 1.76 | 0.763 | 0.94 | 0.44 |
| 5 | 235.7 | 3.815 | 4.7 | 2.2 | 0.763 | 0.94 | 0.44 |
| 6 | 235.7 | 4.578 | 5.64 | 2.64 | 0.763 | 0.94 | 0.44 |
| 7 | 235.7 | 5.341 | 6.58 | 3.08 | 0.763 | 0.94 | 0.44 |
| 8 | 235.7 | 6.104 | 7.52 | 3.52 | 0.763 | 0.94 | 0.44 |
| 9 | 235.7 | 6.867 | 8.46 | 3.96 | 0.763 | 0.94 | 0.44 |
| 10 | 235.7 | 7.63 | 9.4 | 4.4 | 0.763 | 0.94 | 0.44 |
| 11 | 235.7 | 8.393 | 10.34 | 4.84 | 0.763 | 0.94 | 0.44 |
| 12 | 235.7 | 9.156 | 11.28 | 5.28 | 0.763 | 0.94 | 0.44 |
| 12.5 | 235.7 | 9.5375 | 11.75 | 5.5 | 0.763 | 0.94 | 0.44 |
| 13 | 235.7 | 9.919 | 12.22 | 5.72 | 0.763 | 0.94 | 0.44 |
| 13.5 | 235.7 | 10.3005 | 12.69 | 5.94 | 0.763 | 0.94 | 0.44 |
| 14 | 235.7 | 10.682 | 13.16 | 6.16 | 0.763 | 0.94 | 0.44 |
| 15 | 235.7 | 11.445 | 14.1 | 6.6 | 0.763 | 0.94 | 0.44 |
| 16 | 235.7 | 12.208 | 15.04 | 7.04 | 0.763 | 0.94 | 0.44 |
| 18 | 235.7 | 13.734 | 16.92 | 7.92 | 0.763 | 0.94 | 0.44 |
| 20 | 235.7 | 15.26 | 18.8 | 8.8 | 0.763 | 0.94 | 0.44 |
| 21 | 235.7 | 16.023 | 19.74 | 9.24 | 0.763 | 0.94 | 0.44 |
| 22 | 235.7 | 16.786 | 20.68 | 9.68 | 0.763 | 0.94 | 0.44 |
| 24 | 235.7 | 18.312 | 22.56 | 10.56 | 0.763 | 0.94 | 0.44 |
| 29 | 235.7 | 22.127 | 27.26 | 12.76 | 0.763 | 0.94 | 0.44 |
| 33 | 235.7 | 25.179 | 31.02 | 14.52 | 0.763 | 0.94 | 0.44 |
| 35 | 235.7 | 26.705 | 32.9 | 15.4 | 0.763 | 0.94 | 0.44 |
| 40 | 235.7 | 30.52 | 37.6 | 17.6 | 0.763 | 0.94 | 0.44 |
| 45 | 235.7 | 34.335 | 42.3 | 19.8 | 0.763 | 0.94 | 0.44 |
| 48 | 235.7 | 36.624 | 45.12 | 21.12 | 0.763 | 0.94 | 0.44 |
| 50 | 235.7 | 38.15 | 47 | 22 | 0.763 | 0.94 | 0.44 |

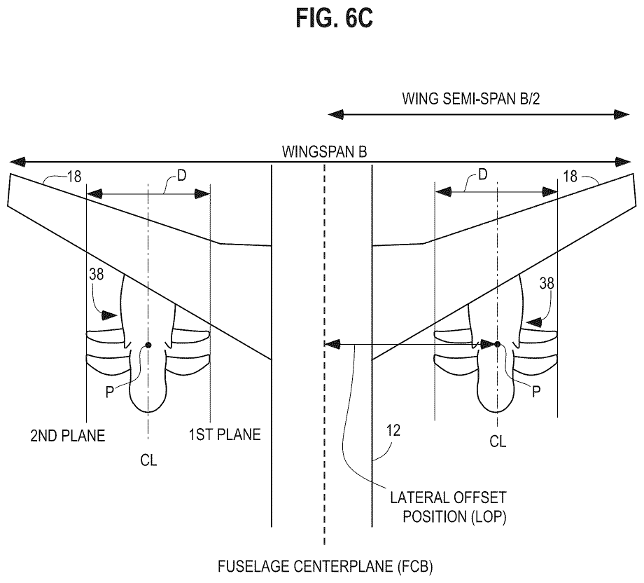

Referring to FIG. 8, the locations for P relative to the airfoil section and advantages therefrom described above can also be realized for an unducted fan propulsor system mounted above a horizontal stabilizer. For an unducted fan propulsor mounted to horizontal stabilizers, the foregoing examples and embodiments would be mirrored about the chord line of the airfoil section (again, for purposes of explanation, this chord line may be thought of as an axis passing through θ=0 deg and θ=180 deg in FIG. 11) for the case where the airfoil section 41 produces a lift in the downward direction, such as a horizontal stabilizer, as compared to a wing which produces a lift in the upward direction. The above descriptions for an undermount propulsor can apply, with the location being shifted as shown in FIG. 8 as compared to FIG. 7.

According to the foregoing examples or embodiments, the unducted fan propulsor 38, incorporating the vane assembly described herein, can be incorporated into an airplane or other aircraft having a cruise flight Mach M₀ of between 0.70 and 0.85, between 0.75 and 0.85, between 0.75 and 0.79, between 0.5 and 0.9, between 0.7 and 0.9, or between 0.75 and 0.9. A propulsor that is part of an airplane that operates at a high cruise flight Mach number (e.g., greater than 0.7) encounters velocities near the surfaces of the rotor, vanes, and nacelle that approach or exceed the speed of sound, or Mach 1.0. In general, friction drag increases roughly in proportion to the square of the air velocity. However, as the Mach number increases, a significant contributor to the increase in drag can come from wave drag. Wave drag is a drag resulting from shock waves that form as the flow of air near a surface becomes supersonic (e.g., Mach>1.0).

In addition to the cruise flight Mach number, another factor contributing to increased drag on propulsor surfaces is high non-dimensional cruise fan net thrust based on fan annular area and flight speed. The same acceleration of the air stream by the fan that produces thrust also tends to increase the drag force on the rotor, vanes, and nacelle.

Expressing thrust non-dimensionally in a way that accounts for flight speed, ambient conditions, and fan annular area yields a thrust parameter as follows:

$$\frac{{F}_{n e t}}{{ρ}_{0} {A}_{a n} {V}_{0}^{2}}$$

In the above thrust parameter, Fₙₑₜ is cruise fan net thrust, ρ₀ is ambient air density, Vₒ is cruise flight velocity, and Aₐₙ is fan stream tube cross-sectional area at the fan inlet. Fan annular area, Aₐₙ, is computed using a maximum radius as the tip radius of the forward-most rotor blades and a minimum radius as the minimum radius of the fan stream tube entering the fan.

A propulsor that operates at a high cruise fan net thrust parameter (e.g., greater than 0.06) tends to have higher propulsor velocities with risk of higher drag on propulsor surfaces.

According to any of the foregoing examples or embodiments, there may be a particularly beneficial range of a dimensionless cruise fan net thrust parameter normalized by ambient density, cruise flight speed squared, and fan stream tube annular area at fan inlet defined by the following expression:

$$0.15 > \frac{{F}_{net}}{{ρ}_{0} {A}_{a n} {V}_{0}^{2}} > 0.06$$

Both a high cruise flight Mach and high dimensionless cruise fan net thrust parameter contribute to higher drag levels on the propulsor surfaces. Advantageously, the specific unducted fan propulsor positions relative to the wing airfoil section, as described herein, can increase unducted fan propulsor net thrust for a given power input when there is a high cruise flight Mach and a high dimensionless cruise fan net thrust parameter.

Using the conditions described herein, the specific regions for placing the unducted fan propulsor system can be located where there is a relatively higher pressure on the high pressure side of the airfoil, beneath the wings or above the horizontal stabilizers. The higher pressure provides increased thrust from the unducted fan propulsor to thereby offset drag penalties resulting from the installation of unducted fan propulsors.

The foregoing conditions for the placement of the propulsors relative to the wing airfoils can be present for any mounting configuration of the propulsors wing. While the mounting configuration can be fixed, it is contemplated that the mounting configuration could be variable. For example, the mounting configuration of an unducted fan propulsor relative to a wing could be different for takeoff as compared to cruise operating conditions. In such a scenario, the foregoing conditions for placement of the propulsors relative to the wing airfoils can be present in either or both operating conditions, or any other operating condition.

The present disclosure further describes an unducted fan blade having a particular shape, such as a specific meanline curvature distribution and/or a specific spanwise loading distribution, to achieve desired aerodynamic and acoustic gains. Regarding the meanline curvature, for at least a portion of the blade span, the airfoil section can be shaped such that a relative curvature parameter is greater than 1.75 in a first leading-edge region, less than 0.75 in a second mid-chord region, and greater than 1.2 in a third trailing-edge region. Regarding the loading distribution, the blades are configured to exhibit a high root loading or camber relative to the outer span. In particular, the blades are configured to have a load distribution such that at any location between the blade root and 30% span, the value of an elemental specific torque (ΔRCu) is greater than or equal to 60% of the peak ΔRCu in the air stream. Alternatively, this loading distribution may be defined by a characteristic selected from the group consisting of: (a) a blade camber at 30% span that is at least 90% of a maximum blade camber between 50% span and 100% span, (b) a blade camber at 0% span that is at least 110% of the maximum blade camber between 50% span and 100% span, or (c) combinations thereof. Regarding the spanwise camber, the blades are configured to exhibit a high root camber relative to the outer span.

In the present disclosure, an aircraft includes an unducted fan propulsor positioned relative to a wing effective quarter chord point (QC) as defined hereinabove, utilizing blades having the specific meanline curvature and/or spanwise camber parameters described hereinbelow. The inventors of the present disclosure have found that mounting the propulsor in the specific aerodynamic locations defined by the RL/D and angle θ parameters creates a unique aerodynamic environment that, when combined with the disclosed blade geometries, enables structural and aerodynamic improvements not previously recognized.

Specifically, mounting the unducted fan propulsor in the high-pressure region of the airfoil (e.g., under the wing) according to the disclosed RL/D parameters results in the fan operating in a decelerated flow field. In this installation, the effective velocity seen by the fan (Ve) is strictly less than a free stream flight velocity (Vinf) (e.g., Ve may be 98% or less of Vinf) due to the flow deceleration caused by the proximity to the wing's pressure field. This deceleration naturally increases the thrust capability and aerodynamic efficiency of the propulsor for a given fan size.

This installed flow environment allows for specific design trade-offs when utilizing the disclosed blade technologies. Because the installation creates an environment of improved propulsive efficiency (due to the lower Ve), the blades may be scaled to reduce weight while maintaining desired thrust levels. For example, utilizing the disclosed blade curvature and loading profiles within this specific installation allows for a reduction in the fan diameter, a reduction in the blade chord length, a reduction in blade camber, or combinations thereof compared to an isolated open fan.

By integrating the blade design capable of stable shock management (via the disclosed chordwise curvature) and high power density (via the disclosed root loading) with the RL/D installation location, the propulsion system can capitalize on the installation efficiency benefits to reduce overall engine weight. For instance, the disclosed chordwise curvature parameters allow the blades to maintain suitable shock strength management even when the blade chord is reduced to take advantage of the installed flow deceleration. Similarly, the high root loading profile ensures that efficiency is maintained near the hub even as the fan diameter is potentially reduced. Thus, the combination provides an aircraft capable of sustained high-speed operation with improved fuel burn driven by both aerodynamic efficiency and structural weight reduction.

The specific mounting configuration defined by the RL/D parameters described herein creates a unique aerodynamic environment that enables specific blade scaling optimizations. When the unducted fan propulsor is positioned relative to the wing effective quarter chord point (QC) within the disclosed ranges (e.g., 0.07≤RL/D≤2.0), the propulsor operates within a region of flow deceleration caused by the wing's stagnation streamline and pressure field. In this specific installation, an effective velocity (Ve) of the airflow at the face of the unducted fan propulsor during an operating condition, such as during a cruise operating condition, is strictly less than a free stream velocity (Vinf) of the aircraft (where Vinf represents the velocity of the aircraft relative to the undisturbed air at the same operating condition).

This deceleration results in an effective advance ratio (Je) at the fan that is lower than an advance ratio calculated using the free stream velocity. In some embodiments, the positioning is selected such that a ratio of the effective velocity to the free stream velocity (Ve/Vinf) is less than 1.0. For example, the ratio (Ve/Vinf) may be greater than or equal to 0.95 and less than or equal to 0.995.

The inventors have discovered that this reduced effective velocity (Ve) naturally increases the thrust capability and aerodynamic efficiency of the propulsor for a given fan size compared to installations where the fan experiences the full free stream velocity. This “installation benefit” allows the blades to be structurally improved to reduce weight while maintaining a target thrust.

Accordingly, in some embodiments, the unducted fan propulsor is configured to generate a specific cruise fan net thrust based on this reduced effective velocity (Ve). Because the inflow is decelerated, the blades may be scaled down relative to a “baseline” installation that does not benefit from this flow suppression. For example, compared to a blade designed for an unducted fan propulsor mounted at a location where RL/D<0.07 or RL/D>2.0 (where the inflow velocity may be closer to Vinf), the blade according to the present disclosure may comprise a reduced chord length while generating a common (equivalent) cruise fan net thrust. Additionally, or alternatively, the blade may comprise a reduced span (i.e., a reduced maximum outer diameter D) relative to the blade of the unducted fan propulsor mounted where RL/D<0.07 or RL/D>2.0, while maintaining the common cruise fan net thrust. By utilizing the disclosed blade loading and curvature profiles in conjunction with the decelerated inflow of the claimed mounting location, the propulsion system achieves the required thrust with reduced engine weight and improved fuel burn.

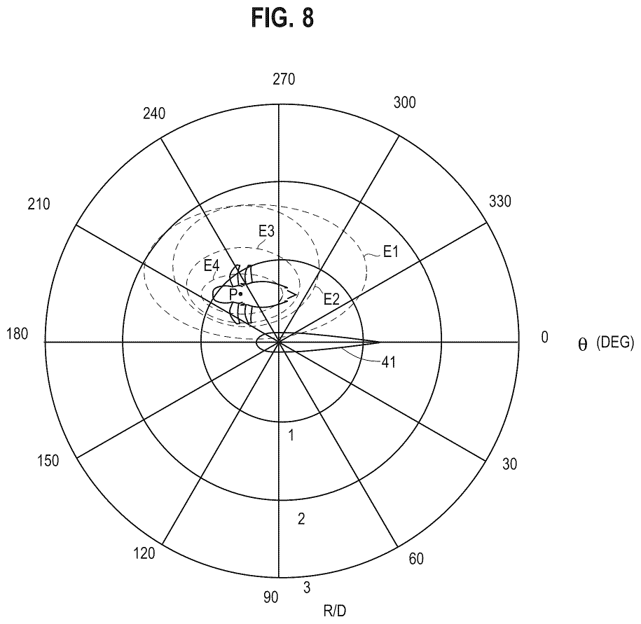

Referring now back briefly to, e.g., FIG. 3, providing the elevational cross-sectional view of an embodiment of one of the unducted fan propulsors 38, the unducted fan propulsor 38 provided includes the array of vanes 42 disposed around CL. These vanes 42 may be arranged such that they are not all equidistant from the propeller, and may optionally include an annular shroud or duct 100 distally from CL (as shown in FIG. 12) or may be unshrouded. These vanes are mounted to a stationary frame and do not rotate relative to CL. For reference purposes, in FIG. 3 a Forward direction, F, is towards the propeller assembly 32 and the unducted fan propulsor 38 is configured to produce thrust by moving a working fluid such as air in a direction Z, opposite the forward direct, F.

Vanes 42 of the stationary element are sized, shaped, and configured to decrease the swirl magnitude of the fluid, so as to increase the kinetic energy that generates thrust for a given shaft power input to the rotating element. For both blades and vanes, span is defined as the distance between root and tip. Vanes 42 may have a shorter span than blades 34, for example, 50% of the span of blades 34, or may have longer span or the same span as blades 34 as desired. Vanes 42 may be attached to an aircraft structure associated with the propulsion system, as shown in FIG. 3, or another aircraft structure such as a wing, pylon, or fuselage. Vanes 42 of the stationary element may be fewer or greater in number than, or the same in number as, the number of blades 34 of the rotating element and typically greater than two, or greater than four, in number.

Vanes 42 may be positioned aerodynamically upstream of the blades 34 so as to serve as counter swirl vanes, i.e., imparting a tangential velocity which is opposite to the rotation direction of the blades 34. Alternatively, and as shown in FIG. 3, vanes 42 may be positioned aerodynamically downstream of the blades 34 so as to serve as de-swirl vanes, i.e., imparting a change in tangential velocity which is counter to that of the blades 34. Any swirl remaining in the airstream downstream of the unducted fan propulsor 38 equates to a loss in thrust producing kinetic energy.

It may be desirable that either or both of the sets of blades 34 and vanes 42 incorporate a pitch change mechanism such that the blades and vanes can be rotated with respect to an axis of pitch rotation either independently or in conjunction with one another. Such pitch change can be utilized to vary thrust and/or swirl effects under various operating conditions, including to provide a thrust reversing feature which may be useful in certain operating conditions such as upon landing an aircraft.

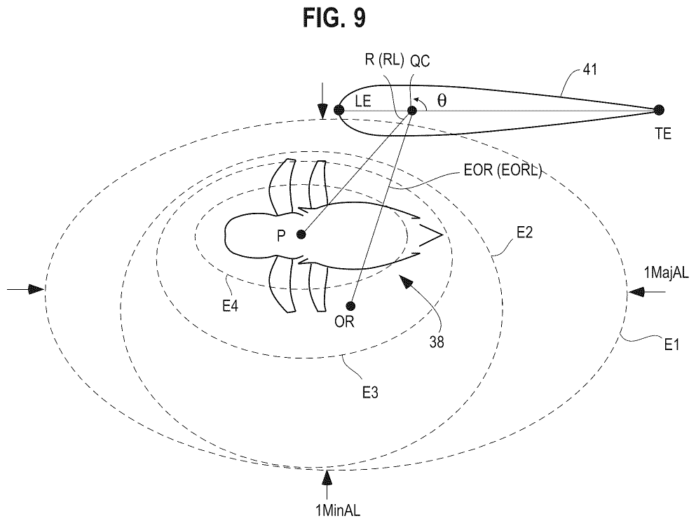

FIG. 13 depicts the change in Cu across the rotating and stationary elements, where Cu is the circumferential averaged tangential velocity. Vector diagrams are shown in a coordinate system in which the axial direction is in the downward direction and tangential direction is left to right. Multiplying the Cu times the airstream radius Ra gives the property RCu. The blade or vane loading at a given radius Ra is now defined as the change in RCu across the blade row (at a constant radius or along a streamtube), here forth referred to as ΔRCu and is a measure of the elemental specific torque of said blade row. Desirably, the ΔRCu for the rotating element should be in the direction of rotation throughout the span.

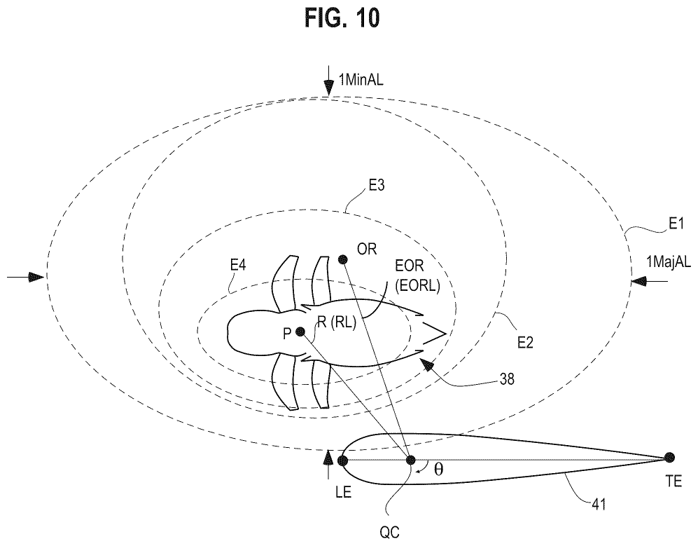

FIG. 14 is a graphical depiction of the aerodynamic load distribution vs. span of the rotating element 20 of the exemplary unducted fan propulsor 38. FIG. 14 illustrates three curves. The curve with the diamonds is a loading distribution for a conventional propeller assembly optimized for minimum wasted/unused kinetic energy for a single rotation propeller with no de-swirl system. The curves with the squares and triangles are a loading distributions for exemplary embodiments of the unducted fan propulsor 38 described herein. As shown in FIG. 14, both curves for the exemplary embodiment have a more uniform ΔRCu over the span, particularly in the region between the blade root and midspan. In fact, at a location of 30% span the value of ΔRCu is greater than or equal to 60% of the maximum value of ΔRCu, and, in an embodiment, is greater than or equal to 70% of the maximum value of ΔRCu, and, in an embodiment, is greater than or equal to 80% of the maximum value of ΔRCu. ΔRCu is measured across the rotating element (propeller blade row) in a conventional manner. Blades 34 are sized, shaped, and configured to deliver this loading distribution using techniques known to those of ordinary skill in the art.

Exemplary embodiments described herein demonstrate a particular distribution of ΔRCu across the blade of a rotating element or propeller assembly including a stationary element comprised of either de-swirl vanes or upstream counter-swirl vanes. In the design process this ΔRCu will be used in conjunction with the aircraft flight velocity, the rotational speed of the rotor, and the overall thrust required from the assembly to define the vector diagrams of the air.

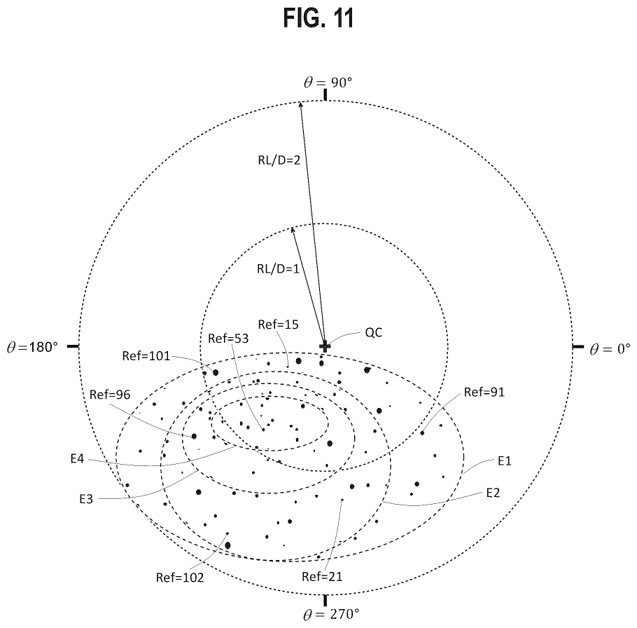

FIG. 15 depicts swirl, Cu, and axial velocity, Vz, at the exit of the unducted fan propulsor. FIG. 15 illustrates four curves. The curves with the diamonds and “x” symbols are for two conventional configurations, rotor only and conventional rotor with de-swirl vanes, respectively. The curves with squares and triangles are for two exemplary embodiments described herein. Compared to the conventional configurations, the embodiments have less exit swirl and more uniform axial velocity, indicating lower wasted kinetic energy in the exit stream and more energy converted into useful thrust.

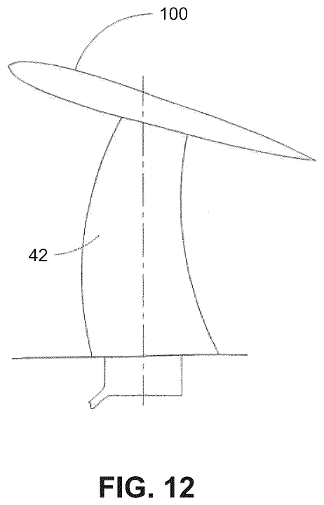

FIG. 16 depicts graphically how various parameters such as camber and stagger angle are defined with respect to a blade or vane. An airfoil meanline is a described as a line that bisects the airfoil thickness (or is equidistant from the suction surface and pressure surface) at all locations. The meanline intersects the airfoil at leading edge and trailing edge. The camber of an airfoil is defined as the angle change between the tangent to the airfoil meanline at the leading edge and the tangent to the angle meanline at the trailing edge. The stagger angle is defined as the angle the chord line makes with the centreline axis. Reference line 104 is parallel to axis CL, and reference line 102 is orthogonal to reference line 104.

In addition to the noise reduction benefit the duct 100 shown in FIG. 12 provides a benefit for vibratory response and structural integrity of the stationary vanes 42 by coupling them into an assembly forming an annular ring or one or more circumferential sectors, i.e., segments forming portions of an annular ring linking two or more vanes 42 such as pairs forming doublets. The duct 100 may allow the pitch of the vanes to be varied as desired.

A significant, perhaps even dominant, portion of the noise generated by the disclosed fan concept is associated with the interaction between wakes and turbulent flow generated by the upstream blade-row and its acceleration and impingement on the downstream blade-row surfaces. By introducing a partial duct acting as a shroud over the stationary vanes, the noise generated at the vane surface can be shielded to effectively create a shadow zone in the far field thereby reducing overall annoyance. As the duct is increased in axial length, the efficiency of acoustic radiation through the duct is further affected by the phenomenon of acoustic cut-off, which can be employed, as it is for conventional aircraft engines, to limit the sound radiating into the far-field. Furthermore, the introduction of the shroud allows for the opportunity to integrate acoustic treatment as it is currently done for conventional aircraft engines to attenuate sound as it reflects or otherwise interacts with the liner. By introducing acoustically treated surfaces on both the interior side of the shroud and the hub surfaces upstream and downstream of the stationary vanes, multiple reflections of acoustic waves emanating from the stationary vanes can be substantially attenuated.

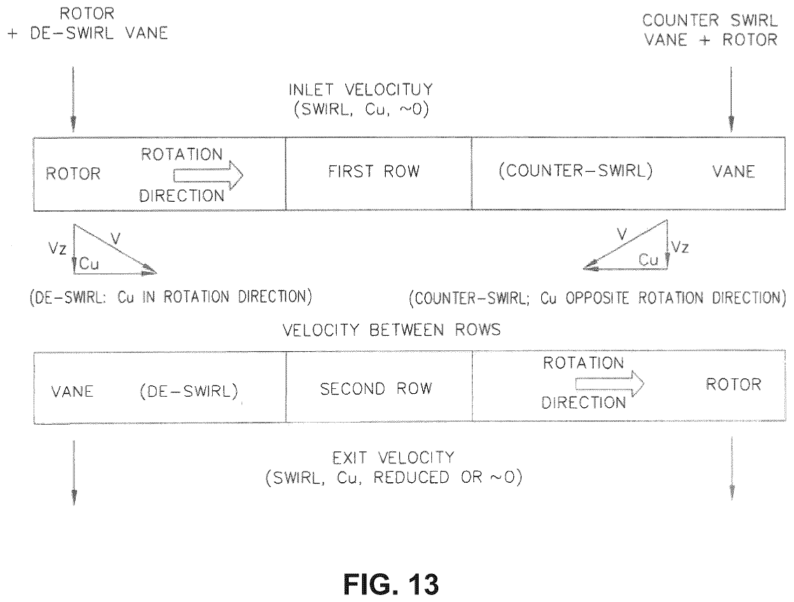

Following a design process blade geometries will be defined that create the desired vector diagrams as illustrated in FIG. 13. While the fundamental desired characteristic is a torque distribution, this will result in a blade geometry designed to achieve the desired torque distribution. An illustration of the change in geometry required to produce the desired torque characteristic, when compared to that currently optimum for a single rotation propeller without de-swirl vane, is shown in FIG. 17. It can be seen that this leads to a change in the blade cambers in the inner portion of the blade, i.e., from about 0 to approximately 50% span, and it is expected that characteristics of exemplary embodiments could also be loosely defined by a camber distribution. At least one of the following criteria are met: at 30% span the blade camber is at least 90% of the max camber level between 50% and 100% span; and the 0% span camber is at least CL0% of the max camber between 50% and 100% span.

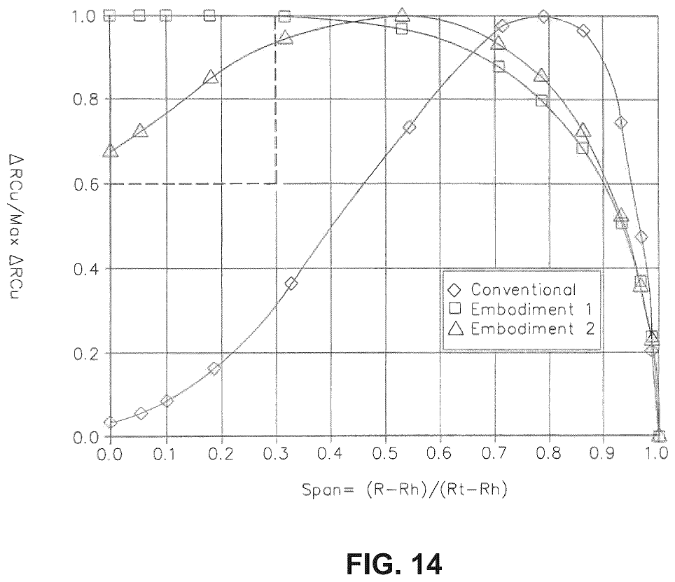

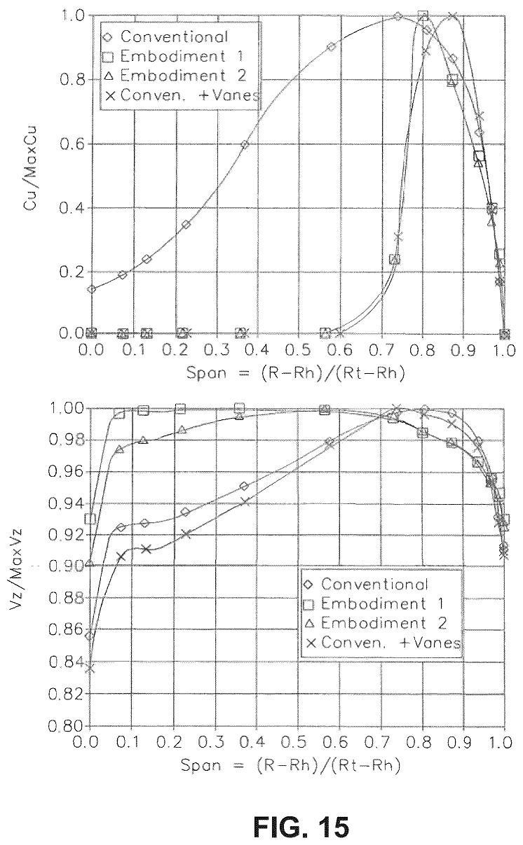

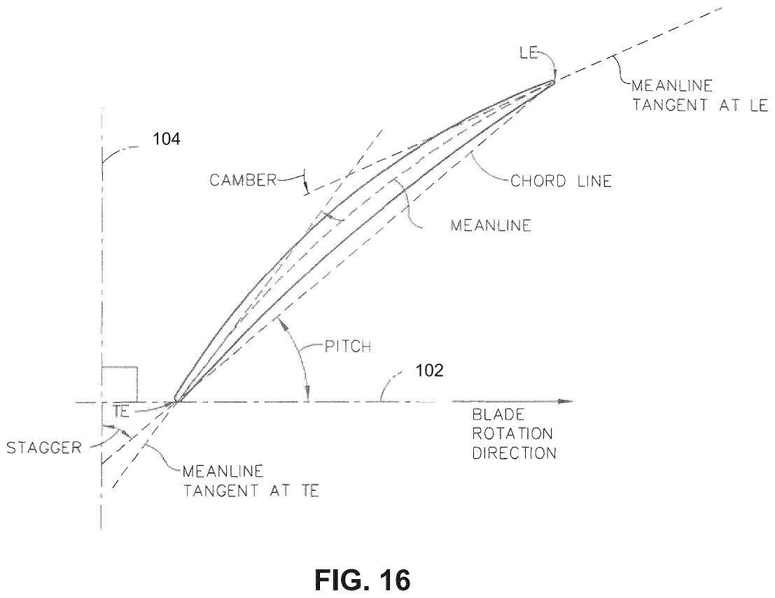

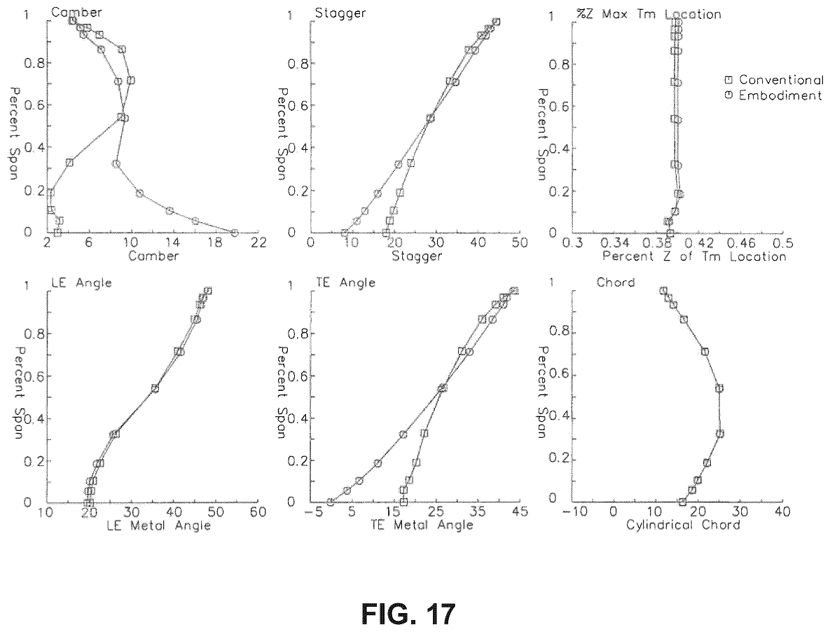

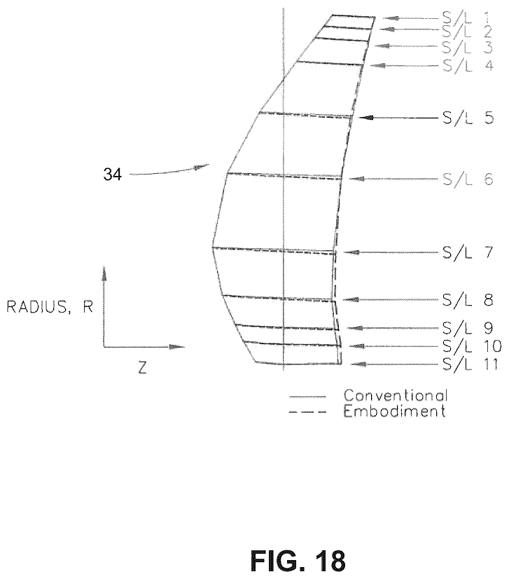

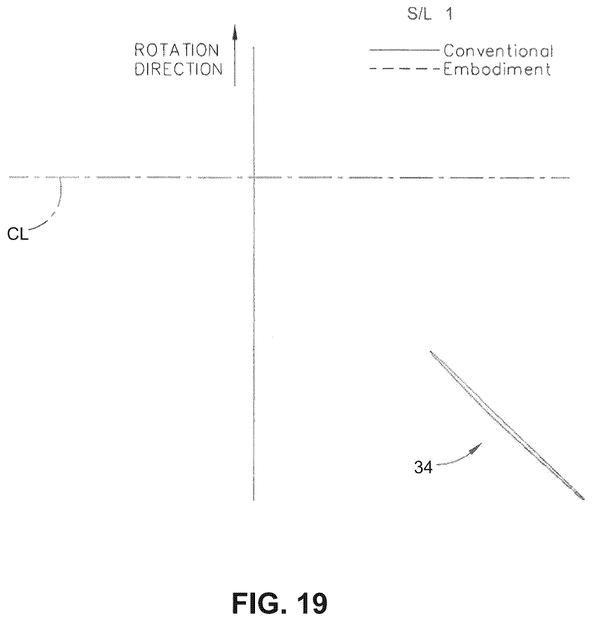

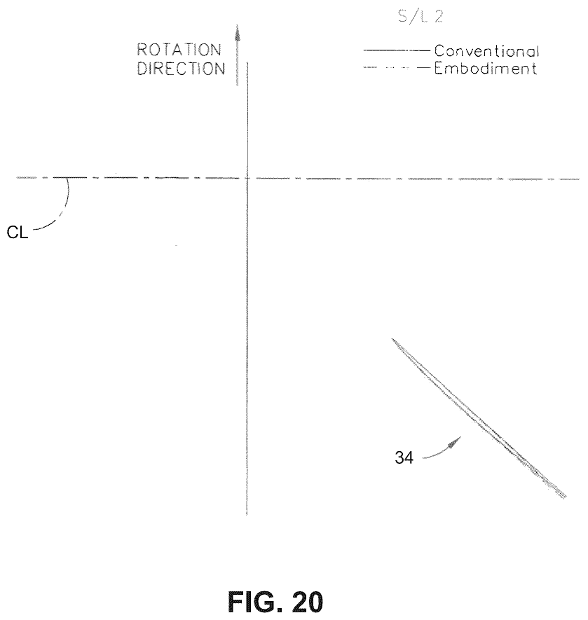

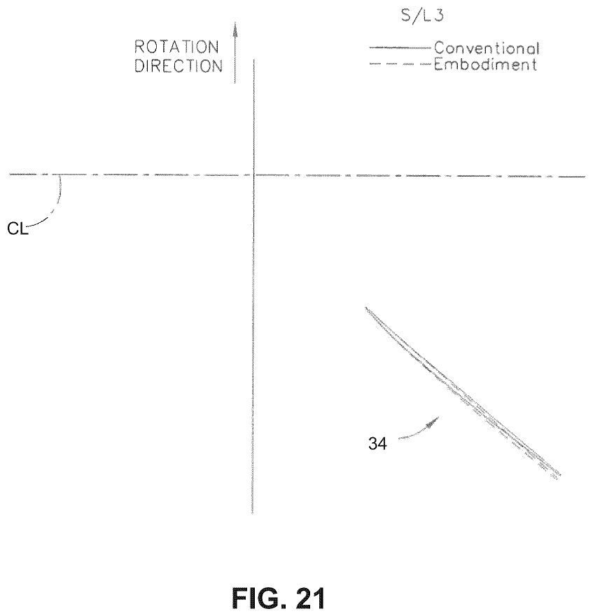

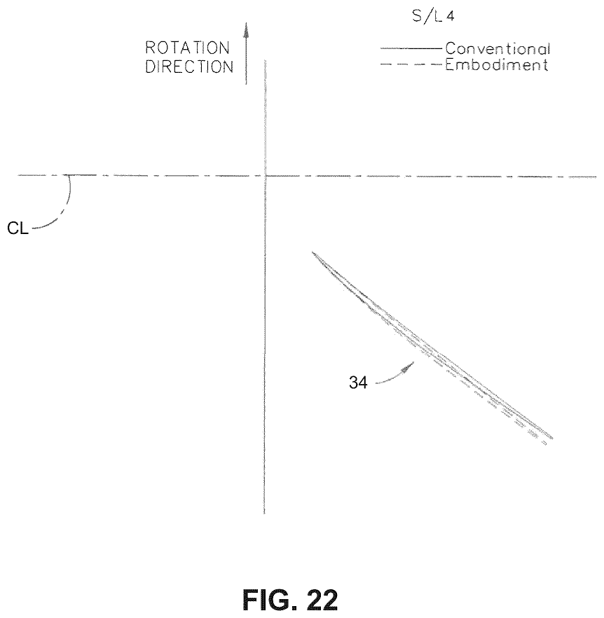

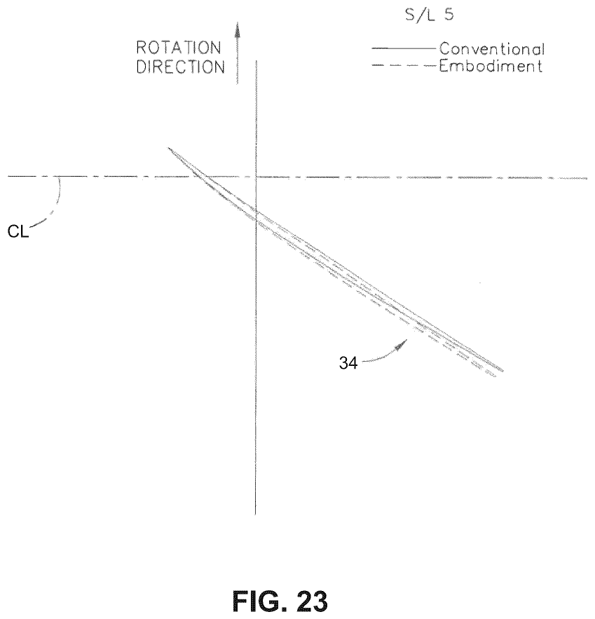

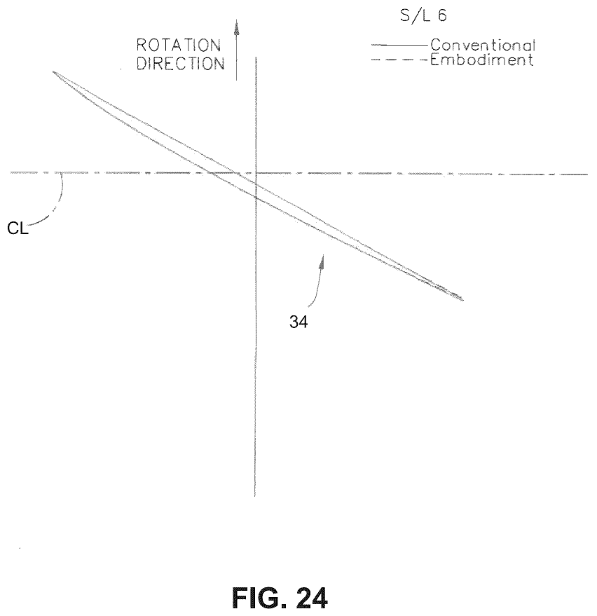

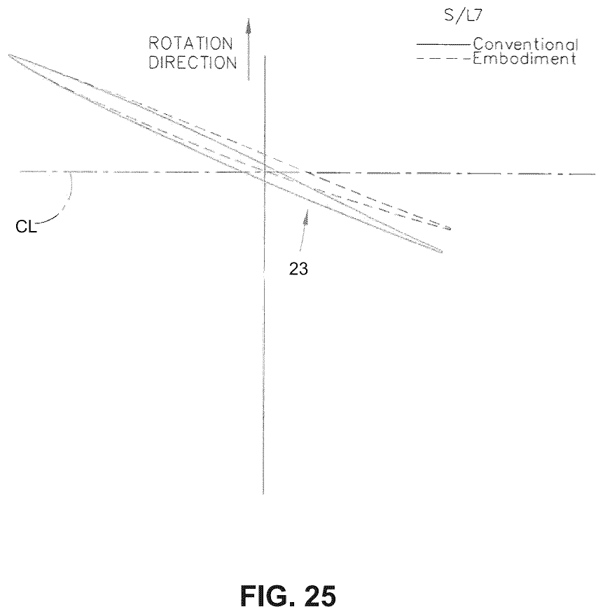

FIG. 18 is an elevational view of an exemplary airfoil blade 34, such as depicted in FIG. 1 for use with an unducted fan propulsor as described herein, with section line locations 1 through CL identified with section 1 being the blade tip and section CL being the blade root. The blade span is measured between the root and the tip. FIGS. 19 through 29 sequentially illustrate airfoil blade cross-sections at section line locations 1 through 11 for both an exemplary airfoil blade 34 and analogous sections through the conventional airfoil blade referenced previously. As shown in the sequence of illustrations, the two airfoil blades have cross-sections which are increasingly different in size, shape, and orientation in the direction from section 1 to section 11, i.e., from tip to root. Said differently, the region of greatest difference between the exemplary airfoil blade and the conventional airfoil blade is near the hub consistent with the largest difference in loading distribution.

It may be desirable to utilize the technologies described herein in combination with those described in the above referenced related applications.

In addition to configurations suited for use with a conventional aircraft platform intended for horizontal flight, the technology described herein could also be employed for helicopter and tilt rotor applications and other lifting devices, as well as hovering devices.

Other potential configurations include those designed to extract energy from an air stream and produce useful torque, such as windmills which utilize torque generated by extracting energy from the air moving past their location to drive generators and produce electricity. Such configurations may include upstream counter swirl vanes.

The technology described herein is particularly beneficial for aircraft that cruise with shaft power per unit annulus area of above 20 SHP/ft² (shaft horsepower per square foot) where the swirl losses can become significant. Loadings of 20 SHP/ft² and above permit aircraft to cruise at Mach numbers above 0.6 Mach number without requiring excessively large propeller areas to limit swirl losses. One of the major benefits of embodiments of the invention is its ability to achieve high shaft power per unit annulus area without significant swirl loss penalties and this opens the opportunity to cruise at Mach numbers of 0.8 and above.

The exemplary embodiment discloses a propeller assembly for a propulsion system. The propeller assembly comprises a plurality of propeller blades each having a blade root proximal to an axis of rotation, a blade tip remote from the axis, and a blade span measured between the blade root and the blade tip. The propeller assembly has a load distribution such that at any location between the blade root and 30% span the value of ΔRCu is greater than or equal to 60% of the peak ΔRCu, and, in an embodiment, at 30% span the value of ΔRCu is greater than or equal to 70% of the peak ΔRCu.

Unducted fan propulsors at high subsonic flight speeds have transonic blade airfoils where supersonic compression and expansion of the flow causes strong pressure pulses to propagate outward from the rotor blades and impact the aircraft fuselage, producing vibration and cabin noise. Since cabin noise is an obstacle to future acceptance of an unducted fan or open rotor engine architecture for commercial aircraft propulsion systems, it is preferable that cabin noise be minimized without compromising good aerodynamic performance.

A transonic rotor blade airfoil design is provided to minimize propeller source noise for cabin acoustics while maintaining good high-speed aerodynamic performance. In some embodiments, competing design goals are satisfied through a combination of aerodynamic solidities, blade count, aft sweep, tip dihedral, leading edge thickness, and chordwise suction-side pressure distributions, all with a near-optimum spanwise aerodynamic loading distribution. In some embodiments, the described rotor blade enables open rotor with high efficiency and lower source noise for cabin acoustics at high-speed cruise conditions and higher aerodynamic solidities for improved takeoff aerodynamics and acoustics. In some embodiments, the location of compression/shock near the trailing edge is more predictable and less sensitive to aerodynamic variations. In some embodiments, the delayed deceleration/diffusion on blade suction surface increases aerodynamic efficiency by prolonging laminar boundary layer. In some embodiments, the rotor blade design described herein contributes to open rotor competitive advantage.

Some conventional blade designs use airfoil chordwise loading distributions with maximum loading forward of mid-chord at aerodynamic design conditions, and generally use lower blade solidities (lower ratio of chord to circumferential spacing) and higher blade aspect ratios, and less sweep and tip dihedral. In some embodiments, the blade design described herein incorporates a combination of features to achieve noise reduction with good aerodynamic performance relative to the conventional open rotor blade.

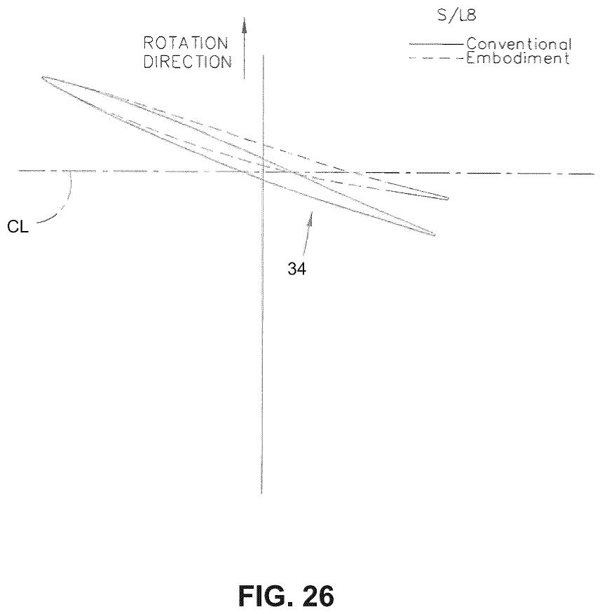

Referring to the drawings wherein identical reference numerals denote the same elements throughout the various views, FIG. 30 illustrates schematically an exemplary aircraft 210 including a pair of wings 212 and 214. Each wing 212 and 214 supports a propulsion device 216 via a pylon 218. Alternatively, one or more propulsion devices 216 may be mounted to any suitable location on aircraft 210.

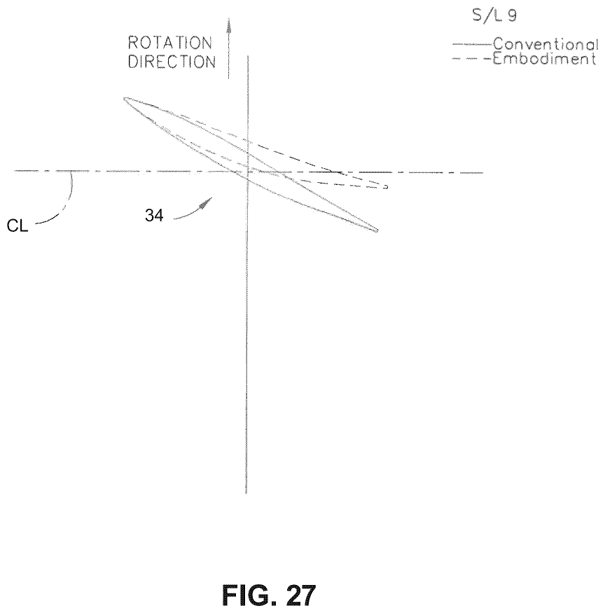

Referring to FIG. 31, one of the propulsion devices 216 is shown in more detail. The propulsion device 216 includes a prime mover 220 (shown schematically) enclosed in a nacelle 222 and coupled in driving relationship with an unducted fan 224 that is mounted for rotation about a centerline axis 226.

It is noted that, as used herein, the terms “axial” and “longitudinal” both refer to a direction parallel to the centerline axis 226, while “radial” refers to a direction perpendicular to the axial direction, and “tangential” or “circumferential” refers to a direction mutually perpendicular to the axial and radial directions. As used herein, the terms “forward” or “front” refer to a location relatively upstream in an air flow passing through or around a component, and the terms “aft” or “rear” refer to a location relatively downstream in an air flow passing through or around a component. The direction of this flow is shown by the arrows “F” in FIGS. 30 and 31. These directional terms are used merely for convenience in description and do not require a particular orientation of the structures described thereby.

The prime mover 220 may be any device operable to rotate the unducted fan 224 at the required speed under expected mechanical and aerodynamic loads. Nonlimiting examples of prime movers include heat engines, motors (e.g. electric, hydraulic, or pneumatic), or combinations thereof (for example electric hybrid drivetrains). In one example, the prime mover 220 may be a gas turbine engine having a core including a compressor, a combustor and one or more turbines. The unducted fan 224 may be driven directly by the prime mover 220, or through an intermediate geartrain.

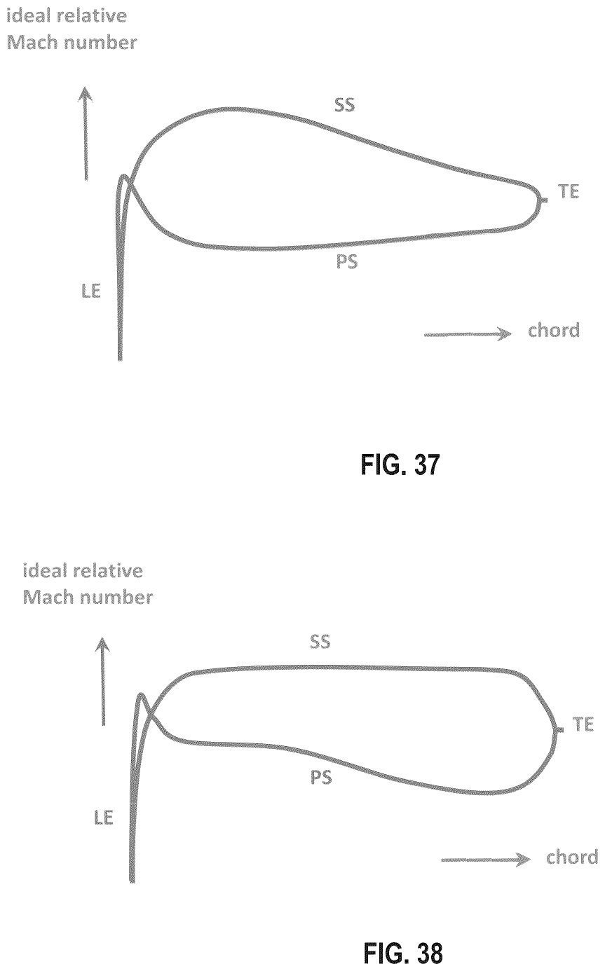

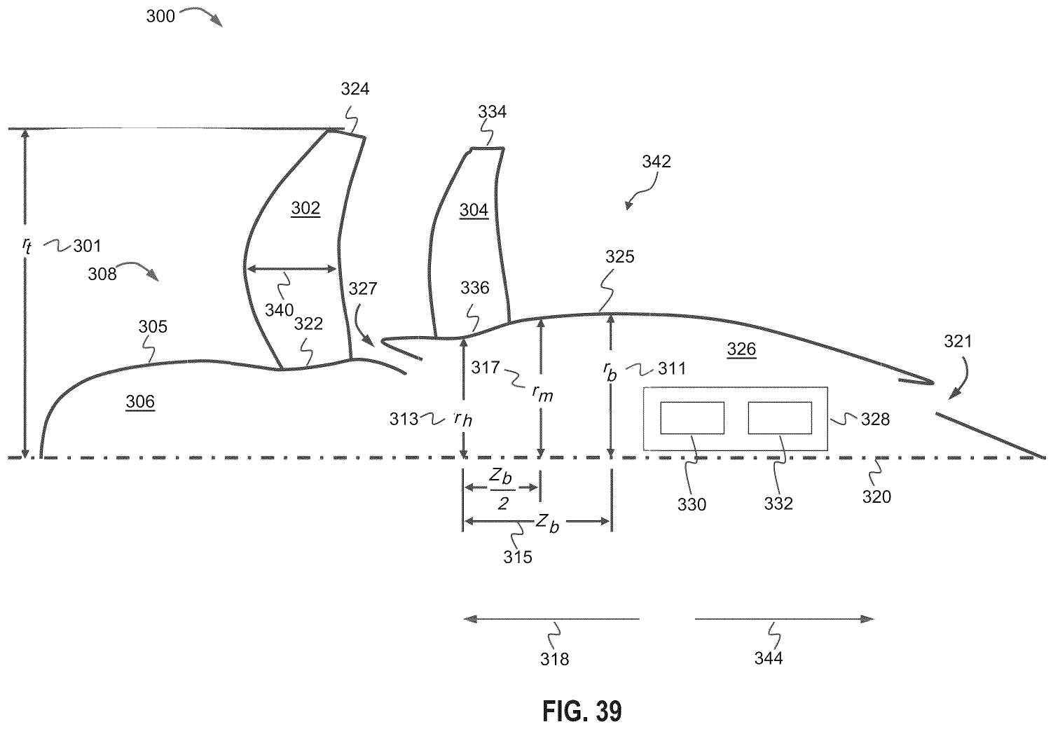

In the illustrated example, the unducted fan 224 is a single-stage open rotor including a single blade row 228 comprising a rotatable disk or hub 230 having an annular array of rotor blades 232 extending therefrom. Other examples of open rotors that may use the blade design described herein are shown in FIG. 39 and FIG. 40.

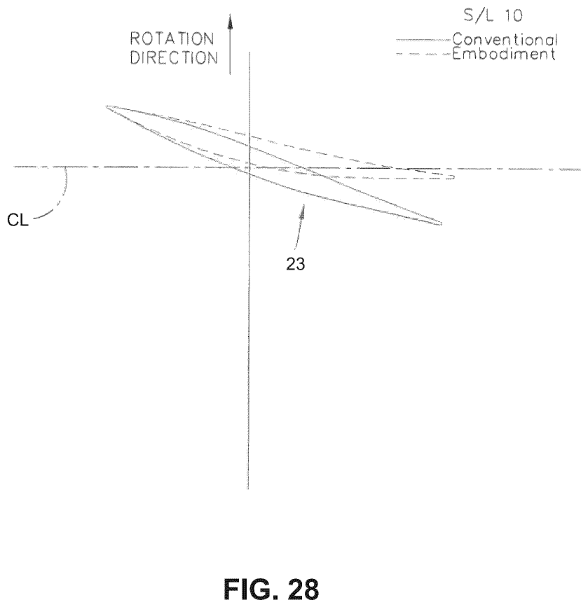

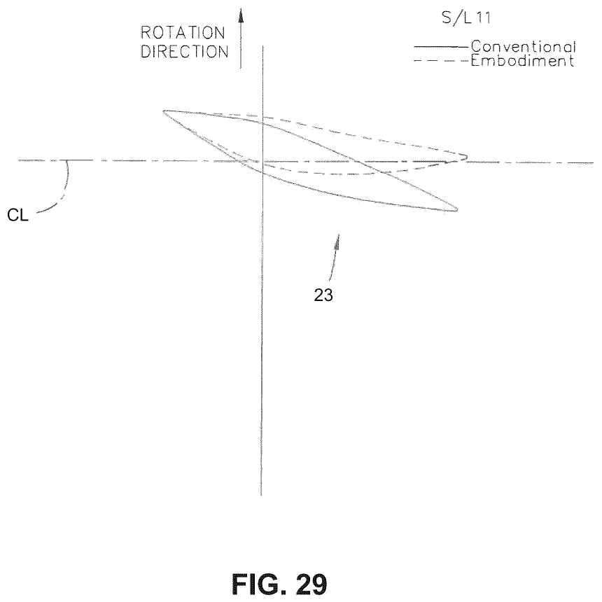

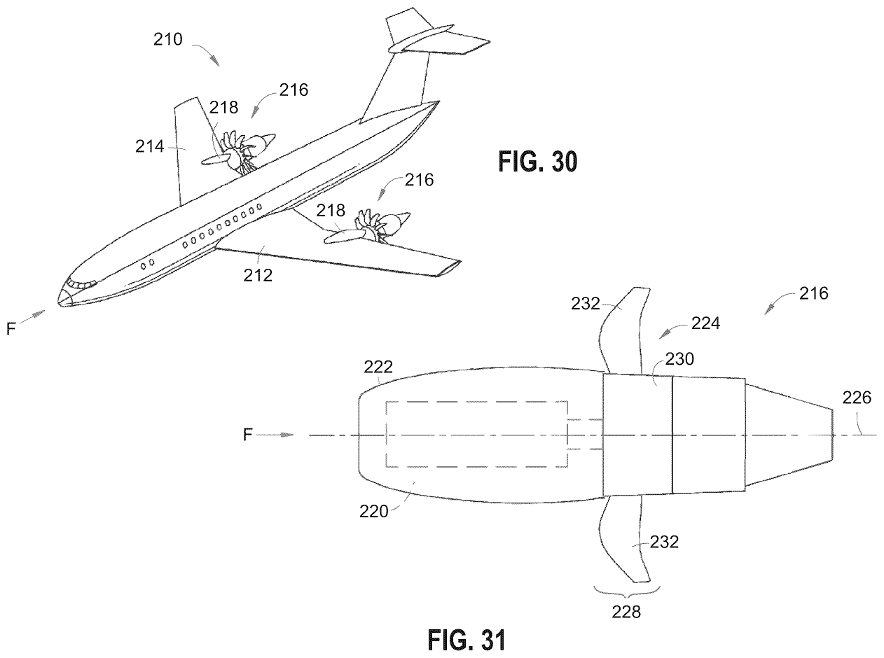

Referring to FIGS. 32-34, each blade 232 extends from a root 234 at the hub 230 to a tip 236 and includes a generally concave pressure side 238 joined to a generally convex suction side 240 at a leading edge 242 and a trailing edge 244. The blade 232 may be represented as an array or “stack” of individual airfoil sections arrayed along a spanwise stacking line traversing point 245. The spanwise sacking line is generally perpendicular to the meanline 248. FIG. 34 illustrates one such airfoil section at cross section plane 34-34 in FIG. 32. As used herein, an airfoil section may also be defined as the intersection of another surface definition with blade 232 as is found in the art, e.g., a surface of revolution about centerline axis 226. Examples of such surfaces of revolution are a cylinder and a stream surface representing the boundary of constant mass flow. It will be appreciated that the “airfoil section” described in conjunction with, e.g., FIGS. 32-44, is different than the airfoil section of the wing to which an unducted fan propulsor is mounted, as described hereinabove.

For each individual airfoil section of the blade 232, an imaginary straight line referred to as a “chord line” 246 connects the leading edge 242 and the trailing edge 244. Also for each individual airfoil section of the blade 232, a curve called the “mean camber line” or “meanline” 248 represents the locus of points lying halfway between the pressure side 238 and the suction side 240. Typically, the blade 232 would incorporate “twist”, a feature in which the stacked airfoil sections are rotated relative to each other about the spanwise stacking line traversing point 245. Although not shown in the illustrated example, it will be understood that the blade 232 may incorporate “lean” or “dihedral”, a feature in which the stacked airfoil sections are laterally shifted relative to each other, and/or “sweep”, a feature in which the stacked airfoil sections are shifted in the chordwise direction.

The blades 232 may be made from suitable high strength materials such as metal alloys (e.g. iron, nickel, or titanium alloys) or composite materials, such as carbon reinforcing fibers in an epoxy matrix, with or without metallic shielding.

In operation, the hub 230 rotates about the centerline axis 226, and the blades 232 sweep through a blade plane 250 which is perpendicular to the centerline axis 226. Airfoil sections of the blades 232 are each disposed at pitch angle θ, dependent on radius (the blades 232 may incorporate twist) and measured between the blade's chord line 246 and the blade plane 250. A relatively small pitch angle θ is typically referred to as a “flat” or “fine” or “low” pitch, and a relatively large pitch angle θ is typically referred to as a “steep” or “coarse” or “high” pitch. It will be understood that in general, the appropriate pitch angle θ for efficient propulsion increases with increasing aircraft speed.

The blades 232 may have a “fixed pitch” configuration in which the airfoil section pitch angles θ of the blades 232 cannot be changed. Alternatively, the blades 232 may have a “variable pitch” configuration in which the airfoil section pitch angles θ of the blades 232 may be uniformly varied (i.e. same pitch angle change for all airfoil sections) in flight. A variable-pitch open rotor may be used to provide thrust efficiently at both high and low speeds. One or more pitch change actuators (not shown) may be used to effect pitch changes.

Each blade 232 has a span (or span dimension) “S” defined as the radial distance from the root 234 to the tip 236, and a blade chord (or chord dimension) “C_{blade}” defined as the length of the chord line 246. The chord dimension may be constant over the span S, or it may vary over the span S, as shown.

A spanwise location may be described based on its relative location between the root and tip of the span expressed as a percentage. For example, a spanwise location located at 30% of the distance from the root to the tip may be described as 30% spanwise location. As used herein, a “x % spanwise location” refers to the distance of a location along the span, from root to tip. The root as at 0% spanwise location and the tip is at 100% spanwise location. One or more sections of the spanwise extent may be described as a percentage of the total span. For example, a section having a spanwise length equal to 30% of the full spanwise extent somewhere between the root and the tip may be described as being 30% of the span. As used herein, “x % of the span” refers to the spanwise length of a section or sections relative to the full spanwise extent.

Similarly, a chordwise location may be described based on its relative location between the leading edge and the trailing edge as a percentage. For example, a chordwise location that is 30% from the leading edge to the trailing edge may be described as 30% chordwise location. As used herein, a “x % chordwise location” refers to the distance of a location along the chord, from leading edge to trailing edge. One or more sections of the chordwise extend may be described as a percentage of the total chord length. For example, a section having a chordwise length equal to 30% of the chord extend somewhere between the leading edge and the trailing edge may be described as being 30% of the chord. As used herein, “x % of the chord” refers to a chordwise length of a section or sections relative to the full chordwise extent.

In operation, the blades 232 rotate at various shaft speeds or rotor speeds (expressed as RPM or as an angular velocity), depending upon the phase of flight. The tangential velocity of any given point on the blade 232, that is, its linear speed in a tangential direction, may be computed as the radius of that point from the centerline axis 226 multiplied by the angular velocity, shown at arrow 252.

It will be understood that, for any given rotor speed, the tangential velocity of the blade 232 increases as radius increases, and that the maximum tangential velocity for any rotor speed occurs at the tip 236. The tangential velocity at the tip 236 is generally referred to as the “tip speed”, shown at arrow 254.

In flight, the blade 232 experiences a “blade-relative velocity” or “relative Mach number”, shown at arrow 256. It will be understood that the blade-relative velocity is a three-dimensional vector quantity with axial, radial, and tangential components. Assuming the radial velocity to be zero, and ignoring secondary factors, the blade-relative velocity at the tip is the vector sum of the tip speed and the flight speed. The blade-relative velocity is approximately equivalent to the speed of the relative wind parallel to the chord line 246 of the blade 232.

Under some operating conditions, for example in the airspeed and tip speed conditions described above, all or portions of the blades 232, for example the outer ½ to ⅓ of the blade span, will experience blade-relative velocities that exceed the local speed of sound. For flow around the blades with substantial regions of both subsonic (Mach numbers less than 1.0) and supersonic (Mach numbers greater than 1.0) blade-relative velocities, the flow field and blade operating regime is called transonic, and for mostly supersonic flow around the blades, the flow field and blade operating regime is called supersonic.

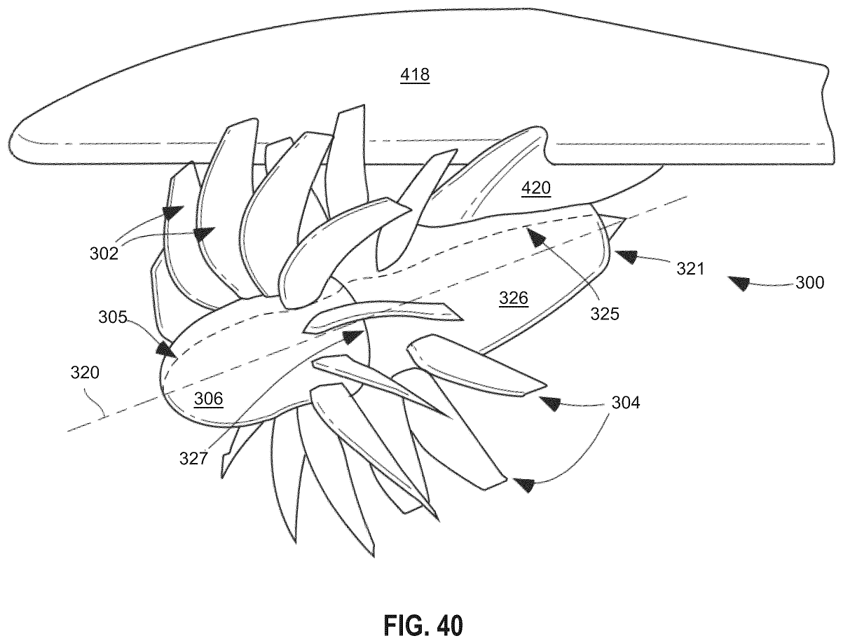

The existence and strength of bow shocks upstream of the blade's airfoil sections in the presence of supersonic relative flow approaching the leading edge depends upon the component, generally varying spanwise along the edge, of the blade-relative velocity perpendicular to the leading edge 242. This component is shown at arrow 258 in FIG. 41. The leading edge 242 includes sweep, which lowers the blade-relative velocity component normal to the leading edge 242 (also referred to as the “edge-normal velocity component”) and decreases the bow shock strength. When the edge-normal velocity component is locally subsonic there is no associated bow shock.

The definition of leading edge sweep as used herein may be understood with reference to FIGS. 34 and 41. A reference line 260 extends in the pure radial direction away from the centerline axis 226 and passes through a local point “A” on the leading edge 242. The angle of local leading edge sweep λ subtends an arc between a radial line passing through point A and a projection of the leading edge tangent line 263 tangent at point A. The projection is onto the plane containing the blade chord line and the radial line that intersects it at point A.

Sweep angle λ is conventionally defined as positive for aft sweep, as depicted in FIG. 32.

The leading edge 242 within an outer portion 262 of the blade 232 incorporates forward or aft sweep (aft sweep is illustrated). The line separating an inner portion 264 from the outer portion 262 would be set depending on the location where blade-relative flow velocities are expected to become supersonic just upstream of the rotor, at some particular operating condition (rotational speed, altitude, and flight Mach number).

For descriptive purposes, reference will be made to the “tip radius”, labeled rtip, of the blade 232. The tip radius rₜᵢₚ is the radial distance from the centerline axis 226 to the tip 236 of the blade 232 at the leading edge 242. A point located at the tip 236 would be referred to as 100% of tip radius rₜᵢₚ, and a point at the centerline axis 226 would be referred to as 0% of tip radius rₜᵢₚ. In one example, the demarcation between the outer portion 262 and the inner portion 264 may be located at approximately 65% of the tip radius rₜᵢₚ. In the illustrated example, the outer radius of the hub 230 is approximately 30% of the tip radius rₜᵢₚ, and so the demarcation at 65% of tip radius rₜᵢₚ would correspond to approximately 50% spanwise location of the span.

For aerodynamic or other reasons, the leading edge 242 of a given blade 232 may incorporate both forward sweep and aft sweep in different portions. In the illustrated example, the inner portion 264 of the leading edge 242 of the blade 232 incorporates forward sweep. For example, the forward sweep in the inner portion 264 may prevent the center of mass of the blade 232 from being too far aft, which might impose excessive mechanical loads on the hub 230.

Referring to FIG. 34, an airfoil section of the blade 232 has a meanline angle 259, which refers to the angle between the tangent to the meanline 248 and centerline axis 226. The meanline angle 259 can be measured at any location along the meanline 248. The value of the meanline angle 259 is a function of both the curvature of the meanline 248 and the pitch angle θ of the blade 232. Thus, the absolute value of the meanline angle 259 will change as the pitch angle θ of the blade 232 changes. However, it will be understood that the overall meanline shape characteristic is unchanging and depends solely on the curvature of the blade 232.

The blade 232 has a thickness 261 which is a distance measured normal to the meanline 248 between the pressure side 238 and suction side 240, which can be measured at any location along the meanline 248. In accordance with conventional practice, a thickness ratio is computed as the absolute value of the thickness divided by the chord length, expressed as a percentage.

A location along the meanline 248 of either the meanline angle 259 or the thickness 261 may be described using a chord fraction, the value of which may be expressed as a percentage. As used herein, chord fraction refers to a chordwise distance of the location from leading edge 242 to a point of interest divided by the blade chord C_{blade}. So, for example, the leading edge 242 is located at 0% chordwise location of the blade chord, and the trailing edge 244 is located at 100% chordwise location of the blade chord.

The meanline angle at the trailing edge 244 is referred to as the “blade exit angle” 265. This may or may not be equal to the angle between the airflow and the centerline axis 226 directions at the trailing edge 244. The meanline angle at the leading edge 242 is referred to as the “blade inlet angle” 266. This may or may not be equal to the angle between the airflow and the centerline axis 226 directions at the leading edge 242.

A parameter called “total turning” is defined as the absolute value of the difference between the blade exit angle 265 and the blade inlet angle 266.

A maximum thickness of the airfoil section of the blade 232 is represented by the diameter of the largest circle 267 that can be inscribed between the pressure side 238 and the suction side 240.

As used herein, camber is defined as a change in meanline angle 259 between any two points along meanline 248. Curvature of the meanline 248 is calculated as the derivative, or rate of change, of meanline angle 259 with respect to arc length along meanline 248.

In some embodiments, for at least 30% of the span of the blade, the meanline of the airfoil section is shaped such that, in the presence of transonic or supersonic relative velocity conditions, maximum and minimum ideal Mach numbers on the suction side will lie within a 0.08 band for 75% or more of the region between 25% and 80% chordwise location of the blade chord of the airfoil section. In some embodiments, for at least 50% of the span of the blade, the meanline of the airfoil section is shaped such that, in the presence of transonic or supersonic relative velocity conditions, maximum and minimum ideal Mach numbers on the suction side will lie within a 0.08 band for 75% or more of the region between 25% and 80% chordwise location of the blade chord of the airfoil section. In some embodiments, for at least 70% of the span of the blade, the meanline of the airfoil section is shaped such that, in the presence of transonic or supersonic relative velocity conditions, maximum and minimum ideal Mach numbers on the suction side will lie within a 0.08 band for 75% or more of the region between 25% and 80% chordwise location of the blade chord of the airfoil section. In some embodiments, for at least 90% of the span of the blade, the meanline of the airfoil section is shaped such that, in the presence of transonic or supersonic relative velocity conditions, maximum and minimum ideal Mach numbers on the suction side will lie within a 0.08 band for 75% or more of the region between 25% and 80% chordwise location of the blade chord of the airfoil section.

In some embodiments, for between 30% and 90% of the span of the blade, a maximum value of the thickness of the airfoil section occurs at a location between about 0% to about 35% chordwise location of the blade chord. In some embodiments, for between 30% and 90% of the span of the blade, the airfoil section has a maximum thickness between about 2% and 7% chordwise location of the blade chord. In some embodiments, for between 30% and 90% of the span of the blade, the leading edge has a thickness greater than 0.45% of the blade chord, measured at a 0.5% chordwise location.

In some embodiments, the majority of the leading edge of the outer span of the blade has an aft sweep equal to or greater than a predetermined sweep profile, wherein the predetermined sweep profile is selected to produce a blade-relative velocity component perpendicular to the leading edge, at a tip radius of the blade, of Mach 0.75 or less, and to produce a blade-relative velocity component perpendicular to the leading edge, at 65% of the tip radius, of Mach 0.87 or less, in the presence of transonic or supersonic relative velocities near the blade.

As used herein, Cu refers to the circumferential averaged tangential velocity. Multiplying the Cu times the airstream radius R gives the property RCu. The blade or vane loading at a given radius R is now defined as the change in Rcu across the blade row (at a constant radius or along a streamtube), here forth referred to as ΔRCu and is a measure of the elemental specific torque of said blade row.

In some embodiments, at under transonic or supersonic relative velocity conditions, the blade has a spanwise ΔRCu distribution such that at any location between a blade root and 30% span of the blade, the value of ΔRCu is greater than or equal to 70% of the peak ΔRCu. In some embodiments, at under transonic or supersonic relative velocity conditions, the blade has a ΔRCu distribution such that at any location between a blade root and 30% spanwise location of the blade, the value of ΔRCu is greater than or equal to 80% of the peak ΔRCu.

In some embodiments, the tip section of the blade has suction side dihedral such that the tip section leading edge is displaced in the direction perpendicular to the blade section chord line at a radius 85% of a tip radius, by an amount 10% or greater of the circumferential blade tip spacing.

Blade solidity is the ratio of the blade chord, represented by its length, over the circumferential spacing of the blades at a given radius or diameter from the axial centerline axis. In other words, blade circumferential spacing is the circumferential length at a given radius divided by the number of blades in the full fan blade row. Fan blade aspect ratio is the radial height or span of the airfoil portion of the blade divided by an average chord length, and can be calculated by dividing the square of the span by the blade planform area. In some embodiments, the blade row aerodynamic solidity at 0% spanwise location is between 1.0 and 3.6, and at 100% span is between 0.0 and 0.8.

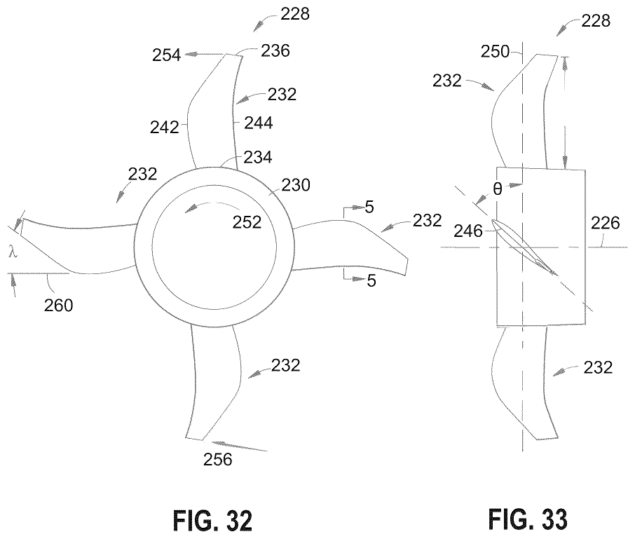

FIG. 35 plots the shape of the meanline 248 of the midspan airfoil section of a blade according to some embodiments. In FIG. 35, the vertical axis represents the distance from the chord line 246 to the meanline 248, measured perpendicular to the chord line 246, expressed as a fraction of blade chord. This value may be referred to as the “camber rise”, which is zero at the leading and trailing edges. It is noted that the scale of the vertical axis in FIG. 35 is different from the scale of the horizontal axis.

In the illustrated example, the location of the maximum value of the camber rise is located within the forward half of the airfoil section, that is, forward of the 50% chord location (indicated by a vertical dashed line). Specifically, the maximum value of the camber rise is located between the 40%-50% chordwise location.

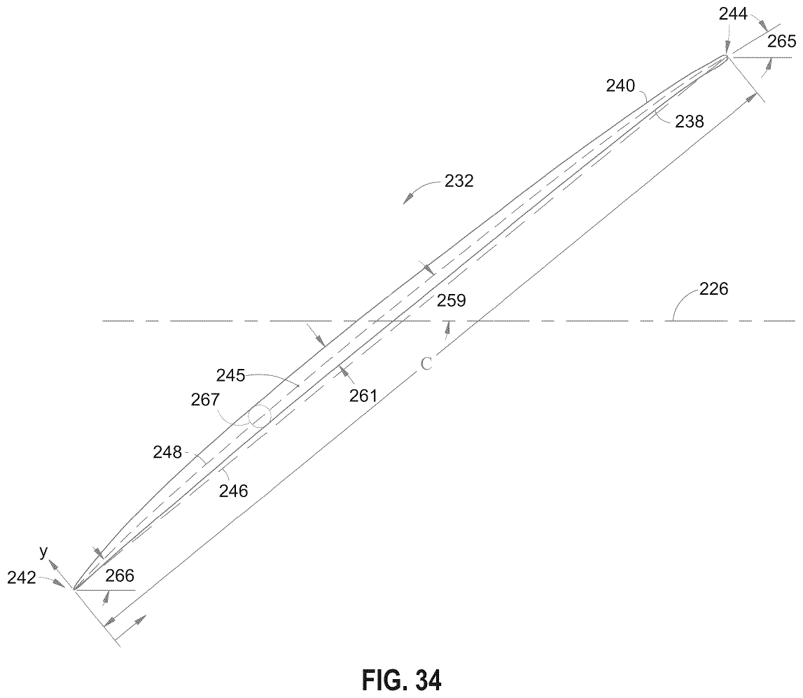

FIG. 36 plots the angle distribution of the meanline 248 of a midspan airfoil section of an exemplary blade. In FIG. 36, the vertical axis represents the meanline angle 259 minus the compliment of the pitch angle θ for the section. Meanline angle for a midspan section is shown which quantifies the camber into three regions. Camber corresponds to the change of meanline angle Δζₙ in each region. The relative curvature parameter of a region is defined by Δζₙ/Δζₜₒₜ/Δ(x/c)ₙ wherein ζ corresponds to the inverse tangent (arctangent) of the slope of a meanline curve, subscript n indicates the region, Δζₜₒₜ corresponds to a total change in meanline angle (the difference between the leading- and trailing-edge meanline angle for a particular blade section), and x/c is the chordwise location normalized by blade chord. In the example shown in FIG. 36, the relative curvature parameter Δζ₁ of the first region (Δ(x/c)₁)) is high, at 1.99, the relative curvature parameter Δζ₂ of the second region (Δ(x/c)₂)), is low, at 0.59, and the relative curvature parameter Δζ₃ of the third region (Δ(x/c)₂), is medium, at 1.39.

In some embodiments, the first region comprises at least x/c=0.0 to 0.10 and the third region comprises at least x/c=0.85 to 1. In some embodiments, the first region corresponds to x/c=0.0 to 0.15, the second region corresponds to x/c=0.15 to 0.75, and the third region corresponds to x/c=0.75 to 1.0. In some embodiments, for 30% of the span of the blade, the meanline of the airfoil section is shaped such that the relative curvature parameter is greater than 1.75 in a first region, less than 0.75 in a second region, and greater than 1.2 in a third region. In some embodiments, for 50% of the span of the blade, the meanline of the airfoil section is shaped such that the relative curvature parameter is greater than 1.75 in the first region, less than 0.75 in the second region, and greater than 1.2 in the third region. In some embodiments, for 70% of the span of the blade, the meanline of the airfoil section is shaped such that the relative curvature parameter is greater than 1.75 in the first region, less than 0.75 in the second region, and greater than 1.2 in the third region.

In some embodiments, a blade design described herein may be used by powering the unducted fan 224 with the prime mover 220 to propel the aircraft 210 in atmospheric flight, such that a relative velocity at the leading edge 242 within an outer portion thereof is transonic or supersonic. For example, these conditions may occur at a flight speed between about Mach 0.7 to about Mach 0.86. For example, the unducted fan 224 may be operated at a tip speed greater than about 152 m/s (500 ft/s) and a flight Mach number greater than about 0.72.

In general, the term “propelling the aircraft” as used herein refers to an approximately steady-state, sustainable condition achievable by operation of the prime mover 220, for example takeoff, climb, descent, and/or cruise flight, and not to conditions characterized or dominated by transient effects, e.g. achieved in a rapid descent or dive. In some embodiments, the blade described herein is part of an aircraft with designated cruise flight Mach number at or above 0.74.

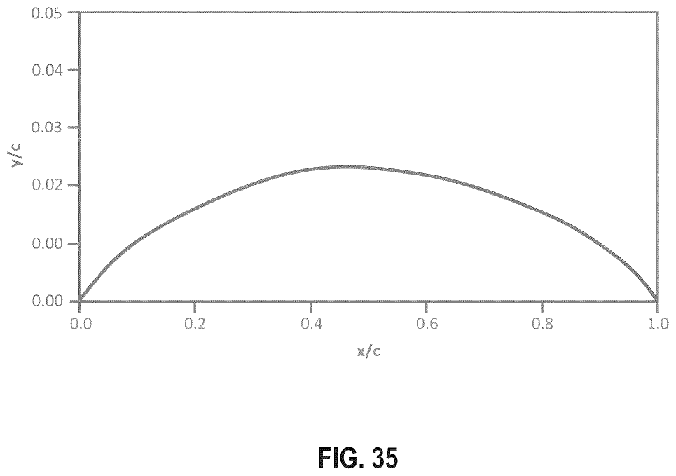

The combination of meanline shaping features described above may be applied so as to increase the uniformity of aerodynamic loading on the airfoil section in a chordwise direction, as compared to prior art designs. FIG. 37 is a plot illustrating the aerodynamic loading on a prior art open rotor airfoil section at its aerodynamic design point (ADP). It can be seen that the aerodynamic loading is non-uniform in the chordwise direction with the peak suction side (SS) ideal Mach number occurring in a front half of the blade chord. Ideal Mach number is a proxy for static pressure and is computed using the isentropic steady-flow relationship for an ideal gas.

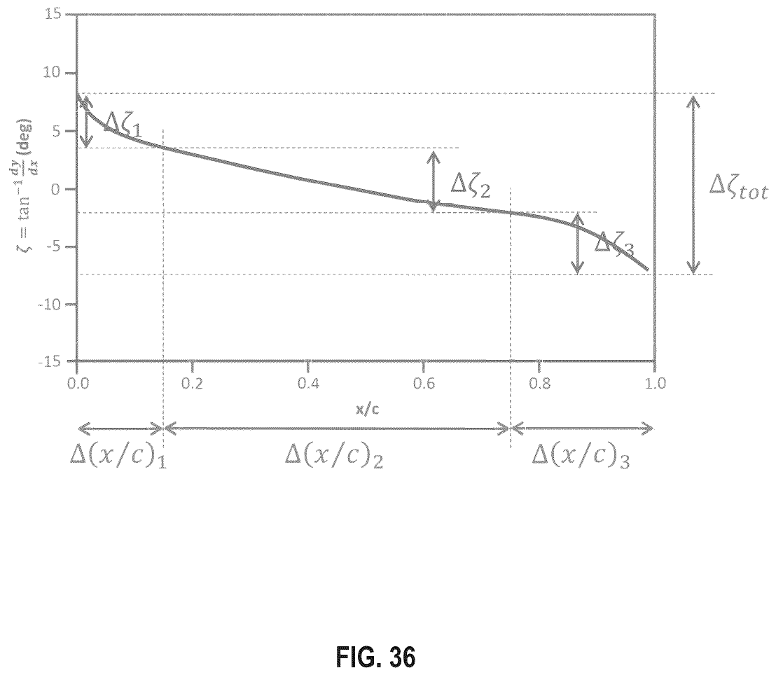

In contrast, FIG. 38 is a plot illustrating the aerodynamic loading on an airfoil section at its ADP designed in accordance with the principles described herein (such as the airfoil section seen in FIG. 34). It can be seen that the suction side (SS) ideal Mach number is generally uniform (i.e. a flat horizontal line) over most of the blade chord while the pressure side (PS) ideal Mach number has a minimum toward the trailing edge (TE). More specifically, in one example, the meanline shaping can be such that, at a predetermined transonic or supersonic relative velocity condition, blade suction side maximum and minimum ideal Mach numbers lie within a 0.08 band for 75% or more of the region between 25% and 80% chordwise location of the blade chord. (Stated another way, the maximum ideal Mach number is not more than 0.08 greater than the minimum ideal Mach number between 25% and 80% chordwise locations of the blade chord, for at least 75% of that blade chord range). This near uniformity of static pressure can be expected in individual airfoil sections, typically in the outer ⅓ of the span. Considering sections further inboard (lower radii), the 0.08 Mach number band could extend over a smaller part of the blade chord, for example from 25% to 75% chordwise locations of the blade chord, or from 25% to 70% chordwise locations of the blade chord.

This near-uniform ADP chordwise SS pressure distribution has numerous benefits. Primarily, it will reduce cumulative supersonic compression and move the terminal shock near to the trailing edge 244. Deliberate placement of the terminal shock near the trailing edge is more predictable and less sensitive to minor aerodynamic variation, as compared to an upstream location, and reduces the strength of blade generated shocks away from the blades and beyond the blade tip radius. The weaker far-field pressure waves will cause less interior noise as they impinge the aircraft cabin.

Near-uniform pressure on the suction side delays flow deceleration, which increases aerodynamic efficiency by delaying laminar-to-turbulent boundary layer transition to a region further aft on the airfoil.

Finally, it has the potential to reduce blade far-field pressure wave strength at lower rotational speeds.

In some embodiments, a rotor blade described herein comprises higher solidities (longer blade chords) to reduce blade aerodynamic loading and chordwise SS pressure distributions are nominally flat with terminal compression located as far aft as practically achievable. In some embodiments, the rotor blade described herein minimizes SS Mach numbers (maximized SS pressures) and the overall strength of supersonic compressions. In some embodiments, a rotor blade comprises aft sweep to de-phase pressure waves and deconcentrate outward propagated pressure waves by spreading them over a larger axial distance. Aft sweep also tends to aerodynamically sweep the tip-region terminal shock and reduce its loss, and it allows relatively thick leading edges to be used without incurring aerodynamic penalties, even when blade relative inflow is supersonic. In some embodiments, the rotor blade comprises tip SS dihedral that further de-phases propagated pressure waves. In some embodiments, added acoustic benefit is realized by locating a terminal tip shock as far aft as possible, near the TE, while accelerating or reaccelerating the SS flow over the aft portion or aft half of the blade upstream of the terminal shock wave. This reduces the magnitude of the propagated pressure pulse by destructive interference.

The rotor blade design principles described above may be applied to various configurations of open rotors. For example, FIG. 39 shows an elevational cross-sectional view of an exemplary unducted propulsion system 300. As is seen from FIG. 39, the unducted propulsion system 300 takes the form of an open rotor propulsion system and has a rotating element 338 depicted as a propeller assembly which includes an array of blades 302 affixed to forward housing 306 and configured to rotate around an axis of rotation 320 of the unducted propulsion system 300. The unducted propulsion system 300 also includes in the exemplary embodiment a non-rotating stationary element 342 which includes an array of blades 304, also known as vanes, disposed around axis of rotation 320. These blades may be arranged such that they are not all equidistant from the propeller. These blades are mounted to a stationary frame and do not rotate relative to the central axis of rotation 320. The non-rotating stationary element 342 includes a stationary aft housing 326. Forward housing 306 and aft housing 326 have external surfaces that are three-dimensional. To explain the surface shaping guidance disclosed herein, parameters are defined along flowpath curves that correspond to intersecting the external surfaces with a plane that includes the axis of rotation. Accordingly, flowpath curve 305 corresponds to the intersection of forward housing 306 with an z-r plane that includes the axis of rotation. Similarly, the flowpath curve 325 corresponds to the intersection of aft housing 326 with an z-r plane that includes the axis of rotation. For reference purposes, FIG. 39 also depicts a forward direction denoted with arrow 318.

Radii rₕ 313, rₘ 317, r_{b} 311, and axial distance z_{b} 315 are also shown in FIG. 39. The annular area may be computed using rₜ 301, the radial distance from the axis of rotation 320 to a tip end of a blade 302 in the forward blade assembly, and the minimum radius of the fan stream tube at the same axial location

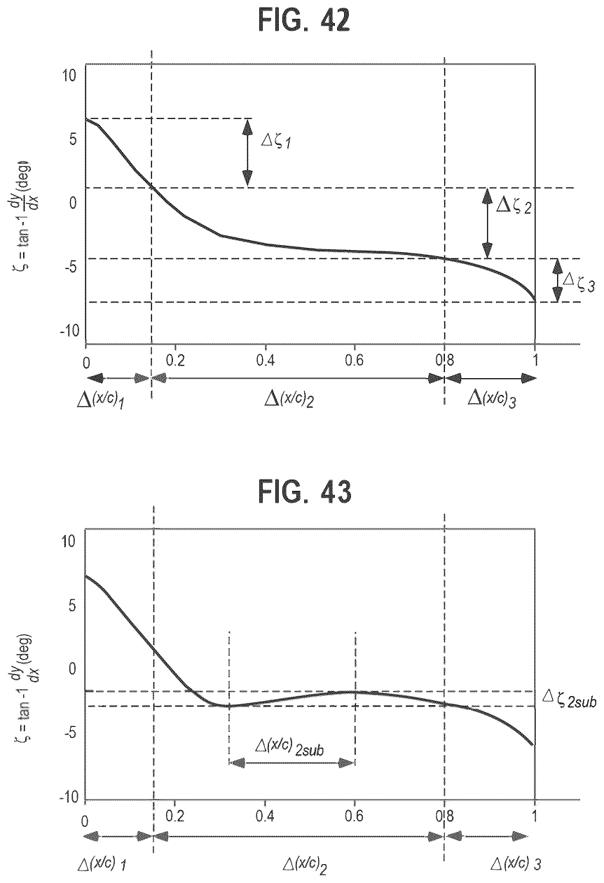

As shown in FIG. 39, the exemplary unducted propulsion system 300 also includes a drive mechanism 328 which provides torque and power to the rotating element 338 through a transmission (not shown). In various embodiments, the drive mechanism 328, also known as an engine, may be a gas turbine engine, an electric motor, an internal combustion engine, or any other suitable source of torque and power and may be located in proximity to the rotating element 338 or may be remotely located with a suitably configured transmission. Transmission transfers power and torque from the drive mechanism 328 to the rotating element 338 and may include one or more shafts, gearboxes, or other mechanical or fluid drive systems. In FIG. 43, drive mechanism 328 is depicted schematically as comprising a gas generator 330 and a power turbine 332. An example of a turbomachine comprising a gas generator (e.g., compressor, combustor & high-speed turbine) and power turbine of a gas turbine engine is shown and described in US20210108597, hereby incorporated by reference in its entirety for all purposes. Alternative configurations to the one illustrated in FIG. 43 herein are depicted in U.S. Pat. Nos. 10,704,410, 5,190,441, 9,340,277, and 10,358,926, hereby each incorporated by reference in their entirety for all purposes.

Blades 302 of rotating element 338 are sized, shaped, and configured to produce thrust by moving a working fluid such as air in a direction 344 as shown in FIG. 43 when the rotating element 338 is rotated in a given direction around the axis of rotation 320. In doing so, blades 302 impart a degree of swirl to the fluid as it travels in the direction 344. Blades 304 of the stationary element are sized, shaped, and configured to decrease the swirl magnitude of the fluid, so as to increase the kinetic energy that generates thrust for a given shaft power input to the rotating element. Each rotating blade 302 has blade root 322 and blade tip 324. Each stationary blade 304 has a blade root 336 and blade tip 334. For both rotating blades 302 and stationary blades 304, span is defined as the distance between root and tip. Stationary blades 304 may have a shorter span than rotating blades 302, for example, 50% of the span of blades 302, or may have longer span or the same span as blades 302 as desired. In FIG. 43, stationary blades 304 are shown affixed to the housing 326 at their respective blade roots 336. In some embodiments some or all stationary blades 304 may be affixed to, or integrated with, the aircraft structure, such as a wing, pylon, or fuselage. The number of blades 304 of the stationary element may be fewer or greater than, or the same as, the number of blades 302 of the rotating element and is typically greater than two, or greater than four. In some embodiments a ratio of the number of rotating blades 302 to a number of stationary blades 304 is between 2:5 and 2:1. In some embodiments a difference between the number of rotating blades 302 to a number of stationary blades 304 is between 2 and −2. Span of blade 302 is defined as the distance between blade root 322 and blade tip 324. In one embodiment, the blades 302 have a maximum axial distance/width 340 near mid span (i.e., 50% of the blade height from the blade root to blade tip). In one embodiment, the blades 302 are affixed to the forward housing 306 or spinner such that, when oriented or configured for cruise operation, the forward-most point of the blade roots 322 is proximal to the local minimum having second radius, and such that 0 to 40 percent of the maximum width 340 is located forward of the forward-most point of the blade roots 322. In another embodiment, 20 to 40 percent of the maximum width 340 is located forward of the forward-most point of the blade roots 322.

Blades 304 of the stationary element 342 may be positioned aerodynamically upstream of the rotating blades 302 to serve as counter swirl vanes, i.e., imparting a tangential velocity which is opposite to the rotation direction of the rotating element 338. Alternatively, and as shown in FIG. 43, stationary blades 304 may be positioned aerodynamically downstream of the rotating blades 302 to serve as de-swirl vanes, i.e., imparting a change in tangential velocity which is counter to that of the rotating element 338. Any swirl remaining in the airstream downstream of the unducted propulsion system 300 equates to a loss in thrust producing kinetic energy.

It may be desirable that either or both of the sets of rotating blades 302 and stationary blades 304 incorporate a pitch change mechanism such that the blades can be rotated with respect to an axis of pitch rotation either independently or in conjunction with one another. Such pitch change can be utilized to vary thrust and/or swirl effects under various operating conditions, including to provide a thrust reversing feature which may be useful in certain operating conditions such as upon landing an aircraft.

An inlet 327 is located axially between the blades 304 and blades 302. Alternatively, the inlet 327 may be located elsewhere, for example, forward of the blades 302. A ratio of a mass of air accelerated by the rotating blades 302 and bypassing the inlet 327 to the mass of air accelerated by the rotating blades and entering the engine core (not shown) via the inlet 327 is known as the bypass ratio. In some embodiments, a ratio of the sweep area of the blades (computed as π×[(blade tip radius)²−(blade root radius)²) to the cross-sectional area of the inlet (as measured in a z-r plane) is greater than 20:1 or greater than 30:1, and less than 80:1.

It will be appreciated that the exemplary unducted propulsion system 300 depicted in FIG. 43 is by way of example only. In other exemplary embodiments, it may have other suitable configurations. For example, instead of being a forward rotating blade assembly and an aft stationary blade assembly as shown, the two blade assemblies could be counter-rotating with respect to one another. As another example, the forward blade assembly could be stationary and the aft blade assembly could be rotating. As another example, the unducted propulsion system may consist of only a rotating blade assembly, i.e., a propeller.

FIG. 40 is a perspective view of an exemplary gas turbine engine attached to a wing of an aircraft in accordance with some aspects of the present disclosure. FIG. 40 depicts the unducted propulsion system 300 mounted to a wing 418 via a pylon 420 to facilitate mounting to, or accommodation of the airframe structure. Additionally, each of blades may not all be equally spaced from each other and/or at the same axial, z, location. These are examples of where a housing 326 may not be axisymmetric.

The unducted propulsion system 300 includes a turbomachine substantially contained within a forward housing 306 or spinner and aft housing 326. In some configurations, both the forward housing 306 and the aft housing 326 include rotating hubs associated with rotating blades 302 and blades 304, respectively. In other configurations, one of the forward housing 306 and the aft housing 326 are entirely rotating or include a rotating structure such as a rotating hub, while the other is a stationary housing associated with respective rotating and stationary blades. In some embodiments, forward housing 306 may be considered a spinner and aft housing 326 may be considered a nacelle. Aft housing 326 may contain a compressor, combustor, and turbine of a turbomachine, followed by engine exit 321.

In an illustrative non-limiting example as depicted in FIG. 40, the unducted propulsion system 300 includes a rotating assembly (or rotor) that includes a forward housing 306 and airfoil-shaped assembly of blades 302 (may also be referred to as a fan, rotor, or propeller) associated with the forward housing 306. In this example, the forward housing 306 is a spinner that rotates about an axis of rotation 320. In other configurations the forward housing may not be rotating, as when the system is comprised of a stationary forward blade assembly and rotating aft blade assembly. The unducted propulsion system 300 also includes a stationary assembly that may include the engine inlet 327 and airfoil shaped stationary assembly of blades 304 associated with aft housing 326. In such a configuration, the housing 326 is non-rotating, as are the blades 304, about the axis of rotation 320 although the blades may separately articulate to modify a pitch, lean or sweep angle, e.g., via a mechanism contained within housing 326. At least one of the functions of the stationary assembly of blades 304 is to remove swirl from air stream leaving the rotor.

Aft housing 326 extends in an axial direction from engine inlet 327 to the engine exit 321. The aft housing 326 contains the internal machinery that produces torque for the assembly of blades 302 and defines a surface shaped to provide aerodynamic efficiency (reduce drag) for air passing through blades 302 and 304 and proceeding downstream. The stream exhausted from the engine exit 321 produces some of the thrust that propels and/or advances an aircraft forward. Most of the thrust produced by an engine of the unducted propulsion system 300 comes from accelerated air that passes over the housing 326, or the air that passes through the blades 304 and bypasses the inlet 327. In some embodiments, the engine may additionally include a third stream (the first and second streams being the bypass and turbomachine core airstream defined by a compressor, combustor, and turbine).

For simplicity of illustration in FIG. 40, forward housing 306 is shown as a continuous spinner. However, each housing may be comprised of separate parts with various mechanical components to allow variable pitch angle of the forward assembly of blades 302 and/or aft assembly of blades 304. The axial extent of such specialized parts of each housing may be approximately the same as a corresponding axial extent of the assembly of blades 302 and/or assembly of blades 304, or the axial extents of the housings may be shorter or longer (in axial extent) than the span of blades or respective axial extents of the blade assemblies. The dot-dashed line in FIG. 40 indicates an axis of rotation 320 for the blades 302. The dashed curves, 305 and 325, represent flowpath curves corresponding to the intersection of housings 306 and 326, respectively, with a plane that includes axis of rotation 320. In the illustrative example in which forward housing 306 and the associated forward assembly of blades 302 are rotating about axis of rotation 320, the shape of the flowpath curve may be defined by an effective radius vs. axial distance parallel to the axis of rotation 320. However, in this example in which the aft housing 326 and the associated aft assembly of blades 304 do not rotate about axis of rotation 320, the flowpath curve shape of radius vs. axal location depends on the orientation of the z-r plane about the axis of rotation, i.e., curve could have a different shape for different positions of the plane that intersects aft housing 326.

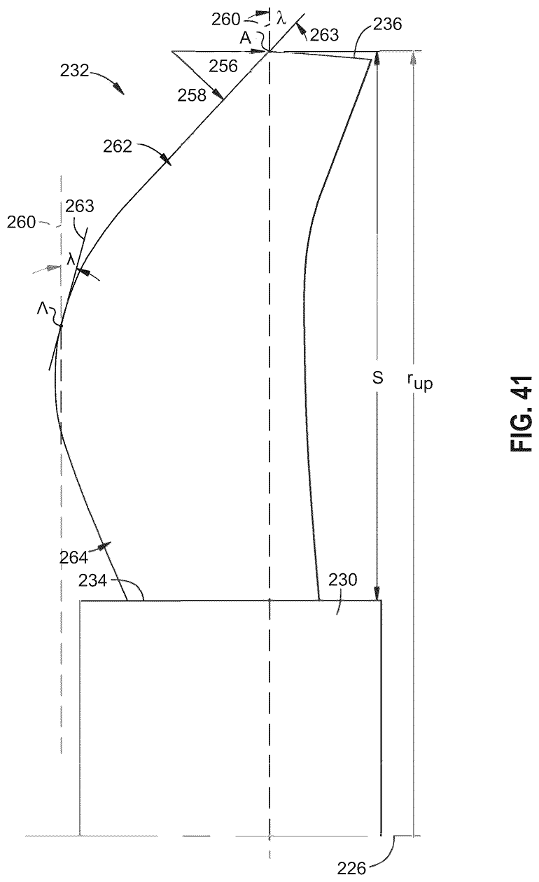

FIG. 42 plots the angle distribution of the meanline 48 of a midspan airfoil section of an exemplary blade in accordance with some additional embodiments. In FIG. 42, the vertical axis represents the meanline angle 59 minus the compliment of the pitch angle θ for the section. Meanline angle for a midspan section is shown which quantifies the camber into three regions. Camber corresponds to the change of meanline angle Δζₙ in each region. The relative curvature parameter of a region is defined by Δζₙ/Δζₜₒₜ/Δ(x/c), wherein ζ corresponds to the inverse tangent (arctangent) of the slope of a meanline curve, subscript n indicates the region, Δζₜₒₜ corresponds to a total change in meanline angle (the difference between the leading- and trailing-edge meanline angle for a particular blade section), and x/c is the chordwise location normalized by blade chord. In FIG. 42, the relative curvature parameter Δζ₁ of the first region (Δ(x/c)₁)) is high, at greater than 1.2, the relative curvature parameter Δζ₂ of the second region (Δ(x/c)₂)), is low, at less than 0.75, and the relative curvature parameter Δζ₃ of the third region (Δ(x/c)₂), is medium, at greater than 0.9.

Also in FIG. 42, the first region comprises at least x/c=0.0 to 0.15 and the third region comprises at least x/c=0.80 to 1. In some embodiments, the second region is within x/c=0.15 to 0.80.

FIG. 43 plots the angle distribution of the meanline 48 of an airfoil section of an exemplary blade with a sub-region of increasing meanline angle in accordance with some additional embodiments. The vertical axis in FIG. 43 represents the meanline angle 59 minus the compliment of the pitch angle θ for the section. In FIG. 43, the relative curvature parameter Δζ₁ of the first region (Δ(x/c)₁)) is high, at more than 1.2, the relative curvature parameter Δζ₂ of the second region (Δ(x/c)₂)), is low, at less than 0.75, and the relative curvature parameter Δζ₃ of the third region (Δ(x/c)₂), is medium, at greater than 0.9. The first region comprises at least x/c=0.0 to 0.15, the third region comprises at least x/c=0.80 to 1, and the second region is within x/c=0.15 to 0.80. The second region comprises a sub-region Δ(x/c)_{2sub} with a change in mean line angle Δζ_{2 sub} that increases from the start of the sub-region to the end of the sub-region in the direction from the leading edge to the trailing edge. In some embodiments, the sub-region Δ(x/c)_{2sub} is situated within x/c=0.3 to 0.6. In some embodiments, at x/c=0.4, the mean line angle of the airfoil section is increasing, such that the tangent line of the meanline at x/c=0.4 has a positive slope. In some embodiments, for more than 30% span of a blade, the meanline angle of the airfoil section decreases from the leading edge to the trailing edge, except in the sub-region Δ(x/c)_{2sub}, in which the meanline angle increases. In some embodiments, the change in meanline angle Δζ_{2sub} in the sub-region is at least 2, 1, or 0.5 degrees.

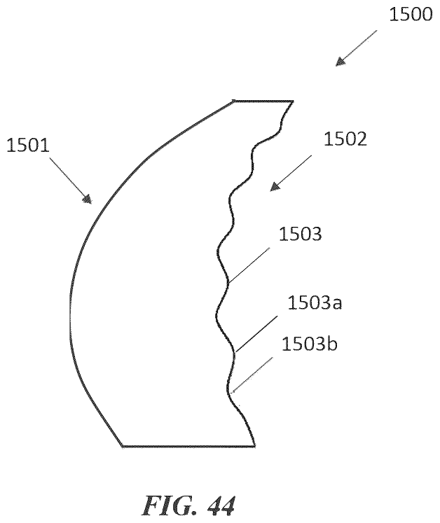

FIG. 44 illustrates a blade 1500 with a wake-mixing wave-like trailing edge feature. The blade 1500 includes a leading edge 1501 and a trailing edge 1502. The trailing edge 1502 includes a wave feature comprising a plurality of spaced-apart wave-shaped projections 1503, each wave-shaped projection 1503 defines a wave tip 1503a and a wave trough 1503b. The wave feature is configured to facilitate wake mixing to reduce interaction noise caused by the blade wakes impinging on downstream stationary airfoils or stators. In some embodiments, the wave-shaped projections may be present in the third region described herein which includes the trailing edge. An example of a blade with wave-shaped projections is described in U.S. Pat. No. 8,083,487 B2 which is hereby incorporated by reference in its entirety.

Further aspects of the disclosure are provided by the subject matter of the following clauses:

Clause 1: An aircraft is provided that includes a fuselage; an airfoil extending from the fuselage, the airfoil having an airfoil section with a leading edge (LE) and a trailing edge (TE), a chord extending between the LE and TE, and an effective quarter chord point (QC) along the chord measured from the LE; an unducted fan propulsor mounted relative to the airfoil section on a high pressure side thereof, the unducted fan propulsor having a centerline (CL) and a plurality of blades arranged in one or more arrays, each of the blades having a root and the plurality of blades defining a maximum outer diameter (D), the unducted fan propulsor having a point (P) defined as one of: (a) wherein the plurality of blades is arranged in a single array, the point P is located at an intersection of the CL and a line perpendicular to the CL that passes through a midpoint between edges at the root of one of the plurality of blades, and (b) wherein the plurality of blades is arranged in a forward array and a rearward array, the point P is located at an intersection of the CL and midpoint between a rearward trailing edge (TE) of the rearward array and leading edge (LE) of the forward array when a blade of the forward and rearward arrays are aligned with each other; and an ellipse origin positioning line (EOR) having a length (EORL) extending from the QC to an ellipse origin (OR) and at an angle θ as measured from a vector from the QC to the TE of the airfoil section to the line EOR, where, when viewed with the LE to the left of TE, a positive θ (1) increases in a counter-clockwise direction when the high pressure side of the airfoil section is below the airfoil section, and (2) increases in a clockwise direction when the high pressure side of the airfoil section is above the airfoil section, and wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1MinAL/D is 1.7.

In the preceding clause, the P of the unducted fan propulsor is located in a second ellipse having a second major axis length (2MajAL) and a second minor axis length (2MinAL) with a second ellipse origin defined by EORL/D of 1.051 and θ of 248.8°, and where 2MajAL/D is 1.86 and 2MinAL/D is 1.56.

In any of the preceding clauses, the P of the unducted fan propulsor is located in a third ellipse having a third major axis length (3MajAL) and a third minor axis length (3MinAL) with a third ellipse origin defined by EORL/D of 0.870 and θ of 239.6°, where 3MajAL/D is 1.4 and 3MinAL/D is 0.9.

In any of the preceding clauses, the P of the unducted fan propulsor is located in a fourth ellipse having a fourth major axis length (4MajAL) and a fourth minor axis length (4MinAL) with a fourth ellipse origin defined by EORL/D of 0.763 and θ of 235.7°, and where 4MajAL/D is 0.94 and 4MinAL/D is 0.44.

In any of the preceding clauses, the unducted fan propulsor is undermounted to the airfoil, such as a wing, with one or more intermediate structures.

In any of the preceding clauses, the unducted fan propulsor has a cruise flight Mach M₀ of between 0.70 and 0.85, between 0.5 and 0.9, between 0.7 and 0.9, or between 0.75 and 0.9.

In any of the preceding clauses, the rotating blades diameter is between 8 to 16 feet or between 12 to 16 feet. In any of the preceding clauses, the aircraft having a wing defining the airfoil and one or two unducted fan propulsors are mounted to the wing.

In any of the preceding clauses, wherein the aircraft are aircraft types A, B, C or G as defined in Tables 1 and 2.

Clause 2: An aircraft is provided including a fuselage; an airfoil extending from the fuselage, the airfoil having an airfoil section with a leading edge (LE) and a trailing edge (TE), a chord extending between the LE and TE, and an effective quarter chord point (QC) along the chord measured from the LE; an unducted fan propulsor mounted relative to the airfoil section on a high pressure side thereof, the unducted fan propulsor having a centerline (CL) and a plurality of blades arranged in one or more arrays, each of the blades having a root and the plurality of blades defining a maximum outer diameter (D), the unducted fan propulsor having a point (P) defined as one of: (a) wherein the plurality of blades is arranged in a single array, the point P is located at an intersection of the CL and a line perpendicular to the CL that passes through a midpoint between edges at the root of one of the plurality of blades, and (b) wherein the plurality of blades is arranged in a forward array and a rearward array, the point P is located at an intersection of the CL and midpoint between a rearward trailing edge (TE) of the rearward array and leading edge (LE) of the forward array when a blade of the forward and rearward arrays are aligned with each other; and a positioning line (R) having a length (RL) and extending from the QC to the point P of the unducted fan propulsor and at an angle θ as measured from a vector from the QC to the TE of the airfoil section to the line R, where, when viewed with the LE to the left of TE, a positive θ (1) increases in a counter-clockwise direction when the high pressure side of the airfoil section is below the airfoil section, and (2) increases in a clockwise direction when the high pressure side of the airfoil section is above the airfoil section, and wherein 0.065<RL/D<1.98 and θ is between 187° and 340°, and wherein RL/D and θ of the P of the unducted fan propulsor adhere to the following expressions:

$$\frac{R L}{D} + \frac{\begin{matrix}( \sqrt{\begin{matrix}1.4161 * [ 1.88978 * {sin}^{2} ( θ ) - 0.0875 * \\ {cos}^{2} ( θ ) + 0.477 * sin ( θ ) * cos ( θ ) ]\end{matrix}} + \\ 1.764 * sin ( θ ) + 0.19146 * cos ( θ ) )\end{matrix}}{1.96 * {sin}^{2} ( θ ) + 0.7225 * {cos}^{2} ( θ )} > 0 ,$$

$$and$$

$$\frac{R L}{D} + \frac{\begin{matrix}( - \sqrt{\begin{matrix}1.4161 * [ 1.88978 * {sin}^{2} ( θ ) - 0.0875 * \\ {cos}^{2} ( θ ) + 0.477 * sin ( θ ) * cos ( θ ) ]\end{matrix}} + \\ 1.764 * sin ( θ ) + 0.19146 * cos ( θ ) )\end{matrix}}{1.96 * {sin}^{2} ( θ ) + 0.7225 * {cos}^{2} ( θ )} < 0.$$

In the preceding clause, 0.254<RL/D<1.86 and θ is between 199° and 306°, and the P of the unducted fan propulsor is defined by the following expressions:

$$\frac{R L}{D} + \frac{\begin{matrix}( \sqrt{\begin{matrix}0.52621 * [ 0.7205 * {sin}^{2} ( θ ) - 0.352 * \\ {cos}^{2} ( θ ) + 0.7448 * sin ( θ ) * cos ( θ ) ]\end{matrix}} + \\ 0.8476 * sin ( θ ) + 0.23119 * cos ( θ ) )\end{matrix}}{0.8649 * {sin}^{2} ( θ ) + 0.6084 * {cos}^{2} ( θ )} > 0 ,$$

$$and$$

$$\frac{R L}{D} + \frac{\begin{matrix}( - \sqrt{\begin{matrix}0.52621 * [ 0.7205 * {sin}^{2} ( θ ) - 0.352 * \\ {cos}^{2} ( θ ) + 0.7448 * sin ( θ ) * cos ( θ ) ]\end{matrix}} + \\ 0.8476 * sin ( θ ) + 0.23119 * cos ( θ ) )\end{matrix}}{0.8649 * {sin}^{2} ( θ ) + 0.6084 * {cos}^{2} ( θ )} < 0.$$

In any of the two preceding clauses, 0.369<RL/D<1.43 and θ is between 204° and 291°, and the P of the unducted fan propulsor is defined by the following expressions:

$$\frac{R L}{D} + \frac{\begin{matrix}( \sqrt{\begin{matrix}0.52621 * [ 0.7205 * {sin}^{2} ( θ ) - 0.352 * \\ {cos}^{2} ( θ ) + 0.7448 * sin ( θ ) * cos ( θ ) ]\end{matrix}} + \\ 0.8476 * sin ( θ ) + 0.23119 * cos ( θ ) )\end{matrix}}{0.8649 * {sin}^{2} ( θ ) + 0.6084 * {cos}^{2} ( θ )} > 0 ,$$

$$and$$

$$\frac{R L}{D} + \frac{\begin{matrix}( - \sqrt{\begin{matrix}0.52621 * [ 0.7205 * {sin}^{2} ( θ ) - 0.352 * \\ {cos}^{2} ( θ ) + 0.7448 * sin ( θ ) * cos ( θ ) ]\end{matrix}} + \\ 0.8476 * sin ( θ ) + 0.23119 * cos ( θ ) )\end{matrix}}{0.8649 * {sin}^{2} ( θ ) + 0.6084 * {cos}^{2} ( θ )} < 0.$$

In any of the three preceding clauses: 0.477<RL/D<0.9455 and θ is between 211° and 274°, and the P of the unducted fan propulsor is defined by the following expressions:

$$\frac{RL}{D} + \frac{( \sqrt{0.01069156 * [ 0.036 * {sin}^{2} ( θ ) - 0.3485 * {cos}^{2} ( θ ) + 0.5418 * sin ( θ ) * cos ( θ ) ]} + 0.139167 * sin ( θ ) + 0.020812 * cos ( θ ) )}{0.2209 * {sin}^{2} ( θ ) + 0.0484 * {cos}^{2} ( θ )} > 0 ,$$

$$and$$

$$\frac{RL}{D} + \frac{( - \sqrt{0.01069156 * [ 0.036 * {sin}^{2} ( θ ) - 0.3485 * {cos}^{2} ( θ ) + 0.5418 * sin ( θ ) * cos ( θ ) ]} + 0.139167 * sin ( θ ) + 0.020812 * cos ( θ ) )}{0.2209 * {sin}^{2} ( θ ) + 0.0484 * {cos}^{2} ( θ )} < 0.$$

In any of the four preceding clauses, the unducted fan propulsor is undermounted to the airfoil, such as a wing, with one or more intermediate structures.

In any of the preceding clauses, the unducted fan propulsor has a cruise flight Mach M₀ of between 0.70 and 0.85, between 0.5 and 0.9, between 0.7 and 0.9, or between 0.75 and 0.9.

Clause 3: An aircraft is provided that includes a fuselage; an airfoil extending from the fuselage, the airfoil having an airfoil section with a leading edge (LE) and a trailing edge (TE), a chord extending between the LE and TE, and an effective quarter chord point (QC) along the chord measured from the LE; an unducted fan propulsor mounted relative to the airfoil section on a high pressure side thereof, the unducted fan propulsor having a centerline (CL) and a plurality of blades arranged in one or more arrays, each of the blades having a root and the plurality of blades defining a maximum outer diameter (D), the unducted fan propulsor having a point (P) defined as one of: (a) wherein the plurality of blades is arranged in a single array, the point P is located at an intersection of the CL and a line perpendicular to the CL that passes through a midpoint between edges at the root of one of the plurality of blades, and (b) wherein the plurality of blades is arranged in a forward array and a rearward array, the point P is located at an intersection of the CL and midpoint between a rearward trailing edge (TE) of the rearward array and leading edge (LE) of the forward array when a blade of the forward and rearward arrays are aligned with each other; and a positioning line (R) having a length (RL) and extending from the QC to the point P of the unducted fan propulsor and at an angle θ as measured from a vector from the QC to the TE of the airfoil section to the line R, where, when viewed with the LE to the left of TE, a positive θ (1) increases in a counter-clockwise direction when the high pressure side of the airfoil section is below the airfoil section, and (2) increases in a clockwise direction when the high pressure side of the airfoil section is above the airfoil section, and wherein RL/D≤2 and θ is between 187° and 342°.

In any of the preceding clauses, 0.15≤RL/D.

In any of the preceding clauses, 0.35≤RL/D, and preferably RL/D is about 0.72.

In any of the preceding clauses, wherein θ is between 198° and 310°, and preferably between 205° and 285°.

In any of the preceding clauses, the unducted fan propulsor operates at a cruise flight Mach M₀ of between 0.5 and 0.9, preferably between 0.7 and 0.9, and more preferably between 0.75 and 0.9.

In any of the preceding clauses, the unducted fan propulsor has a dimensionless cruise fan net thrust parameter expressed as follows:

$$0.15 > \frac{{F}_{net}}{{ρ}_{0} {A}_{an} {V}_{0}^{2}} > 0.06 ,$$

wherein Fₙₑₜ is cruise fan net thrust, ρ₀ is ambient air density, Vₒ is cruise flight velocity, and Aₐₙ is annular cross-sectional area perpendicular to an axis of rotation of a rotor axis of rotation.

In any of the preceding clauses, the unducted fan propulsor is undermounted to the airfoil with one or more intermediate structures.

In any of the foregoing clauses, the P of the unducted fan propulsor is variable to accommodate different operating conditions.

In any of the preceding clauses, the aircraft includes a plurality of the unducted fan propulsors.

In the preceding clause, the plurality of the unducted fan propulsors may be each mounted to the same airfoil, such as a wing or horizontal stabilizer; or the plurality of the unducted fan propulsors may be each mounted to different airfoils, such as a wing or horizontal stabilizer; or combinations thereof.

In any of the preceding clauses, wherein the unducted propulsor has two arrays of blades and only one of the array of blades is rotating.

Clause 4: An aircraft is provided that includes a fuselage; an airfoil extending from the fuselage, the airfoil having an airfoil section defining an effective quarter chord point (QC); an unducted fan propulsor mounted relative to the airfoil section on a high pressure side thereof, the unducted fan propulsor having a centerline (CL), a plurality of counterclockwise rotating blades arranged in a forward array and a plurality clockwise rotating blades arranged in a rearward array, wherein one of the forward and rearward array of blades define a maximum outer diameter (D); a point (P) located at the intersection of the CL and a midpoint (TRL) between a rearward trailing edge nearest a root of a blade of the rearward array and a leading edge nearest a root of a blade of the forward array when the forward leading edge and rearward trailing edge of the respective blades are aligned with each other; and an ellipse origin positioning line (EOR) having a length (EORL) extending from the QC to an ellipse origin (OR) at an angle θ measured positive in a counter-clockwise direction when the high pressure side of the airfoil section is below the airfoil section, and measured positive in a clockwise direction when the high pressure side of the airfoil section is above the airfoil section; wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1MinAL/D is 1.7.

Clause 5: An aircraft is provided that includes a fuselage; an airfoil extending from the fuselage, the airfoil having an airfoil section and the airfoil section having an effective quarter chord point (QC), and a plurality of rotating blades defining a maximum outer diameter (D); a point (P) located at an intersection of the CL and a line perpendicular to the CL that passes through a midpoint between leading and trailing edges nearest the root of one of the plurality of blades, and an ellipse origin positioning line (EOR) having a length (EORL) extending from the QC to an ellipse origin (OR) and at an angle θ measured positive in a counter-clockwise direction when the high pressure side of the airfoil section is below the airfoil section, and measured positive in a clockwise direction when the high pressure side of the airfoil section is above the airfoil section, and wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1MinAL/D is 1.7.

Clause 6: An aircraft is provided that includes a fuselage; an airfoil extending from the fuselage, the airfoil having an airfoil section defining an effective quarter chord point (QC); an unducted fan propulsor mounted relative to the airfoil section on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at the intersection of the CL and a midpoint (TRL) between a rearward trailing edge nearest a root of a blade of the rearward array and a leading edge nearest a root of a blade of the forward array when the forward leading edge and rearward trailing edge of the respective blades are aligned with each other; and a positioning line (R) having a length (RL) and extending from the QC to the point P of the unducted fan propulsor at an angle θ measured positive in a counter-clockwise direction when the high pressure side of the airfoil section is below the airfoil section, and measured positive in a clockwise direction when the high pressure side of the airfoil section is above the airfoil section; wherein 0.065<RL/D<1.98 and θ is between 187° and 340°; and wherein RL/D and θ of the P of the unducted fan propulsor adhere to the following expressions:

$$\frac{RL}{D} \frac{( \sqrt{1.4161 * [ 1.88978 * {sin}^{2} ( θ ) - 0.0875 * {cos}^{2} ( θ ) + 0.477 * sin ( θ ) * cos ( θ ) ]} + 1.764 * sin ( θ ) + 0.19146 * cos ( θ ) )}{1.96 * {sin}^{2} ( θ ) + 0.7225 * {cos}^{2} ( θ )} > 0 ,$$

$$and$$

$$\frac{RL}{D} + \frac{( - \sqrt{1.4161 * [ 1.88978 * {sin}^{2} ( θ ) - 0.0875 * {cos}^{2} ( θ ) + 0.477 * sin ( θ ) * cos ( θ ) ]} + 1.764 * sin ( θ ) + 0.19146 * cos ( θ ) )}{1.96 * {sin}^{2} ( θ ) + 0.7225 * {cos}^{2} ( θ )} < 0 .$$

The aircraft of Clause 6, wherein:
0.254<RL/D<1.86 and θ is between 199° and 306°, and
the P of the unducted fan propulsor is defined by the following expressions:

$$\frac{RL}{D} + \frac{( \sqrt{0.52621 * [ 0.7205 * {sin}^{2} ( θ ) - 0.352 * {cos}^{2} ( θ ) + 0.7448 * sin ( θ ) * cos ( θ ) ]} + 0.8476 * sin ( θ ) + 0.23119 * cos ( θ ) )}{0.8649 * {sin}^{2} ( θ ) + 0.6084 * {cos}^{2} ( θ )} > 0 ,$$

$$and$$

$$\frac{RL}{D} + \frac{( - \sqrt{0.52621 * [ 0.7205 * {sin}^{2} ( θ ) - 0.352 * {cos}^{2} ( θ ) + 0.7448 * sin ( θ ) * cos ( θ ) ]} + 0.8476 * sin ( θ ) + 0.23119 * cos ( θ ) )}{0.8649 * {sin}^{2} ( θ ) + 0.6084 * {cos}^{2} ( θ )} < 0 .$$

The aircraft of Clause 6, wherein:
0.369<RL/D<1.43 and θ is between 204° and 291°, and
the P of the unducted fan propulsor is defined by the following expressions:

$$\frac{RL}{D} + \frac{( \sqrt{0.09923 * [ 0.2964 * {sin}^{2} ( θ ) - 0.36 * {cos}^{2} ( θ ) + 0.66 * sin ( θ ) * cos ( θ ) ]} + 0.3675 * sin ( θ ) + 0.0891 * cos ( θ ) )}{0.49 * {sin}^{2} ( θ ) + 0.2025 * {cos}^{2} ( θ )} > 0 ,$$

$$and$$

$$\frac{RL}{D} + \frac{( - \sqrt{0.09923 * [ 0.2964 * {sin}^{2} ( θ ) - 0.36 * {cos}^{2} ( θ ) + 0.66 * sin ( θ ) * cos ( θ ) ]} + 0.3675 * sin ( θ ) + 0.0891 * cos ( θ ) )}{0.49 * {sin}^{2} ( θ ) + 0.2025 * {cos}^{2} ( θ )} < 0.$$

The aircraft of Clause 6, wherein:
0.477<RL/D<0.9455 and θ is between 211° and 274°, and
the P of the unducted fan propulsor is defined by the following expressions:

$$\frac{RL}{D} + \frac{( \sqrt{0.01069156 * [ 0.036 * {sin}^{2} ( θ ) - 0.3485 * {cos}^{2} ( θ ) + 0.5418 * sin ( θ ) * cos ( θ ) ]} + 0.139167 * sin ( θ ) + 0.020812 * cos ( θ ) )}{0.2209 * {sin}^{2} ( θ ) + 0.0484 * {cos}^{2} ( θ )} > 0 ,$$

$$and$$

$$\frac{RL}{D} + \frac{( - \sqrt{0.01069156 * [ 0.036 * {sin}^{2} ( θ ) - 0.3485 * {cos}^{2} ( θ ) + 0.5418 * sin ( θ ) * cos ( θ ) ]} + 0.139167 * sin ( θ ) + 0.02812 * cos ( θ ) )}{0.2209 * {sin}^{2} ( θ ) + 0.0484 * {cos}^{2} ( θ )} < 0.$$

The aircraft of Clause 6, wherein the unducted fan propulsor is undermounted to the airfoil with one or more intermediate structures.

The aircraft of Clause 6, wherein the P of the unducted fan propulsor is variable to accommodate different operating conditions.

Clause 7: An aircraft is provided that includes a fuselage; an airfoil extending from the fuselage, the airfoil having an airfoil section defining an effective quarter chord point (QC); an unducted fan propulsor mounted relative to the airfoil section on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at the intersection of the CL and a midpoint (TRL) between a rearward trailing edge nearest a root of a blade of the rearward array and a leading edge nearest a root of a blade of the forward array when the forward leading edge and rearward trailing edge of the respective blades are aligned with each other; and a positioning line (R) having a length (RL) and extending from the QC to the point P of the unducted fan propulsor at an angle θ measured positive in a counter-clockwise direction when the high pressure side of the airfoil section is below the airfoil section, and measured positive in a clockwise direction when the high pressure side of the airfoil section is above the airfoil section; wherein RL/D≤2 and θ is between 187° and 342°.

The aircraft of Clause 7, wherein 0.15≤RL/D.

The aircraft of Clause 7, wherein 0.35≤RL/D, and preferably RL/D is about 0.72.

The aircraft of Clause 7, wherein θ is between 198° and 310°, and preferably between 205° and 285°.

The aircraft of Clause 7, wherein the unducted fan propulsor operates at a cruise flight Mach M₀ of between 0.5 and 0.9, preferably between 0.7 and 0.9, and more preferably between 0.75 and 0.9.

The aircraft of Clause 7, wherein the unducted fan propulsor has a dimensionless cruise fan net thrust parameter expressed as follows:

$$0.15 > \frac{{F}_{net}}{{ρ}_{0} {A}_{an} {V}_{0}^{2}} > 0.06 ,$$

wherein Fₙₑₜ is cruise fan net thrust, ρ₀ is ambient air density, Vₒ is cruise flight velocity, and Aₐₙ is annular cross-sectional area perpendicular to an axis of rotation of a rotor axis of rotation.

The aircraft of Clause 7, wherein the unducted fan propulsor is undermounted to the airfoil with one or more intermediate structures.

The aircraft of Clause 7, wherein the P of the unducted fan propulsor is variable to accommodate different operating conditions.

Clause 8: A method of assembly, comprising: using an aircraft body comprising a fuselage and an airfoil extending from the fuselage, wherein the airfoil has an airfoil section defining an effective quarter chord point (QC); and attaching an unducted fan propulsor to the aircraft body relative to the airfoil section on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at the intersection of the CL and a line HP perpendicular to the axial centerline CL that passes through the axial midpoint between a rearward trailing edge at a root of a blade of the rearward array and a forward leading edge at a root of a blade of the forward array when the forward leading edge and rearward trailing edge of the respective blades are aligned with each other; and a positioning line (R) having a length (RL) and extending from the QC to the point P of the unducted fan propulsor at an angle θ measured positive in a counter-clockwise direction when the high pressure side of the airfoil section is below the airfoil section, and measured positive in a clockwise direction when the high pressure side of the airfoil section is above the airfoil section, when viewed looking from an outboard position towards an inboard position; wherein 0.07≤RL/D≤2.0 and θ is between 187° and 342°.

The method of Clause 8, wherein 0.15≤RL/D.

The method of Clause 8, wherein 0.35≤RL/D, and preferably RL/D is about 0.72.

The method of Clause 8, wherein θ is between 198° and 310°, and preferably between 205° and 285°.

The method of Clause 8, wherein the unducted fan propulsor operates at a cruise flight Mach M₀ of between 0.5 and 0.9, preferably between 0.7 and 0.9, and more preferably between 0.75 and 0.9.

The method of Clause 8, wherein the unducted fan propulsor has a dimensionless cruise fan net thrust parameter expressed as follows:

$$0.15 > \frac{{F}_{net}}{{ρ}_{0} {A}_{an} {V}_{0}^{2}} > 0.06 ,$$

wherein Fₙₑₜ is cruise fan net thrust, ρ₀ is ambient air density, Vₒ is cruise flight velocity, and Aₐₙ is annular cross-sectional area perpendicular to an axis of rotation of a rotor axis of rotation.

The method of Clause 8, wherein the unducted fan propulsor is undermounted to the airfoil with one or more intermediate structures.

The method of Clause 8, wherein the P of the unducted fan propulsor is variable to accommodate different operating conditions.

Clause 9: A method of assembly, comprising: using an aircraft body comprising a fuselage and an airfoil extending from the fuselage, the airfoil having an airfoil section with a leading edge (LE) and a trailing edge (TE), a chord extending between the LE and TE, and an effective quarter chord point (QC) along the chord measured from the LE, wherein the airfoil has an airfoil section defining an effective quarter chord point (QC); and attaching an unducted fan propulsor to the aircraft body relative to the airfoil section on a high pressure side thereof; the unducted fan propulsor having a centerline (CL) and a plurality of blades arranged in one or more arrays, each of the blades having a root and the plurality of blades defining a maximum outer diameter (D), the unducted fan propulsor having a point (P) defined as one of: (a) wherein the plurality of blades is arranged in a single array, the point P is located at an intersection of the CL and a line perpendicular to the CL that passes through a midpoint between edges at the root of one of the plurality of blades, and (b) wherein the plurality of blades is arranged in a forward array and a rearward array, the point P is located at an intersection of the CL and midpoint between a rearward trailing edge (TE) of the rearward array and leading edge (LE) of the forward array when a blade of the forward and rearward arrays are aligned with each other; and an ellipse origin positioning line (EOR) having a length (EORL) extending from the QC to an ellipse origin (OR) and at an angle θ as measured from a vector from the QC to the TE of the airfoil section to the line EOR, where, when viewed with the LE to the left of TE, a positive θ (1) increases in a counter-clockwise direction when the high pressure side of the airfoil section is below the airfoil section, and (2) increases in a clockwise direction when the high pressure side of the airfoil section is above the airfoil section, and wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1 MinAL/D is 1.7.

The method of Clause 9, wherein the P of the unducted fan propulsor is located in a second ellipse having a second major axis length (2MajAL) and a second minor axis length (2MinAL) with a second ellipse origin defined by EORL/D of 1.051 and θ of 248.8°, and where 2MajAL/D is 1.86 and 2MinAL/D is 1.56.

The method of Clause 9, wherein the P of the unducted fan propulsor is located in a third ellipse having a third major axis length (3MajAL) and a third minor axis length (3MinAL) with a third ellipse origin defined by EORL/D of 0.870 and θ of 239.6°, where 3MajAL/D is 1.4 and 3MinAL/D is 0.9.

The method of Clause 9, wherein the P of the unducted fan propulsor is located in a fourth ellipse having a fourth major axis length (4MajAL) and a fourth minor axis length (4MinAL) with a fourth ellipse origin defined by EORL/D of 0.763 and θ of 235.7°, and where 4MajAL/D is 0.94 and 4MinAL/D is 0.44.

Clause 10: An aircraft comprising:
a fuselage;
a pair of wings extending from the fuselage,
two or more unducted fan propulsors, each of the unducted fan propulsors is mounted relative to one of the wings on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D);
a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and
an airfoil section having an effective quarter chord point QC;
a positioning line (R) having a length (RL) and extending from the QC to the point P of the unducted fan propulsor at an angle θ measured positive in a counter-clockwise direction when the high pressure side of the airfoil section is below the airfoil section when viewed looking from an outboard position towards an inboard position of the wing; wherein 0.07≤RL/D≤2.0 and θ is between 187° and 342°.

Clause 11: An aircraft comprising:
a fuselage;
a pair of horizontal stabilizers extending relative to the fuselage,
two or more unducted fan propulsors, each of the unducted fan propulsors is mounted relative to one of the horizontal stabilizers on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D);
a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and
an airfoil section having an effective quarter chord point QC;
a positioning line (R) having a length (RL) and extending from the QC to the point P of the unducted fan propulsor at an angle θ measured positive in a clockwise direction when the high pressure side of the airfoil section is above the airfoil section when viewed looking from an outboard position towards an inboard position of the wing; wherein 0.07≤RL/D≤2.0 and θ is between 187° and 342°.

In any of the preceding clauses, the unducted fan propulsor is undermounted to the airfoil, such as a wing, with one or more intermediate structures.

In any of the preceding clauses, the P of the unducted fan propulsor is variable to accommodate different operating conditions.

In any of the preceding clauses the drive mechanism may be a gas turbine engine and associated transmission to delivers torque from the drive mechanism to the propeller assembly.

In any of the preceding clauses, the unducted fan propulsor is incorporated into an airplane or other aircraft having a cruise flight Mach M₀ of between 0.70 and 0.85, between 0.75 and 0.85, between 0.75 and 0.79, between 0.5 and 0.9, between 0.7 and 0.9, or between 0.75 and 0.9.

In any of the preceding clauses, the unducted fan propulsors is connected to the wing (or horizontal stabilizer) through a pylon.

In any of the preceding clauses, the rotating blades diameter (D) may be between 8 to 16 feet or 12 to 16 feet.

In any of the preceding clauses, each of the propulsors including a drive mechanism comprising a gas turbine engine assembly comprising in serial order a compressor, combustor, high pressure turbine and power turbine.

In any of the preceding clauses, the propulsor having a pitch angle between −5 and +5 degrees, or −3 and 0 degrees.

In any of the preceding clauses, the propulsor having an inward toe angle of between 0 and 5 degrees, or 1 and 3 degrees.

In any of the preceding clauses, the rotating blades diameter is between 8 to 16 feet or between 12 to 16 feet.

In any of the preceding clauses, the aircraft having a wing defining the airfoil and one or two unducted fan propulsors are mounted to the wing.

In any of the preceding clauses, wherein the aircraft are aircraft types A, B, C or G as defined in Tables 1 and 2.

An unducted fan propulsor, comprising: a rotating element comprising: an axis of rotation; a stationary element; and a plurality of blades, each of said plurality of blades comprising: a blade root proximal to said axis; a blade tip remote from said axis; and a blade span measured between said blade root and said blade tip, wherein said rotating element has a load distribution such that at any location between said blade root and 30% span the value of ΔRCu in the air stream is greater than or equal to 60% of the peak ΔRCu in the air stream.

The unducted fan propulsor of any preceding clause, wherein said rotating element has a load distribution such that at any location between said blade root and 30% span the value of ΔRCu in the air stream is greater than or equal to 70% of the peak ΔRCu in the air stream.

The unducted fan propulsor of any preceding clause, wherein said rotating element has a load distribution such that at any location between said blade root and 30% span the value of ΔRCu in the air stream is greater than or equal to 80% of the peak ΔRCu in the air stream.

The unducted fan propulsor of any preceding clause, wherein said unducted fan propulsor is a propeller system.

The unducted fan propulsor of any preceding clause, wherein said unducted fan propulsor is an open rotor system.

The unducted fan propulsor of any preceding clause, wherein said stationary element comprises a plurality of vanes each comprising a vane root proximal to said axis, a vane tip remote from said axis, and a vane span measured between said vane root and said vane tip configured to impart a change in tangential velocity of the air opposite to that imparted by said rotating element.

The unducted fan propulsor of any preceding clause, wherein said vanes are positioned upstream of said rotating element.

The unducted fan propulsor of any preceding clause, wherein said vanes are positioned downstream of said rotating element.

The unducted fan propulsor of any preceding clause, wherein said vanes are variable in pitch.

The unducted fan propulsor of any preceding clause, wherein at least one of said vanes comprise a shroud distally from said axis.

The unducted fan propulsor of any preceding clause, wherein the Cu in the air stream aft of said unducted fan propulsor is relatively low compared to ΔCu of said rotating element over the majority of the span of said vanes.

The unducted fan propulsor of any preceding clause, wherein at least one of said vanes is attached to an aircraft structure.

The unducted fan propulsor of any preceding clause, wherein said stationary element comprises more than two of said plurality of vanes.

The unducted fan propulsor of any preceding clause, wherein said stationary element comprises more than four of said plurality of vanes.

The unducted fan propulsor of any preceding clause, wherein said unducted fan propulsor is a tilt rotor system.

The unducted fan propulsor of any preceding clause, wherein said unducted fan propulsor is a helicopter lift system.

The unducted fan propulsor of any preceding clause, wherein said rotating element is driven via a torque producing device.

The unducted fan propulsor of any preceding clause, wherein said torque producing device is selected from the group consisting of electric motors, gas turbines, gear drive systems, hydraulic motors, and combinations thereof.

The unducted fan propulsor of any preceding clause, wherein said rotating element has a shaft power per unit annulus area greater than about 20 SHP/ft² at cruise operating conditions.

The unducted fan propulsor of any preceding clause, wherein said blades are variable in pitch.

An unducted fan propulsor, comprising: a rotating element comprising: an axis of rotation; a stationary element; and a plurality of blades, each of said plurality of blades comprising: a blade root proximal to said axis; a blade tip remote from said axis; and a blade span measured between said blade root and said blade tip, wherein said blades have a characteristic selected from the group consisting of: at 30% span the blade camber is at least 90% of the maximum blade camber between 50% span and 100% span, the blade camber at 0% span is at least 110% of the maximum blade camber between 50% span and 100% span, and combinations thereof.

The unducted fan propulsor of any preceding clause, wherein said stationary element comprises a plurality of vanes each comprising a vane root proximal to said axis, a vane tip remote from said axis, and a vane span measured between said vane root and said vane tip configured to impart a change in tangential velocity of the air opposite to that imparted by said rotating element.

The unducted fan propulsor of any preceding clause, wherein said vanes are positioned upstream of said rotating element.

The unducted fan propulsor of any preceding clause, wherein said vanes are positioned downstream of said rotating element.

The unducted fan propulsor of any preceding clause, wherein at least one of said vanes comprise a shroud distally from said axis.

The unducted fan propulsor of any preceding clause, wherein the Cu in the air stream aft of the system is relatively low compared to ΔCu of said rotating element over the majority of the span of said vanes.

The unducted fan propulsor of any preceding clause, wherein said unducted fan propulsor is a propeller system.

The unducted fan propulsor of any preceding clause, wherein said unducted fan propulsor is an open rotor system.

An unducted torque producing system for extracting energy from an air stream, said unducted torque producing system comprising: a rotating element comprising: an axis of rotation; a stationary element; and a plurality of blades, each of said plurality of blades comprising: a blade root proximal to said axis; a blade tip remote from said axis; and a blade span measured between said blade root and said blade tip, wherein said rotating element has a load distribution such that at any location between said blade root and 30% span the value of ΔRCu in the air stream is greater than or equal to 60% of the peak ΔRCu in the air stream.

The unducted torque producing system of any preceding clause, wherein said unducted torque producing system is a wind turbine.

The unducted torque producing system of any preceding clause, wherein said stationary element comprises a plurality of vanes each comprising a vane root proximal to said axis, a vane tip remote from said axis, and a vane span measured between said vane root and said vane tip configured to impart a change in tangential velocity of the air opposite to that imparted by said rotating element.

The unducted torque producing system of any preceding clause, wherein said vanes are positioned upstream of said rotating element.

The unducted torque producing system of any preceding clause, wherein said vanes are positioned downstream of said rotating element.

A blade for an open rotor, comprising a pressure side and a suction side, the pressure side and the suction side intersecting at a leading edge and a trailing edge, wherein at each spanwise location, a chord of an airfoil section is defined as a straight line distance between the leading edge and the trailing edge and a meanline is defined midway between the pressure side and the suction side, and wherein for at least 30% of a span of the blade, the meanline of the airfoil section is shaped such that, in the presence of transonic or supersonic relative velocity conditions, maximum and minimum ideal Mach numbers on the suction side will lie within a 0.08 band for 75% or more of a region between 25% and 80% chordwise location of the chord of the airfoil section.

The blade of any preceding clause wherein a thickness of the airfoil section is defined as a distance measured normal to the meanline between the pressure side and the suction side, and wherein for between 30% and 90% of the span of the blade, a maximum value of the thickness of the airfoil section occurs at a location between about 0% to about 35% chordwise location of the chord.

The blade of any preceding clause wherein for between 30% and 90% spanwise location of the span of the blade, the airfoil section has a maximum thickness of about 2% to about 7% of the chord.

The blade of any preceding clause wherein the blade is part of an aircraft with designated cruise flight Mach number at or above 0.74.

The blade of any preceding clause wherein a majority of the leading edge of the blade has an aft sweep equal to or greater than a predetermined sweep profile, wherein the predetermined sweep profile is selected to produce a blade-relative velocity component perpendicular to the leading edge, at a tip radius of the blade, of Mach 0.75 or less, and to produce a blade-relative velocity component perpendicular to the leading edge, at 65% of the tip radius, of Mach 0.87 or less, in the presence of transonic or supersonic relative velocities near the blade.

The blade of any preceding clause, wherein, under transonic or supersonic relative velocity conditions, the blade has a spanwise ΔRCu distribution such that at any location between a blade root and 30% spanwise location of the blade, the value of ΔRCu is greater than or equal to 70% of the peak ΔRCu.

The blade of any preceding clause wherein a tip section of the blade has suction side dihedral such that a tip section leading edge is displaced in the direction perpendicular to a blade section chord line at a radius 85% of a tip radius, by an amount 10% or greater of a circumferential blade tip spacing.

The blade of any preceding clause wherein row aerodynamic solidity of the blade at 0% spanwise location is between 1.0 and 3.6, and at 100% spanwise location is between 0.0 and 0.8.

The blade of any preceding clause wherein for between 30% and 90% of the span of the blade, the leading edge has a thickness greater than 0.45% of the chord, measured at a 0.5% chordwise location.

A blade for an open rotor, comprising a pressure side and a suction side, the pressure side and the suction side intersecting at a leading edge and a trailing edge, wherein at each spanwise location, a chord of an airfoil section is defined as a straight line distance between the leading edge and the trailing edge and a meanline is defined midway between the pressure side and the suction side; and wherein for at least 30% of a span of the blade, the meanline of the airfoil section is shaped such that a relative curvature parameter is greater than 1.75 in a first region, less than 0.75 in a second region, and greater than 1.2 in a third region, wherein the relative curvature parameter of a region is defined by Δζₙ/Δζₜₒₜ/Δ(x/c)ₙ wherein ζ corresponds to the inverse tangent of the slope of a meanline curve, subscript n indicates the region, and x/c is a chordwise location normalized by the chord; and wherein for between 30% and 90% spanwise location of the span of the blade, the airfoil section has a maximum thickness of about 2% to about 7% of the chord.

The blade of any preceding clause wherein a thickness of the airfoil section is defined as a distance measured normal to the meanline between the pressure side and the suction side, and wherein for between 30% and 90% spanwise location of the span of the blade, a maximum value of the thickness of the airfoil section occurs at a location between about 0% to about 35% chordwise location of the chord.

The blade of any preceding clause wherein a tip section of the blade has suction side dihedral such that a tip section leading edge is displaced in the direction perpendicular to a blade section chord line at a radius 85% of a tip radius, by an amount 10% or greater of a circumferential blade tip spacing.

The blade of any preceding clause wherein row aerodynamic solidity of the blade at 0% spanwise location is between 1.0 and 3.6, and at 100% spanwise location is between 0.0 and 0.8.

The blade of any preceding clause wherein for between 30% and 90% of the span of the blade, the leading edge has a thickness greater than 0.45% of the chord, measured at a 0.5% chordwise location.

The blade of any preceding clause wherein for 50% of the span of the blade, the meanline of the airfoil section is shaped such that the relative curvature parameter is greater than 1.75 in the first region, less than 0.75 in the second region, and greater than 1.2 in the third region.

The blade of any preceding clause wherein the first region comprises at least x/c=0.0 to 0.10 and the third region comprises at least x/c=0.85 to 1.0.

The blade of any preceding clause wherein the first region corresponds to x/c=0.0 to 0.15, the second region corresponds to x/c=0.15 to 0.75, and the third region corresponds to x/c=0.75 to 1.0.

A blade for an open rotor comprising a pressure side and a suction side, the pressure side and the suction side intersecting at a leading edge and a trailing edge, wherein at each spanwise location, a chord of an airfoil section is defined as a straight line distance between the leading edge and the trailing edge and a meanline is defined midway between the pressure side and the suction side, and wherein for at least 30% of a span of the blade, the meanline of the airfoil section is shaped such that a relative curvature parameter is greater than 1.75 in a first region, less than 0.75 in a second region, and greater than 1.2 in a third region, wherein the relative curvature parameter of a region is defined by Δζₙ/Δζₜₒₜ/Δ(x/c)ₙ wherein ζ corresponds to the inverse tangent of the slope of a meanline curve, subscript n indicates the region, and x/c is a chordwise location normalized by the chord, and wherein the first region comprises at least x/c=0.0 to 0.10 and the third region comprises at least x/c=0.85 to 1.0.

The blade of any preceding clause wherein a thickness of the airfoil section is defined as a distance measured normal to the meanline between the pressure side and the suction side, and wherein for between 30% and 90% spanwise location of the span of the blade, a maximum value of the thickness of the airfoil section occurs at a location between about 0% to about 35% chordwise location of the chord.

The blade of any preceding clause wherein for between 30% and 90% spanwise location of the span of the blade, the airfoil section has a maximum thickness of about 2% to about 7% of the chord.

The blade of any preceding clause wherein the blade is part of an aircraft with designated cruise flight Mach number at or above 0.74.

The blade of any preceding clause wherein a majority of the leading edge of the blade has an aft sweep equal to or greater than a predetermined sweep profile, wherein the predetermined sweep profile is selected to produce a blade-relative velocity component perpendicular to the leading edge, at a tip radius of the blade, of Mach 0.75 or less, and to produce a blade-relative velocity component perpendicular to the leading edge, at 65% of the tip radius, of Mach 0.87 or less, in the presence of transonic or supersonic relative velocities near the blade.

The blade of any preceding clause wherein, under transonic or supersonic relative velocity conditions, the blade has a ΔRCu distribution such that at any location between a blade root and 30% spanwise location of the blade, the value of ΔRCu is greater than or equal to 70% of the peak ΔRCu.

The blade of any preceding clause wherein a tip section of the blade has suction side dihedral such that a tip section leading edge is displaced in the direction perpendicular to a blade section chord line at a radius 85% of a tip radius, by an amount 10% or greater of a circumferential blade tip spacing.

The blade of any preceding clause wherein row aerodynamic solidity of the blade at 0% spanwise location is between 1.0 and 3.6, and at 100% spanwise location is between 0.0 and 0.8.

The blade of any preceding clause wherein for between 30% and 90% of the span of the blade, the leading edge has a thickness greater than 0.45% of the chord, measured at a 0.5% chordwise location.

The blade of any preceding clause wherein for 50% of the span of the blade, the meanline of the airfoil section is shaped such that the relative curvature parameter is greater than 1.75 in the first region, less than 0.75 in the second region, and greater than 1.2 in the third region.

The blade of any preceding clause wherein the first region corresponds to x/c=0.0 to 0.15, the second region corresponds to x/c=0.15 to 0.75, and the third region corresponds to x/c=0.75 to 1.0.

A blade for an open rotor, including: a pressure side and a suction side, the pressure side and the suction side intersecting at a leading edge and a trailing edge, wherein at each spanwise location, a chord of an airfoil section is defined as a straight line distance between the leading edge and the trailing edge and a meanline is defined midway between the pressure side and the suction side; and wherein for at least 30% of a span of the blade, the meanline of the airfoil section is shaped such that a relative curvature parameter is greater than 1.2 in a first region, less than 0.75 in a second region, and greater than 0.9 in a third region, wherein the relative curvature parameter of a region is defined by Δζn/Δζtot/Δ(x/c)n wherein ζ corresponds to the inverse tangent of the slope of a meanline curve, Δζtot corresponds to a total change in meanline angle, subscript n indicates the region, and x/c is a chordwise location normalized by the chord; and wherein the first region includes at least x/c=0.0 to 0.15 and the third region includes at least x/c=0.80 to 1.0.

The blade for an open rotor of any preceding clause, wherein the second region includes a sub-region with an increasing mean line angle.

The blade for an open rotor of any preceding clause, wherein at x/c=0.4, the airfoil section has a meanline angle that is increasing.

The blade for an open rotor of any preceding clause, wherein the trailing edge includes a plurality of wave-shaped projections configured to facilitate wake mixing to reduce interaction noise caused by wakes of the blade impinging on a downstream engine component.

The blade for an open rotor of any preceding clause, wherein for 50% of the span of the blade, the meanline of the airfoil section is shaped such that the relative curvature parameter is greater than 1.75 in the first region, less than 0.75 in the second region, and greater than 1.2 in the third region.

The blade for an open rotor, including: a pressure side and a suction side, the pressure side and the suction side intersecting at a leading edge and a trailing edge, wherein at each spanwise location, a chord of an airfoil section is defined as a straight line distance between the leading edge and the trailing edge and a meanline is defined midway between the pressure side and the suction side; and wherein for at least 30% of a span of the blade, the meanline of the airfoil section is shaped such that a relative curvature parameter is greater than 1.2 in a first region, less than 0.75 in a second region, and greater than 0.9 in a third region, wherein the relative curvature parameter of a region is defined by Δζn/Δζtot/Δ(x/c)n wherein ζ corresponds to the inverse tangent of the slope of a meanline curve, Δζtot corresponds to a total change in meanline angle, subscript n indicates the region, and x/c is a chordwise location normalized by the chord; and wherein for between 30% and 90% spanwise location of the span of the blade, the airfoil section has a maximum thickness of about 2% to about 7% of the chord.

The blade for an open rotor of any preceding clause, wherein the second region includes a sub-region with an increasing mean line angle.

The blade for an open rotor of any preceding clause, wherein at x/c=0.4, the airfoil section has a meanline angle that is increasing.

The blade for an open rotor of any preceding clause, wherein the trailing edge includes a plurality of wave-shaped projections configured to facilitate wake mixing to reduce interaction noise caused by wakes of the blade impinging on a downstream engine component.

The blade for an open rotor of any preceding clause, wherein the first region includes at least x/c=0.0 to 0.15 and the third region includes at least x/c=0.8 to 1.0.

An aircraft comprising: a fuselage; a pair of wings extending from the fuselage, two or more unducted fan propulsors, each of the unducted fan propulsors is mounted relative to one of the wings on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and an airfoil section having an effective quarter chord point QC; a positioning line (R) having a length (RL) and extending from the QC to the point P of the unducted fan propulsor at an angle θ measured positive in a counter-clockwise direction when the high pressure side of the airfoil section is below the airfoil section when viewed looking from an outboard position towards an inboard position of the wing; wherein 0.07≤RL/D≤2.0 and θ is between 187° and 342°; wherein a blade of the rotating blades has a load distribution such that at any location between a blade root and 30% span, a value of ΔRCu in an air stream is greater than or equal to 60% of a peak ΔRCu in the air stream.

The aircraft of any preceding clause, wherein the unducted fan propulsor is positioned relative to the wing such that an effective velocity (Ve) of an airflow at the unducted fan propulsor is less than a free stream velocity (Vinf) of the aircraft.

The aircraft of any preceding clause, wherein the unducted fan propulsor is configured to generate a cruise fan net thrust based on the effective velocity (Ve).

The aircraft of any preceding clause, wherein a ratio of the effective velocity (Ve) to the free stream velocity (Vinf) is greater than or equal to 0.95 and less than or equal to 0.995.

The aircraft of any preceding clause, wherein the blade comprises a reduced chord length relative to a blade of an unducted fan propulsor where RL/D<0.07 or RL/D>2.0 having a common cruise fan net thrust.

The aircraft of any preceding clause, wherein the blade comprises a reduced span relative to a blade of an unducted fan propulsor where RL/D<0.07 or RL/D>2.0 having a common cruise fan net thrust.

The aircraft of any preceding clause, wherein 0.15≤RL/D.

The aircraft of any preceding clause, wherein 0.35≤RL/D, and preferably RL/D is about 0.72.

The aircraft of any preceding clause, wherein θ is between 198° and 310°, and preferably between 205° and 285°.

The aircraft of any preceding clause, wherein the two or more unducted fan propulsors are configured to operate at a cruise flight Mach M₀ of between 0.7 and 0.9, and more preferably between 0.75 and 0.9; or the two or more unducted fan propulsors are configured to propel the aircraft at a cruise flight Mach M₀ of between 0.7 and 0.9, and more preferably between 0.75 and 0.85.

The aircraft of any preceding clause, wherein the unducted fan propulsor has a dimensionless cruise fan net thrust parameter expressed as follows:

$$0.15 > \frac{{F}_{net}}{{ρ}_{0} {A}_{an} {V}_{0}^{2}} > 0.06 ,$$

wherein Fₙₑₜ is cruise fan net thrust, ρ₀ is ambient air density, Vₒ is cruise flight velocity, and Aₐₙ is annular cross-sectional area perpendicular to an axis of rotation of a rotor axis of rotation.

The aircraft of any preceding clause, wherein the unducted fan propulsor is undermounted to the airfoil with one or more intermediate structures.

The aircraft of any preceding clause, wherein the P of the unducted fan propulsor is variable to accommodate different operating conditions.

An aircraft, comprising: a fuselage; an airfoil extending from the fuselage, the airfoil having an airfoil section defining an effective quarter chord point (QC); an unducted fan propulsor mounted relative to the airfoil section on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and an ellipse origin positioning line (EOR) having a length (EORL) extending from the QC to an ellipse origin (OR) at an angle θ measured positive in a counter-clockwise direction when the high pressure side of the airfoil section is below the airfoil section, and measured positive in a clockwise direction when the high pressure side of the airfoil section is above the airfoil section, when viewed looking for an outboard position towards an inboard position; wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1MinAL/D is 1.7.

The aircraft of any preceding clause, wherein the P of the unducted fan propulsor is located in a second ellipse having a second major axis length (2MajAL) and a second minor axis length (2MinAL) with a second ellipse origin defined by EORL/D of 1.051 and θ of 248.8°, and where 2MajAL/D is 1.86 and 2MinAL/D is 1.56.

The aircraft of any preceding clause, wherein the P of the unducted fan propulsor is located in a third ellipse having a third major axis length (3MajAL) and a third minor axis length (3MinAL) with a third ellipse origin defined by EORL/D of 0.870 and θ of 239.6°, where 3MajAL/D is 1.4 and 3MinAL/D is 0.9.

The aircraft of any preceding clause, wherein the P of the unducted fan propulsor is located in a fourth ellipse having a fourth major axis length (4MajAL) and a fourth minor axis length (4MinAL) with a fourth ellipse origin defined by EORL/D of 0.763 and θ of 235.7°, and where 4MajAL/D is 0.94 and 4MinAL/D is 0.44.

An aircraft, comprising: a fuselage; an airfoil extending from the fuselage, the airfoil having an airfoil section defining an effective quarter-chord point (QC); an unducted fan propulsor mounted relative to the airfoil section on a high pressure side thereof, the unducted fan propulsor having a centerline (CL), a plurality of blades arranged in a forward array and a plurality of blades arranged in a rearward array, wherein one of the forward and rearward array of blades are rotating blades and the rotating blades define a maximum outer diameter (D); a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and a positioning line (R) having a length (RL) and extending from the QC to the point P of the unducted fan propulsor at an angle θ measured positive in a counter-clockwise direction when the high pressure side of the airfoil section is below the airfoil section, and measured positive in a clockwise direction when the high pressure side of the airfoil section is above the airfoil section, when viewed looking from an outboard position towards an inboard position (e.g. the fuselage) OR when viewed with the LE to the left of the TE; wherein 0.065<RL/D<1.98 and θ is between 187° and 340°; and wherein RL/D and θ of the P of the unducted fan propulsor adhere to the following expressions:

$$\frac{RL}{D} + \frac{( \sqrt{1.4161 * [ 1.88978 * {sin}^{2} ( θ ) - 0.0875 * {cos}^{2} ( θ ) + 0.477 * sin ( θ ) * cos ( θ ) ]} + 1.764 * sin ( θ ) + 0.19146 * cos ( θ ) )}{1.96 * {sin}^{2} ( θ ) + 0.7225 * {cos}^{2} ( θ )} > 0 ,$$

$$And$$

$$\frac{RL}{D} + \frac{( - \sqrt{1.4161 * [ 1.88978 * {sin}^{2} ( θ ) - 0.0875 * {cos}^{2} ( θ ) + 0.477 * sin ( θ ) * cos ( θ ) ]} + 1.764 * sin ( θ ) + 0.19146 * cos ( θ ) )}{1.96 * {sin}^{2} ( θ ) + 0.7225 * {cos}^{2} ( θ )} < 0 .$$

An aircraft comprising: a fuselage; a pair of wings extending from the fuselage, two or more unducted fan propulsors, each of the unducted fan propulsors is mounted relative to one of the wings on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and an airfoil section having an effective quarter chord point QC; a positioning line (R) having a length (RL) and extending from the QC to the point P of the unducted fan propulsor at an angle θ measured positive in a counter-clockwise direction when the high pressure side of the airfoil section is below the airfoil section when viewed looking from an outboard position towards an inboard position of the wing; wherein 0.07≤RL/D≤2.0 and θ is between 187° and 342°; wherein the rotating blades includes a blade having a pressure side and a suction side, the pressure side and the suction side intersecting at a leading edge and a trailing edge, wherein at each spanwise location, a chord of an airfoil section of the blade is defined as a straight line distance between the leading edge and the trailing edge and a meanline is defined midway between the pressure side and the suction side, and wherein for at least 30% of a span of the blade of the rotating blades, a meanline of the airfoil section is shaped such that a relative curvature parameter is greater than 1.2 in a first region, less than 0.75 in a second region, and greater than 0.9 in a third region, wherein the relative curvature parameter of a region is defined by Δζₙ/Δζₜₒₜ/Δ(x/c), wherein ζ corresponds to an inverse tangent of a slope of a meanline curve, Δζₜₒₜ corresponds to a total change in meanline angle, subscript n indicates the region, and x/c is a chordwise location normalized by the chord; and wherein the first region comprises at least x/c=0.0 to 0.15 and the third region comprises at least x/c=0.80 to 1.0.

An aircraft, comprising: a fuselage; an airfoil extending from the fuselage, the airfoil having an airfoil section defining an effective quarter chord point (QC); an unducted fan propulsor mounted relative to the airfoil section on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and an ellipse origin positioning line (EOR) having a length (EORL) extending from the QC to an ellipse origin (OR) at an angle θ measured positive in a counter-clockwise direction when the high pressure side of the airfoil section is below the airfoil section, and measured positive in a clockwise direction when the high pressure side of the airfoil section is above the airfoil section, when viewed looking for an outboard position towards an inboard position; wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1 MinAL/D is 1.7, wherein the rotating blades includes a blade having a pressure side and a suction side, the pressure side and the suction side intersecting at a leading edge and a trailing edge, wherein at each spanwise location, a chord of an airfoil section of the blade is defined as a straight line distance between the leading edge and the trailing edge and a meanline is defined midway between the pressure side and the suction side, and wherein for at least 30% of a span of the blade of the rotating blades, a meanline of the airfoil section is shaped such that a relative curvature parameter is greater than 1.2 in a first region, less than 0.75 in a second region, and greater than 0.9 in a third region, wherein the relative curvature parameter of a region is defined by Δζₙ/Δζₜₒₜ/Δ(x/c)ₙ wherein ζ corresponds to an inverse tangent of a slope of a meanline curve, Δζₜₒₜ corresponds to a total change in meanline angle, subscript n indicates the region, and x/c is a chordwise location normalized by the chord; andwherein the first region comprises at least x/c=0.0 to 0.15 and the third region comprises at least x/c=0.80 to 1.0.

An aircraft, comprising: a fuselage; an airfoil extending from the fuselage, the airfoil having an airfoil section defining an effective quarter-chord point (QC); an unducted fan propulsor mounted relative to the airfoil section on a high pressure side thereof, the unducted fan propulsor having a centerline (CL), a plurality of blades arranged in a forward array and a plurality of blades arranged in a rearward array, wherein one of the forward and rearward array of blades are rotating blades and the rotating blades define a maximum outer diameter (D); a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and a positioning line (R) having a length (RL) and extending from the QC to the point P of the unducted fan propulsor at an angle θ measured positive in a counter-clockwise direction when the high pressure side of the airfoil section is below the airfoil section, and measured positive in a clockwise direction when the high pressure side of the airfoil section is above the airfoil section, when viewed looking from an outboard position towards an inboard position (e.g. the fuselage) OR when viewed with the LE to the left of the TE; wherein 0.065<RL/D<1.98 and θ is between 187° and 340°; and wherein RL/D and θ of the P of the unducted fan propulsor adhere to the following expressions:

$$\frac{RL}{D} + \frac{( \sqrt{1.4161 * [ 1.88978 * {sin}^{2} ( θ ) - 0.0875 * {cos}^{2} ( θ ) + 0.477 * sin ( θ ) * cos ( θ ) ]} + 1.764 * sin ( θ ) + 0.19146 * cos ( θ ) )}{1.96 * {sin}^{2} ( θ ) + 0.7225 * {cos}^{2} ( θ )} > 0 , and$$

$$\frac{RL}{D} + \frac{( - \sqrt{1.4161 * [ 1.88978 * {sin}^{2} ( θ ) - 0.0875 * {cos}^{2} ( θ ) + 0.477 * sin ( θ ) * cos ( θ ) ]} + 1.764 * sin ( θ ) + 0.19146 * cos ( θ ) )}{1.96 * {sin}^{2} ( θ ) + 0.7225 * {cos}^{2} ( θ )} < 0 ,$$

wherein the rotating blades includes a blade having a pressure side and a suction side, the pressure side and the suction side intersecting at a leading edge and a trailing edge, wherein at each spanwise location, a chord of an airfoil section of the blade is defined as a straight line distance between the leading edge and the trailing edge and a meanline is defined midway between the pressure side and the suction side, and wherein for at least 30% of a span of the blade of the rotating blades, a meanline of the airfoil section is shaped such that a relative curvature parameter is greater than 1.2 in a first region, less than 0.75 in a second region, and greater than 0.9 in a third region, wherein the relative curvature parameter of a region is defined by Δζₙ/Δζₜₒₜ/Δ(x/c)ₙ wherein ζ corresponds to an inverse tangent of a slope of a meanline curve, Δζₜₒₜ corresponds to a total change in meanline angle, subscript n indicates the region, and x/c is a chordwise location normalized by the chord; and wherein the first region comprises at least x/c=0.0 to 0.15 and the third region comprises at least x/c=0.80 to 1.0.

An aircraft comprising: a fuselage; a pair of wings extending from the fuselage, two or more unducted fan propulsors, each of the unducted fan propulsors is mounted relative to one of the wings on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and an airfoil section having an effective quarter chord point QC; a positioning line (R) having a length (RL) and extending from the QC to the point P of the unducted fan propulsor at an angle θ measured positive in a counter-clockwise direction when the high pressure side of the airfoil section is below the airfoil section when viewed looking from an outboard position towards an inboard position of the wing; wherein 0.07≤RL/D≤2.0 and θ is between 187° and 342°; wherein the rotating blades includes a blade having a pressure side and a suction side, the pressure side and the suction side intersecting at a leading edge and a trailing edge, wherein at each spanwise location, a chord of an airfoil section of the blade is defined as a straight line distance between the leading edge and the trailing edge and a meanline is defined midway between the pressure side and the suction side, and wherein for at least 30% of a span of the blade, the meanline of the airfoil section is shaped such that a relative curvature parameter is greater than 1.2 in a first region, less than 0.75 in a second region, and greater than 0.9 in a third region, wherein the relative curvature parameter of a region is defined by Δζₙ/Δζₜₒₜ/Δ(x/c)ₙ wherein ζ corresponds to the inverse tangent of the slope of a meanline curve, Δζₜₒₜ corresponds to a total change in meanline angle, subscript n indicates the region, and x/c is a chordwise location normalized by the chord; and wherein for between 30% and 90% spanwise location of the span of the blade, the airfoil section has a maximum thickness of about 2% to about 7% of the chord.

An aircraft, comprising: a fuselage; an airfoil extending from the fuselage, the airfoil having an airfoil section defining an effective quarter chord point (QC); an unducted fan propulsor mounted relative to the airfoil section on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and an ellipse origin positioning line (EOR) having a length (EORL) extending from the QC to an ellipse origin (OR) at an angle θ measured positive in a counter-clockwise direction when the high pressure side of the airfoil section is below the airfoil section, and measured positive in a clockwise direction when the high pressure side of the airfoil section is above the airfoil section, when viewed looking for an outboard position towards an inboard position; wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1MinAL/D is 1.7; wherein the rotating blades includes a blade having a pressure side and a suction side, the pressure side and the suction side intersecting at a leading edge and a trailing edge, wherein at each spanwise location, a chord of an airfoil section of the blade is defined as a straight line distance between the leading edge and the trailing edge and a meanline is defined midway between the pressure side and the suction side, and wherein for at least 30% of a span of the blade, the meanline of the airfoil section is shaped such that a relative curvature parameter is greater than 1.2 in a first region, less than 0.75 in a second region, and greater than 0.9 in a third region, wherein the relative curvature parameter of a region is defined by Δζₙ/Δζₜₒₜ/Δ(x/c)ₙ wherein ζ corresponds to the inverse tangent of the slope of a meanline curve, Δζₜₒₜ corresponds to a total change in meanline angle, subscript n indicates the region, and x/c is a chordwise location normalized by the chord; and wherein for between 30% and 90% spanwise location of the span of the blade, the airfoil section has a maximum thickness of about 2% to about 7% of the chord.

An aircraft, comprising: a fuselage; an airfoil extending from the fuselage, the airfoil having an airfoil section defining an effective quarter-chord point (QC); an unducted fan propulsor mounted relative to the airfoil section on a high pressure side thereof, the unducted fan propulsor having a centerline (CL), a plurality of blades arranged in a forward array and a plurality of blades arranged in a rearward array, wherein one of the forward and rearward array of blades are rotating blades and the rotating blades define a maximum outer diameter (D); a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and a positioning line (R) having a length (RL) and extending from the QC to the point P of the unducted fan propulsor at an angle θ measured positive in a counter-clockwise direction when the high pressure side of the airfoil section is below the airfoil section, and measured positive in a clockwise direction when the high pressure side of the airfoil section is above the airfoil section, when viewed looking from an outboard position towards an inboard position (e.g. the fuselage) OR when viewed with the LE to the left of the TE; wherein 0.065<RL/D<1.98 and θ is between 187° and 340°; and wherein RL/D and θ of the P of the unducted fan propulsor adhere to the following expressions:

$$\frac{RL}{D} + \frac{( \sqrt{1.4161 * [ 1.88978 * {sin}^{2} ( θ ) - 0.0875 * {cos}^{2} ( θ ) + 0.477 * sin ( θ ) * cos ( θ ) ]} + 1.764 * sin ( θ ) + 0.19146 * cos ( θ ) )}{1.96 * {sin}^{2} ( θ ) + 0.7225 * {cos}^{2} ( θ )} > 0 , and$$

$$\frac{RL}{D} + \frac{( - \sqrt{1.4161 * [ 1.88978 * {sin}^{2} ( θ ) - 0.0875 * {cos}^{2} ( θ ) + 0.477 * sin ( θ ) * cos ( θ ) ]} + 1.764 * sin ( θ ) + 0.19146 * cos ( θ ) )}{1.96 * {sin}^{2} ( θ ) + 0.7225 * {cos}^{2} ( θ )} < 0 ,$$

wherein the rotating blades includes a blade having a pressure side and a suction side, the pressure side and the suction side intersecting at a leading edge and a trailing edge, wherein at each spanwise location, a chord of an airfoil section of the blade is defined as a straight line distance between the leading edge and the trailing edge and a meanline is defined midway between the pressure side and the suction side, and wherein for at least 30% of a span of the blade, the meanline of the airfoil section is shaped such that a relative curvature parameter is greater than 1.2 in a first region, less than 0.75 in a second region, and greater than 0.9 in a third region, wherein the relative curvature parameter of a region is defined by Δζₙ/Δζₜₒₜ/Δ(x/c)ₙ wherein ζ corresponds to the inverse tangent of the slope of a meanline curve, Δζₜₒₜ corresponds to a total change in meanline angle, subscript n indicates the region, and x/c is a chordwise location normalized by the chord; and wherein for between 30% and 90% spanwise location of the span of the blade, the airfoil section has a maximum thickness of about 2% to about 7% of the chord.

An aircraft comprising: a fuselage; a pair of wings extending from the fuselage, two or more unducted fan propulsors, each of the unducted fan propulsors is mounted relative to one of the wings on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and an airfoil section having an effective quarter chord point QC; a positioning line (R) having a length (RL) and extending from the QC to the point P of the unducted fan propulsor at an angle θ measured positive in a counter-clockwise direction when the high pressure side of the airfoil section is below the airfoil section when viewed looking from an outboard position towards an inboard position of the wing; wherein 0.07≤RL/D≤2.0 and θ is between 187° and 342°; wherein a blade of the rotating blades has a characteristic selected from the group consisting of: at 30% span a blade camber is at least 90% of a maximum blade camber between 50% span and 100% span, the blade camber at 0% span is at least 110% of the maximum blade camber between 50% span and 100% span, and combinations thereof.

An aircraft, comprising: a fuselage; an airfoil extending from the fuselage, the airfoil having an airfoil section defining an effective quarter chord point (QC); an unducted fan propulsor mounted relative to the airfoil section on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D); a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and an ellipse origin positioning line (EOR) having a length (EORL) extending from the QC to an ellipse origin (OR) at an angle θ measured positive in a counter-clockwise direction when the high pressure side of the airfoil section is below the airfoil section, and measured positive in a clockwise direction when the high pressure side of the airfoil section is above the airfoil section, when viewed looking for an outboard position towards an inboard position; wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1 MinAL/D is 1.7; wherein a blade of the rotating blades has a characteristic selected from the group consisting of: at 30% span a blade camber is at least 90% of a maximum blade camber between 50% span and 100% span, the blade camber at 0% span is at least 110% of the maximum blade camber between 50% span and 100% span, and combinations thereof.

An aircraft, comprising: a fuselage; an airfoil extending from the fuselage, the airfoil having an airfoil section defining an effective quarter-chord point (QC); an unducted fan propulsor mounted relative to the airfoil section on a high pressure side thereof, the unducted fan propulsor having a centerline (CL), a plurality of blades arranged in a forward array and a plurality of blades arranged in a rearward array, wherein one of the forward and rearward array of blades are rotating blades and the rotating blades define a maximum outer diameter (D); a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and a positioning line (R) having a length (RL) and extending from the QC to the point P of the unducted fan propulsor at an angle θ measured positive in a counter-clockwise direction when the high pressure side of the airfoil section is below the airfoil section, and measured positive in a clockwise direction when the high pressure side of the airfoil section is above the airfoil section, when viewed looking from an outboard position towards an inboard position (e.g. the fuselage) OR when viewed with the LE to the left of the TE; wherein 0.065<RL/D<1.98 and θ is between 187° and 340°; and wherein RL/D and θ of the P of the unducted fan propulsor adhere to the following expressions:

$$\frac{RL}{D} + \frac{( \sqrt{1.4161 * [ 1.88978 * {sin}^{2} ( θ ) - 0.0875 * {cos}^{2} ( θ ) + 0.477 * sin ( θ ) * cos ( θ ) ]} + 1.764 * sin ( θ ) + 0.19146 * cos ( θ ) )}{1.96 * {sin}^{2} ( θ ) + 0.7225 * {cos}^{2} ( θ )} > 0 , and$$

$$\frac{RL}{D} + \frac{( - \sqrt{1.4161 * [ 1.88978 * {sin}^{2} ( θ ) - 0.0875 * {cos}^{2} ( θ ) + 0.477 * sin ( θ ) * cos ( θ ) ]} + 1.764 * sin ( θ ) + 0.19146 * cos ( θ ) )}{1.96 * {sin}^{2} ( θ ) + 0.7225 * {cos}^{2} ( θ )} < 0 ;$$

wherein a blade of the rotating blades has a characteristic selected from the group consisting of: at 30% span a blade camber is at least 90% of a maximum blade camber between 50% span and 100% span, the blade camber at 0% span is at least 110% of the maximum blade camber between 50% span and 100% span, and combinations thereof.

1. An aircraft comprising:
a fuselage;
a pair of wings extending from the fuselage,
two or more unducted fan propulsors, each of the unducted fan propulsors is mounted relative to one of the wings on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D);
a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and
an airfoil section having an effective quarter chord point QC;
a positioning line (R) having a length (RL) and extending from the QC to the point P of the unducted fan propulsor at an angle θ measured positive in a counter-clockwise direction when the high pressure side of the airfoil section is below the airfoil section when viewed looking from an outboard position towards an inboard position of the wing; wherein 0.07≤RL/D≤2.0 and θ is between 187° and 342°;
wherein a blade of the rotating blades has a load distribution such that at any location between a blade root and 30% span, a value of ΔRCu in an air stream is greater than or equal to 60% of a peak ΔRCu in the air stream.

2. The aircraft of claim 1, wherein the unducted fan propulsor is positioned relative to the wing such that an effective velocity (Ve) of an airflow at the unducted fan propulsor is less than a free stream velocity (Vinf) of the aircraft.

3. The aircraft of claim 2, wherein the unducted fan propulsor is configured to generate a cruise fan net thrust based on the effective velocity (Ve).

4. The aircraft of claim 2, wherein a ratio of the effective velocity (Ve) to the free stream velocity (Vinf) is greater than or equal to 0.95 and less than or equal to 0.995.

5. The aircraft of claim 4, wherein the blade comprises a reduced chord length relative to a blade of an unducted fan propulsor where RL/D<0.07 or RL/D>2.0 having a common cruise fan net thrust.

6. The aircraft of claim 4, wherein the blade comprises a reduced span relative to a blade of an unducted fan propulsor where RL/D<0.07 or RL/D>2.0 having a common cruise fan net thrust.

7. The aircraft of claim 1, wherein 0.15≤RL/D.

8. The aircraft of claim 1, wherein 0.35≤RL/D, and preferably RL/D is about 0.72.

9. The aircraft of claim 1, wherein 0 is between 198° and 310°, and preferably between 205° and 285°.

10. The aircraft of claim 1, wherein the two or more unducted fan propulsors are configured to operate at a cruise flight Mach M₀ of between 0.7 and 0.9, and more preferably between 0.75 and 0.9; or the two or more unducted fan propulsors are configured to propel the aircraft at a cruise flight Mach M₀ of between 0.7 and 0.9, and more preferably between 0.75 and 0.85.

11. The aircraft of claim 1, wherein the unducted fan propulsor has a dimensionless cruise fan net thrust parameter expressed as follows:
$$0.15 > \frac{{F}_{net}}{{ρ}_{0} {A}_{an} {V}_{0}^{2}} > 0.06 ,$$
wherein Fₙₑₜ is cruise fan net thrust, ρ₀ is ambient air density, Vₒ is cruise flight velocity, and Aₐₙ is annular cross-sectional area perpendicular to an axis of rotation of a rotor axis of rotation.

12. The aircraft of claim 1, wherein the unducted fan propulsor is undermounted to the airfoil with one or more intermediate structures.

13. The aircraft of claim 1, wherein the P of the unducted fan propulsor is variable to accommodate different operating conditions.

14. An aircraft, comprising:
a fuselage;
an airfoil extending from the fuselage, the airfoil having an airfoil section defining an effective quarter chord point (QC);
an unducted fan propulsor mounted relative to the airfoil section on a high pressure side thereof, the unducted fan propulsor having a centerline (CL), a plurality of blades arranged in a forward array and a plurality of blades arranged in a rearward array, wherein only one of the forward and rearward array of blades are rotating blades and the rotating blades define a maximum outer diameter (D);
a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and
an ellipse origin positioning line (EOR) having a length (EORL) extending from the QC to an ellipse origin (OR) at an angle θ measured positive in a counter-clockwise direction when the high pressure side of the airfoil section is below the airfoil section, and measured positive in a clockwise direction when the high pressure side of the airfoil section is above the airfoil section, when viewed looking for an outboard position towards an inboard position; wherein the P of the unducted fan propulsor is located within a first ellipse having a first major axis length (1MajAL) and a first minor axis length (1MinAL) with a first ellipse origin defined by EORL/D of 0.938 and θ of 253.6°, and where 1MajAL/D is 2.8 and 1 MinAL/D is 1.7.

15. The aircraft of claim 9, wherein the P of the unducted fan propulsor is located in a second ellipse having a second major axis length (2MajAL) and a second minor axis length (2MinAL) with a second ellipse origin defined by EORL/D of 1.051 and θ of 248.8°, and where 2MajAL/D is 1.86 and 2MinAL/D is 1.56.

16. The aircraft of claim 14, wherein the P of the unducted fan propulsor is located in a third ellipse having a third major axis length (3MajAL) and a third minor axis length (3MinAL) with a third ellipse origin defined by EORL/D of 0.870 and θ of 239.6°, where 3MajAL/D is 1.4 and 3MinAL/D is 0.9.

17. The aircraft of claim 14, wherein the P of the unducted fan propulsor is located in a fourth ellipse having a fourth major axis length (4MajAL) and a fourth minor axis length (4MinAL) with a fourth ellipse origin defined by EORL/D of 0.763 and θ of 235.7°, and where 4MajAL/D is 0.94 and 4MinAL/D is 0.44.

18. An aircraft, comprising:
a fuselage;
an airfoil extending from the fuselage, the airfoil having an airfoil section defining an effective quarter-chord point (QC);
an unducted fan propulsor mounted relative to the airfoil section on a high pressure side thereof, the unducted fan propulsor having a centerline (CL), a plurality of blades arranged in a forward array and a plurality of blades arranged in a rearward array, wherein one of the forward and rearward array of blades are rotating blades and the rotating blades define a maximum outer diameter (D);
a point (P) located at an intersection of the CL and a line HP perpendicular to the CL that passes through an axial midpoint between a rearward trailing edge at a root of a blade of the rearward array and a forward leading edge at a root of a blade of the forward array when the forward leading edge and rearward trailing edge of the respective blades are aligned with each other; and
a positioning line (R) having a length (RL) and extending from the QC to the point P of the unducted fan propulsor at an angle θ measured positive in a counter-clockwise direction when the high pressure side of the airfoil section is below the airfoil section, and measured positive in a clockwise direction when the high pressure side of the airfoil section is above the airfoil section, when viewed looking from an outboard position towards an inboard position (e.g. the fuselage) OR when viewed with the LE to the left of the TE; wherein 0.065<RL/D<1.98 and θ is between 187° and 340°; and wherein RL/D and θ of the P of the unducted fan propulsor adhere to the following expressions:
$$\frac{RL}{D} + \frac{( \sqrt{1.4161 * [ 1.88978 * {sin}^{2} ( θ ) - 0.0875 * {cos}^{2} ( θ ) + 0.477 * sin ( θ ) * cos ( θ ) ]} + 1.764 * sin ( θ ) + 0.19146 * cos ( θ ) )}{1.96 * {sin}^{2} ( θ ) + 0.7225 * {cos}^{2} ( θ )} > 0 ,$$
$$and$$
$$\frac{RL}{D} + \frac{( - \sqrt{1.4161 * [ 1.88978 * {sin}^{2} ( θ ) - 0.0875 * {cos}^{2} ( θ ) + 0.477 * sin ( θ ) * cos ( θ ) ]} + 1764 * sin ( θ ) + 0.19146 * cos ( θ ) )}{1.96 * {sin}^{2} ( θ ) + 0.7225 * {cos}^{2} ( θ )} < 0.$$
